(19) United States
(12) Patent Application Publication
(10) Pub. No.: US 2026/0019635 A1
(43) Pub. Date: Jan. 15, 2026

(54) POINT CLOUD ENCODING METHOD AND APPARATUS, POINT CLOUD DECODING METHOD AND APPARATUS, DEVICE, AND STORAGE MEDIUM

(71) Applicant: GUANGDONG OPPO MOBILE TELECOMMUNICATIONS CORP., LTD., Dongguan (CN)

(72) Inventor: Zexing SUN, Dongguan (CN)

(21) Appl. No.: 19/338,844

(22) Filed: Sep. 24, 2025

Related U.S. Application Data
(63) Continuation of application No. PCT/CN2023/084912, filed on Mar. 29, 2023.

(51) Int. Cl. H04N 19/597; H04N 19/119; H04N 19/169; H04N 19/96

(52) U.S. Cl. CPC H04N 19/597; H04N 19/119; H04N 19/1883; H04N 19/96

(57) ABSTRACT

The present disclosure provides a point cloud decoding method. The point cloud decoding method includes: determining first information corresponding to a current node, wherein the first information is used to indicate whether first-type neighborhood nodes of the current node are valid, and the first-type neighborhood nodes are neighborhood nodes whose geometry information has been decoded; obtaining occupancy information of N neighborhood nodes of the current node based on the first information, N being a positive integer; and performing predictive decoding on planar structure information of the current node based on the occupancy information of the N neighborhood nodes.

### CROSS-REFERENCE TO RELATED APPLICATION

This application is a Continuation Application of International Application No. PCT/CN2023/084912 filed on Mar. 29, 2023, which is incorporated herein by reference in its entirety.

### TECHNICAL FIELD

The present disclosure relates to the technical field of point cloud, and in particular, to a point cloud encoding and decoding method, an apparatus, a device and a storage medium.

### BACKGROUND

A surface of an object is captured by a collection device to form point cloud data, which includes hundreds of thousands or even more points. In a process of video production, the point cloud data is transmitted between a point cloud encoding device and a point cloud decoding device in a form of a point cloud media file. However, such a large number of points brings challenges to transmission, and thus, the point cloud encoding device needs to compress the point cloud data before transmission.

Point cloud compression is also referred to as point cloud encoding. In a process of point cloud encoding, for some relatively planar nodes or nodes with planar characteristics, coding efficiency of geometry information of the point cloud can be further improved by utilizing planar coding method. However, in the related art, predictive coding is performed on planar structure information of a current node only through some prior reference information, resulting in poor predictive coding performance of the planar structure information.

### SUMMARY

The embodiments of the present disclosure provide a point cloud encoding and decoding method, an apparatus, a device and a storage medium.

In a first aspect, the embodiments of the present disclosure provide a point cloud decoding method, which includes:
determining first information corresponding to a current node, where the first information is used to indicate whether first-type neighborhood nodes of the current node are valid, and the first-type neighborhood nodes are neighborhood nodes whose geometry information has been decoded;
obtaining occupancy information of N neighborhood nodes of the current node based on the first information, N being a positive integer; and
performing predictive decoding on planar structure information of the current node based on the occupancy information of the N neighborhood nodes.

In a second aspect, the present disclosure provides a point cloud encoding method, which includes:
determining first information corresponding to a current node, where the first information is used to indicate whether first-type neighborhood nodes of the current node are valid, and the first-type neighborhood nodes are neighborhood nodes whose geometry information has been encoded;
obtaining occupancy information of N neighborhood nodes of the current node based on the first information, N being a positive integer; and
performing predictive encoding on planar structure information of the current node based on the occupancy information of the N neighborhood nodes.

In a third aspect, the present disclosure provides a point cloud decoding apparatus, which is configured to perform the method in the above first aspect or its various implementations. Exemplarily, the apparatus includes functional units for performing the method in the above first aspect or its various implementations.

In a fourth aspect, the present disclosure provides a point cloud encoding apparatus, which is configured to perform the method in the above second aspect or its various implementations. Exemplarily, the apparatus includes functional units for performing the method in the above second aspect or its various implementations.

In a fifth aspect, a point cloud decoder is provided, including a processor and a memory. The memory is configured to store a computer program, and the processor is configured to call and run the computer program stored in the memory to perform the method in the above first aspect or its various implementation methods.

In a sixth aspect, a point cloud encoder is provided, including a processor and a memory. The memory is configured to store a computer program, and the processor is configured to call and run the computer program stored in the memory to perform the method in the above second aspect or its various implementations.

In a seventh aspect, a point cloud encoding and decoding system is provided, including a point cloud encoder and a point cloud decoder. The point cloud decoder is configured to perform the method in the above first aspect or its various implementations, and the point cloud encoder is configured to perform the method in the above second aspect or its various implementations.

In an eighth aspect, a chip is provided, which is configured to implement the method in any one of the first to second aspects or their various implementations. Exemplarily, the chip includes a processor, which is configured to call a computer program from a memory and run the computer program, to enable a device equipped with the chip to perform the method in any one of the first to second aspects or their various implementations.

In a ninth aspect, a non-transitory computer-readable storage medium is provided, which is configured to store a computer program, and the computer program enables a computer to perform the method in any one of the first to second aspects or their various implementations.

In a tenth aspect, a computer program product is provided, including computer program instructions, where the computer program instructions enable a computer to perform the method in any one of the first to second aspects or their various implementations.

In an eleventh aspect, a computer program is provided, where the computer program, when executed on a computer, enables the computer to perform the method in any one of the first to second aspects or their various implementations.

In a twelfth aspect, a bitstream is provided, which is generated based on the method in the second aspect.

In a thirteenth aspect, a non-transitory computer-readable storage medium is provided. The non-transitory computer-readable storage medium has a computer program and a bitstream stored thereon, and the computer program, when executed by a processor, enables the processor to perform the method described in the second aspect to generate the bitstream.

### BRIEF DESCRIPTION OF THE DRAWINGS

FIG. 1A is a schematic diagram of a point cloud.

FIG. 1B is a partially enlarged diagram of a point cloud.

FIG. 2 is a schematic diagram of a point cloud picture at six viewing angles.

FIG. 3 is a schematic block diagram of a point cloud encoding and decoding system involved in an embodiment of the present disclosure.

FIG. 4A is a schematic block diagram of a point cloud encoder provided by an embodiment of the present disclosure.

FIG. 4B is a schematic block diagram of a point cloud decoder provided by an embodiment of the present disclosure.

FIG. 5A is a schematic diagram of a plane.

FIG. 5B is a schematic diagram of a node coding sequence.

FIG. 5C is a schematic diagram of a planar flag.

FIG. 5D is a schematic diagram of sibling nodes.

FIG. 5E is a schematic diagram of an intersection of a laser radar and a node.

FIG. 5F is a schematic diagram of a neighborhood node at the same partitioning depth and the same coordinate.

FIG. 5G is a schematic diagram of neighborhood nodes in a case where a node is located at a lower plane position of a parent node.

FIG. 5H is a schematic diagram of neighborhood nodes in a case where a node is located at a high plane position of a parent node.

FIG. 5I is a schematic diagram of predictive encoding of planar position information of a laser radar point cloud.

FIG. 6 is a schematic diagram of infer direct coding model (IDCM) coding.

FIG. 7A to FIG. 7C are schematic diagrams of triangle soup-based geometry information coding.

FIG. 8A is a schematic diagram of a distance-based LOD construction.

FIG. 8B is a subjective schematic diagram of a distance-based LOD generation process.

FIG. 8C is a flowchart of predictive encoding.

FIG. 8D is a schematic diagram of a LOD partitioning.

FIG. 8E is a schematic diagram of inter-level nearest neighbor search.

FIG. 8F is a schematic diagram of performing nearest neighbor search based on a spatial relationship.

FIG. 8G is a schematic diagram of nearest neighbor search for a co-planar, co-edge and co-vertex.

FIG. 8H is a schematic diagram of a neighboring point search.

FIG. 8I is a schematic diagram of a neighboring point search.

FIG. 8J is a schematic diagram of a neighboring point search based on a fast search algorithm.

FIG. 8K is a schematic diagram of an inter nearest neighbor search.

FIG. 8L is a flowchart of a lifting transform.

FIG. 8M is a schematic diagram of a RAHT transform process along x, y and z directions.

FIG. 8N is a schematic diagram of a RAHT transform.

FIG. 8O is a schematic diagram of RAHT forward transform and inverse transform.

FIG. 9 is a schematic flowchart diagram of a point cloud decoding method provided by an embodiment of the present disclosure.

FIG. 10 is a schematic diagram of an octree partitioning.

FIG. 11 is a schematic diagram of neighborhood nodes.

FIG. 12 is another schematic diagram of neighborhood nodes.

FIG. 13 is another schematic diagram of neighborhood nodes.

FIG. 14 is a schematic diagram of primary information and minor information.

FIG. 15 is a schematic diagram of a minor information partitioning tree.

FIG. 16 is a partitioning schematic diagram of a minor information partitioning tree.

FIG. 17 is another partitioning schematic diagram of a minor information partitioning tree.

FIG. 18 is yet another partitioning schematic diagram of a minor information partitioning tree.

FIG. 19 is a schematic flowchart of a point cloud encoding method provided by an embodiment of the present disclosure.

FIG. 20 is a schematic block diagram of a point cloud decoding apparatus provided by an embodiment of the present disclosure.

FIG. 21 is a schematic block diagram of a point cloud encoding apparatus provided by an embodiment of the present disclosure.

FIG. 22 is a schematic block diagram of an electronic device provided by an embodiment of the present disclosure.

FIG. 23 is a schematic block diagram of a point cloud encoding and decoding system provided by an embodiment of the present disclosure.

### DETAILED DESCRIPTION

The present disclosure may be applied to the technical field of point cloud upsampling, for example, may be applied to the technical field of point cloud compression.

In order to facilitate understanding of the embodiments of the present disclosure, related concepts involved in the embodiments of the present disclosure are briefly introduced as follows firstly.

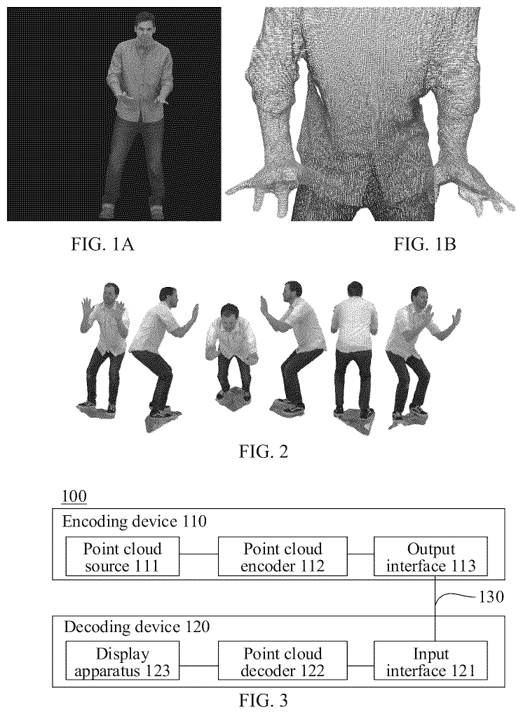

A point cloud refers to a set of discrete points in space that are irregularly distributed and express spatial structures and surface attributes of three-dimensional objects or three-dimensional scenarios. FIG. 1A is a schematic diagram of a three-dimensional point cloud picture, and FIG. 1B is a partially enlarged diagram of FIG. 1A. It may be seen from FIG. 1A and FIG. 1B that a point cloud surface is composed of densely distributed points.

A two-dimensional picture has information expression at each sample point (also referred to as pixel point), and the distribution is regular, so there is no need to record its position information additionally. However, distribution of points in a point cloud is random and irregular in three-dimensional space, so it is necessary to record a position of each point in space to completely express the entire point cloud. Similar to the two-dimensional picture, during a capturing process, each position has corresponding attribute information.

Point cloud data is a specific record form of a point cloud. A point in the point cloud may include position information of the point and attribute information of the point. For example, the position information of the point may be three-dimensional coordinate information of the point. The position information of the point may also be referred to as geometry information of the point. For example, the attribute information of the point may include color information, reflectance information, normal vector information, or the like. The color information reflects a color of an object, and the reflectance information reflects a surface material of an object. The color information may be information in any color space. For example, the color information may be RGB. For another example, the color information may be luma-chroma (YCbCr, YUV) information. For example, Y represents luminance (Luma), Cb (U) represents blue chromatic aberration, Cr (V) represents red chromatic aberration, and U and V represent chroma for describing chromatic aberration information. For example, for a point cloud obtained according to the laser measurement principle, a point in the point cloud may include three-dimensional coordinate information of the point and laser reflectance intensity of the point. For another example, for a point cloud obtained according to the photogrammetry principle, a point in the point cloud may include three-dimensional coordinate information of the point and color information of the point. For another example, for a point cloud obtained by combining the laser measurement principle and photogrammetry principle, a point in the point cloud may include three-dimensional coordinate information of the point, laser reflectance intensity of the point and color information of the point. FIG. 2 illustrates a point cloud picture, where FIG. 2 illustrates six viewing angles of the point cloud picture. Table 1 illustrates a point cloud data storage format consisting of a file header information part and a data part.

TABLE 1

| | |
|---|---|
| 1 | ply |
| 2 | format ascii 1.0 |
| 3 | element vertex 207242 |
| 4 | property float x |
| 5 | property float y |
| 6 | property float z |
| 7 | property uchar red |
| 8 | property uchar green |
| 9 | property uchar blue |
| 10 | end_header |
| 11 | 75 318 0 0 142 0 |
| 12 | 75 319 0 0 143 0 |
| 13 | 75 319 1 1 99 |
| 14 | 77 315 0 1 99 |

In Table 1, the header information includes a data format, a data representation type, the total number of points of a point cloud, and content represented by the point cloud. For example, the point cloud in this example is in “.ply” format, represented by ASCII code, with a total number of 207,242 points, and each point has three-dimensional position information XYZ and three-dimensional color information RGB.

The point cloud may express the spatial structures and the surface attributes of three-dimensional objects or three-dimensional scenarios flexibly and conveniently; moreover, since the point cloud is acquired by directly sampling real objects, the point cloud may provide a strong sense of reality under the premise of ensuring accuracy; and therefore, the point cloud is widely applied, and its application range includes virtual reality games, computer-aided design, geographic information systems, automatic navigation systems, digital cultural heritage, free-viewpoint broadcasting, three-dimensional immersive remote presentation, and three-dimensional reconstruction of biological tissues and organs or the like.

Acquisition approaches for the point cloud may include, but are not limited to, at least one of the following: (1) generated by a computer device, the computer device may generate the point cloud data based on virtual three-dimensional objects and virtual three-dimensional scenarios; (2) acquired by 3-Dimension (3D) laser scanning, where point cloud data of three-dimensional objects or three-dimensional scenarios of static real world may be acquired by the 3D laser scanning, and millions of point cloud data may be acquired per second; (3) acquired by 3D photogrammetry, where visual scenarios of real world are collected by a 3D photography device (i.e., a group of cameras or a camera device with multiple lenses and multiple sensors), to acquire point cloud data of the visual scenarios in real world, and point cloud data of three-dimensional objects or three-dimensional scenarios of dynamic real world may be acquired by 3D photography; or (4) point cloud data of biological tissues and organs acquired by a medical device, where in the medical field, the point cloud data of biological tissues and organs may be acquired by a medical device such as a magnetic resonance imaging (MRI), a computed tomography (CT), and an electromagnetic positioning system.

Point clouds may be classified into dense point clouds and sparse point clouds according to acquisition approaches.

The point clouds are classified into the following types according to a time series of the data:
first type: static point cloud, where an object is static, and a device for acquiring the point cloud is also static;
second type: dynamic point cloud, where an object is dynamic, but a device for acquiring the point cloud is static; and
third type: dynamically acquired point cloud, where a device for acquiring the point cloud is dynamic.

The point clouds may be classified into two types according to purposes:
type I: a machine perception point cloud, which may be used for scenarios such as, an autonomous navigation system, a real-time inspection system, a geographic information system, a visual sorting robot and a disaster relief robot; and
type II: a human eye perception point cloud, which may be used for point cloud application scenarios such as, digital cultural heritage, free viewpoint broadcasting, 3D immersive communication and 3D immersive interaction.

Through the above point cloud acquiring technologies, the cost and time period for acquiring the point cloud data are reduced and the accuracy of the data is improved. The change in the acquisition approaches for point cloud data makes it possible to acquire a large amount of point cloud data. However, with the growth of application demand, the processing of massive 3D point cloud data has encountered the bottleneck in storage space and transmission bandwidth limitation.

Taking a point cloud video with a frame rate of 30 frames per second (fps) as an example, the number of points of the point cloud per frame is 700,000, and each point has coordinate information xyz (float) and color information RGB (uchar); and thus, the data volume of a 10 s point cloud video is approximately 0.7 million×(4 Byte×3+1 Byte×3)×30 fps×10 s=3.15 GB. For a two-dimensional video with a YUV sampling format of 4:2:0, a resolution of 1280×720 and a frame rate of 24 fps, the data volume of a 10 s video is approximately 1280×720×12 bit×24 frames×10 s≈0.33 GB, and the data volume of a 10 s three-dimensional video with two-viewpoints is approximately 0.33×2=0.66 GB. It can be seen that, for videos with the same length, the data volume of point cloud video is much larger than that of two-dimensional video or that of three-dimensional video. Therefore, in order to better realize data management, save server storage space and reduce the transmission traffic and transmission time between the server and the client, point cloud compression has become a key issue to promote the development of the point cloud industry.

Related knowledge of point cloud encoding and decoding is introduced below.

FIG. 3 is a schematic block diagram of a point cloud encoding and decoding system involved in an embodiment of the present disclosure. It is to be noted that FIG. 3 only illustrates an example, and the point cloud encoding and decoding system in the embodiments of the present disclosure includes but is not limited to that illustrated in FIG. 3. As illustrated in FIG. 3, the point cloud encoding and decoding system 100 includes an encoding device 110 and a decoding device 120. The encoding device is configured to encode (which may be understood as compress) the point cloud data to generate a bitstream, and transmit the bitstream to the decoding device. The decoding device is configured to decode the bitstream generated by the encoding device to obtain decoded point cloud data.

The encoding device 110 in the embodiments of the present disclosure may be understood as a device with a point cloud encoding function, and the decoding device 120 may be understood as a device with a point cloud decoding function. That is, in the embodiments of the present disclosure, the encoding device 110 and the decoding device 120 includes multiple types of devices, such as smartphones, desktop computers, mobile computing apparatuses, notebook (e.g., laptop) computers, tablet computers, set-top boxes, televisions, cameras, display devices, digital media players, point cloud game consoles, and vehicle-mounted computers.

In some embodiments, the encoding device 110 may transmit the encoded point cloud data (e.g., the bitstream) to the decoding device 120 via a channel 130. The channel 130 may include one or more media and/or apparatuses which are capable of transmitting the encoded point cloud data from the encoding device 110 to the decoding device 120.

In an instance, the channel 130 includes one or more communication media that enable the encoding device 110 to transmit the encoded point cloud data directly to the decoding device 120 in real time. In this instance, the encoding device 110 may modulate the encoded point cloud data according to a communication standard and transmit the modulated point cloud data to the decoding device 120. The communication medium includes a wireless communication medium, such as, a radio frequency spectrum. Optionally, the communication medium may also include a wired communication medium, such as, one or more physical transmission lines.

In another instance, the channel 130 includes a storage medium, and the storage medium may store the point cloud data encoded by the encoding device 110. The storage medium includes a variety of locally accessible data storage media, such as an optical disk, a DVD, and a flash memory. In this instance, the decoding device 120 may acquire the encoded point cloud data from the storage medium.

In yet another instance, the channel 130 may include a storage server, and the storage server may store the point cloud data encoded by the encoding device 110. In this instance, the decoding device 120 may download the encoded point cloud data stored in the storage server from the storage server. Optionally, the storage server may store the encoded point cloud data and transmit the encoded point cloud data to the decoding device 120, such as a web server (e.g., for a website), a file transfer protocol (FTP) server, or the like.

In some embodiments, the encoding device 110 includes a point cloud encoder 112 and an output interface 113. The output interface 113 may include a modulator/demodulator (modem) and/or a transmitter.

In some embodiments, the encoding device 110 may further include a point cloud source 111 in addition to the point cloud encoder 112 and the output interface 113.

The point cloud source 111 may include at least one of: a point cloud collection apparatus (e.g., a scanner), a point cloud archive, a point cloud input interface, or a computer graphics system, where the point cloud input interface is used to receive point cloud data from a point cloud content provider, and the computer graphics system is used to generate the point cloud data.

The point cloud encoder 112 encodes the point cloud data from the point cloud source 111 to generate a bitstream. The point cloud encoder 112 transmits the encoded point cloud data directly to the decoding device 120 via the output interface 113. The encoded point cloud data may also be stored in a storage medium or a storage server for subsequent reading by the decoding device 120.

In some embodiments, the decoding device 120 includes an input interface 121 and a point cloud decoder 122.

In some embodiments, the decoding device 120 may further include a display apparatus 123 in addition to the input interface 121 and the point cloud decoder 122.

The input interface 121 includes a receiver and/or a modem. The input interface 121 may receive the encoded point cloud data through the channel 130.

The point cloud decoder 122 is used to decode the encoded point cloud data to obtain decoded point cloud data, and transmit the decoded point cloud data to the display apparatus 123.

The display apparatus 123 displays the decoded point cloud data. The display apparatus 123 may be integrated with the decoding device 120 or external to the decoding device 120. The display apparatus 123 may include a variety of display apparatuses, such as a liquid crystal display (LCD), a plasma display, an organic light emitting diode (OLED) display, or other types of display devices.

In addition, FIG. 3 only illustrates an example, and the technical solution of the embodiments of the present disclosure is not limited to FIG. 3. For example, the technology of the present disclosure may also be applied to unilateral point cloud encoding or unilateral point cloud decoding.

The current point cloud encoder may adopt two point cloud compression coding technology routes proposed by the Moving Picture Experts Group (MPEG) of the international standards organization, namely Video-based Point Cloud Compression (VPCC) and Geometry-based Point Cloud Compression (GPCC). The VPCC projects a 3D point cloud into 2D and encodes a projected 2D picture using existing 2D coding tools. The GPCC partitions a point cloud into multiple units step by step using a hierarchical structure and encodes the entire point cloud by encoding and recording the partitioning process.

The point cloud encoder and the point cloud decoder applicable to the embodiments of the present disclosure are described below by taking the GPCC encoding and decoding framework as an example.

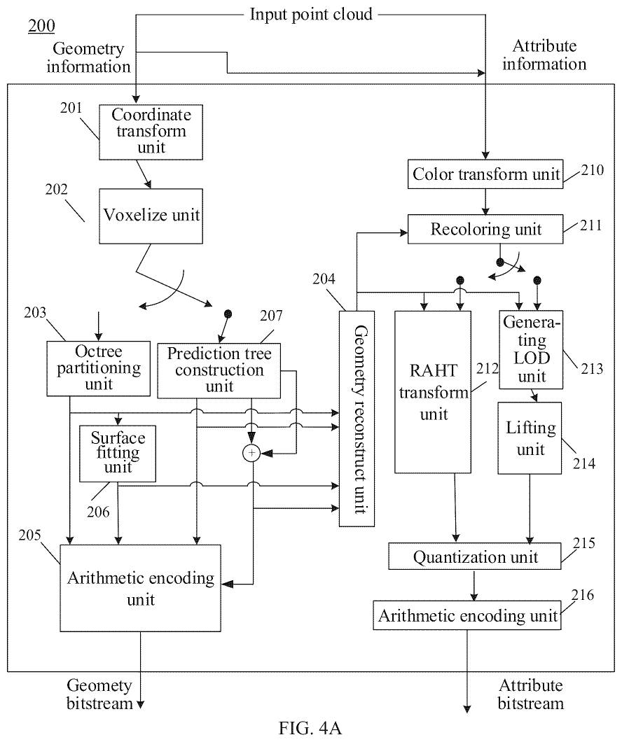

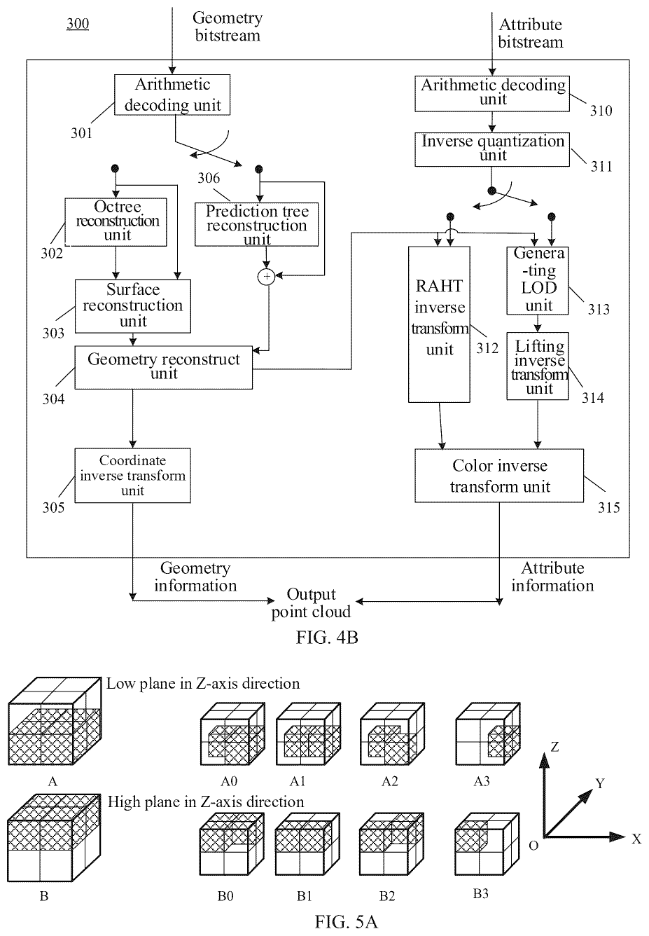

FIG. 4A is a schematic block diagram of a point cloud encoder provided by an embodiment of the present disclosure.

As can be seen from the above, a point in the point cloud may include position information of the point and attribute information of the point. Therefore, the encoding of the point in the point cloud mainly includes position encoding and attribute encoding. In some examples, the position information of the point in the point cloud is also referred to as geometry information; and correspondingly, the position encoding of the point in the point cloud may also be referred to as geometric encoding.

In the GPCC encoding framework, the geometry information of the point cloud and the corresponding attribute information of the point cloud are encoded separately.

As illustrated in FIG. 4A below, the current G-PCC geometric encoding and decoding may be classified into octree-based geometric encoding and decoding and predictive tree-based geometric encoding and decoding.

A process of the position encoding includes: performing preprocessing (e.g., coordinate transform, quantization, and removal of duplicate points) on the points in the point cloud; and then, performing geometric encoding on the preprocessed point cloud, e.g., constructing an octree or constructing a predictive tree, and performing geometric encoding on the constructed octree or predictive tree to form a geometry bitstream. At the same time, based on the position information output by the constructed octree or predictive tree, position information of each point in the point cloud data is reconstructed to obtain a reconstructed value of the position information of each point.

A process of the attribute encoding includes: selecting one of three prediction modes to perform point cloud prediction through given reconstructed information of position information and an original value of attribute information of an input point cloud, quantizing the predicted result, and performing arithmetic encoding to form an attribute bitstream.

As illustrated in FIG. 4A, the position encoding may be implemented by the following units: a coordinate transform (transform coordinates) unit 201, a voxelize unit 202, an octree partitioning (analyze octree) unit 203, a geometry reconstruct (reconstruct geometry) unit 204, an arithmetic encode unit 205, a surface fitting (analyze surface approximation) unit 206, and a predictive tree construction unit 207.

The coordinate transform unit 201 may be used to transform world coordinates of a point in the point cloud into relative coordinates. For example, subtracting the minimum values of the xyz-coordinate axis from geometry coordinates of the point respectively is equivalent to a direct current removal operation, to implement the transform of the coordinates of the point in the point cloud from the world coordinates to the relative coordinates.

The voxelize unit 202 is also referred to as a quantize and remove duplicate points (quantize and remove points) unit; the number of coordinates may be reduced through quantization; after quantization, originally different points may be assigned the same coordinates; and based on which, duplicate points may be removed through a deduplication operation. For example, multiple clouds with the same quantized position and different pieces of attribute information may be merged into one cloud by attribute transform. In some embodiments of the present disclosure, the voxelize unit 202 is an optional unit module.

The octree partitioning unit 203 may encode the position information of the quantized points using an octree coding manner. For example, the point cloud is partitioned in an octree form, so that positions of the points in the point cloud may be in one-to-one correspondence with positions of the octree. By counting the positions in the octree that contain points and marking their flags as 1, the geometric encoding is performed.

In some embodiments, in a process of geometry information encoding based on trianglesoup (trisoup), octree partitioning is also performed on the point cloud through the octree partitioning unit 203. However, different from the manner of the octree-based geometry information encoding, the trisoup does not need to partition the point cloud into unit cubes with a side length of 1×1×1 step by step, but stops partitioning once there exists a block (sub-block) with a side length of W. Based on a surface formed by the distribution of the point cloud in each block, at most twelve vertices (intersections) generated by the surface and the twelve edges of the block are obtained; surface fitting is performed on the vertices by the surface fitting unit 206; and the geometric encoding is performed on the fitted vertices.

The predictive tree construction unit 207 may encode the position information of the quantized points using a predictive tree encoding manner. For example, the point cloud is partitioned in a prediction tree form, so that the positions of the point in the point cloud may be in one-to-one correspondence with the positions of nodes in the predictive tree. By counting the positions in the prediction tree that have points, the geometry position information of the nodes is predicted by selecting different prediction modes to obtain prediction residuals; and the geometry prediction residuals are quantized using a quantization parameter. Finally, through continuous iteration, the prediction residuals of the predictive tree node position information, the structure of the predictive tree and the quantization parameter are encoded to generate a binary bitstream.

The geometry reconstruct unit 204 may perform position reconstruction based on the position information output by the octree partitioning unit 203 or the vertices fitted by the surface fitting unit 206 to obtain the reconstructed value of the position information of each point in the point cloud data. Alternatively, position reconstruction is performed based on the position information output by the predictive tree construction unit 207 to obtain the reconstructed value of the position information of each point in the point cloud data.

The arithmetic encode unit 205 may perform, by using an entropy coding manner, arithmetic encoding on encode the position information output by the octree partitioning (analyze octree) unit 203 or the vertices fitted by the surface fitting unit 206 or the geometry prediction residual values output by the predictive tree construction unit 207, to generate a geometry bitstream; where the geometry bitstream may also be referred to as a geometry bit stream.

The attribute encoding may be implemented by the following units:
a color transform (transform colors) unit 210, a recoloring (transfer attributes) unit 211, a region adaptive hierarchical transform (RAHT) unit 212, a generate LOD unit 213, a lifting (lifting transform) unit 214, a quantization (or quantize coefficients) unit 215, and an arithmetic encode unit 216.

It is to be noted that a point cloud encoder 200 may include more, fewer or different functional components than those illustrated in FIG. 4A.

The color transform unit 210 may be used to transform an RGB color space of the points in the point cloud into a YCbCr format or other formats.

The recoloring unit 211 performs recoloring on color information using the reconstructed geometry information, so that the uncoded attribute information corresponds to the reconstructed geometry information.

After an original value of the attribute information of the point is obtained through transformation by the recoloring unit 211, any one of the transform units may be selected to transform the point in the point cloud. The transform units may include the RAHT transform unit 212 and the lifting (lifting transform) unit 214. The lifting transform depends on generating a level of detail (LOD).

Any one of the RAHT transform and the lifting transform may be understood as being used to predict the attribute information of the point in the point cloud to obtain a prediction value of the attribute information of the point, and then to obtain a residual value of the attribute information of the point based on the prediction value of the attribute information of the point. For example, the residual value of the attribute information of the point may be obtained by subtracting the prediction value of the attribute information of the point from the original value of the attribute information of the point.

In an embodiment of the present disclosure, a process of generating an LOD by the LOD generate unit includes: obtaining Euclidean distances between points according to the position information of the points in the point cloud; and partitioning the points into different detail expression levels according to the Euclidean distances. In an embodiment, after the Euclidean distances are sorted, Euclidean distances in different ranges may be partitioned into different detail expression levels. For example, a point may be randomly selected as a first detail expression level. Then, Euclidean distances between remaining points and the point are calculated, and points whose Euclidean distances meet a first threshold requirement are partitioned as a second detail expression level. A centroid of the points in the second detail expression level is obtained, Euclidean distances between points other than the first and second detail expression levels and the centroid are calculated, and points whose Euclidean distance meet a second threshold are partitioned as a third detail expression level; and so forth, all points are partitioned into the detail expression levels. By adjusting a threshold of Euclidean distance, the number of points in each LOD level may be increased. It is to be understood that the LOD partitioning manner may also be performed using other manners, which is not limited in the present disclosure.

It is to be noted that the point cloud may be directly partitioned into one or more detail expression levels, or the point cloud may be first partitioned into multiple point cloud slices, and then each point cloud slice may be partitioned into one or more LOD levels.

For example, the point cloud may be partitioned into multiple point cloud slices, and the number of points in each point cloud slice may be in a range between 550,000 and 1.1 million. Each point cloud slice may be considered as a separate point cloud. Each point cloud slice may be partitioned into multiple detail expression levels, and each detail expression level includes multiple points. In an embodiment, the detail expression level may be partitioned according to Euclidean distances between the points.

The quantization unit 215 may be used to quantize the residual value of the attribute information of the point. For example, in a case where the quantization unit 215 is connected to the RAHT transform unit 212, the quantization unit 215 may be used to quantize the residual value of the attribute information of the point output by the RAHT transform unit 212.

The arithmetic encode unit 216 may perform entropy encoding on the residual value of the attribute information of the point using zero run length coding, to obtain an attribute bitstream. The attribute bitstream may be bitstream information.

FIG. 4B is a schematic block diagram of a point cloud decoder provided by an embodiment of the present disclosure.

As illustrated in FIG. 4B, the decoder 300 may obtain a point cloud bitstream from an encoding device, and obtain position information and attribute information of a point in the point cloud by parsing the bitstream. Decoding of the point cloud includes position decoding and attribute decoding.

A process of the position decoding includes: performing arithmetic decoding on a geometry bitstream; performing merge after constructing an octree, and reconstructing the position information of the point to obtain reconstructed information of the position information of the point; and performing coordinate transformation on the reconstructed information of the position information of the point to obtain the position information of the point. Position information of a point may also be referred to as geometry information of the point.

A process of the attribute decoding includes: obtaining a residual value of the attribute information of the point in the point cloud by parsing an attribute bitstream; obtaining an inverse-quantized residual value of the attribute information of the point by performing inverse quantization on the residual value of the attribute information of the point; selecting, based on the reconstruction information of the position information of the point obtained in the process of the position decoding, one of the RAHT inverse transform and the lifting inverse transform to perform point cloud prediction to obtain a prediction value, and adding the prediction value to the residual value to obtain a reconstructed value of the attribute information of the point; and performing color space inverse transformation on the reconstructed value of the attribute information of the point to obtain a decoded point cloud.

As illustrated in FIG. 4B, the position decoding may be implemented by the following units:
an arithmetic decoding unit 301, an octree reconstruct (synthesize octree) unit 302, a surface reconstruct (synthesize surface approximation) unit 303, a geometry reconstruct (reconstruct geometry) unit 304, a coordinate inverse transform (inverse transform coordinates) unit 305 and a predictive tree reconstruct unit 306.

The attribute decoding may be implemented by the following units:
an arithmetic decoding unit 310, an inverse quantize unit 311, an RAHT inverse transform unit 312, a generate LOD unit 313, an inverse transform (inverse lifting) unit 314, and a color inverse transform (inverse transform colors) unit 315.

It should be noted that decompression is an inverse process of compression. Similarly, as for functions of all units in the decoder 300, reference may be made to the functions of the corresponding units in the encoder 200. In addition, the point cloud decoder 300 may include more, fewer, or different functional components than those illustrated in FIG. 4B.

For example, the decoder 300 may partition the point cloud into multiple LODs based on Euclidean distances between points in the point cloud, and decode attribute information of the points in the LODs in turn, e.g., compute the number of zeros (zero_cnt) in a zero-run encoding technique to decode a residual based on zero_cnt. Then, a decoding architecture may perform inverse quantization based on the decoded residual value, and obtain a reconstructed value of the point cloud by adding an inverse-quantized residual value to a prediction value of a current point, until all point clouds are decoded. The current point will serve as the nearest neighbor point to points in a subsequent LOD, and attribute information of the subsequent points will be predicted using the reconstructed value of the current point.

The above is a basic process of the point cloud encoder and decoder based on the GPCC encoding and decoding architecture. With the development of technology, some modules or steps of the architecture or process may be optimized. The present disclosure is applicable to the basic process of the point cloud encoder and decoder based on the GPCC encoding and decoding architecture, but is not limited to the architecture and process.

Next, the octree-based geometric encoding and the prediction tree-based geometric encoding are introduced below.

The octree-based geometric encoding includes the following steps. First, coordinate transform is performed on the geometry information, so that all point clouds are included in a Bounding Box. Then, quantization is performed, and the process of quantization mainly plays the role of scaling. Due to quantization and rounding, the geometry information of part of points is the same, it is determined whether to remove duplicate points based on parameters, and the process of quantization and removal of duplicate points is also referred to as voxelization process. Next, tree partitioning (e.g., octree, quadtree, binary tree) is performed on the Bounding Box continually in the order of breadth-first traversal, and the occupancy code of each node is encoded. In an implicit geometry partitioning method. First, the bounding box of the point cloud (2^{d}^{ₓ},2^{d}^{_{y}},2^{d}^{_{z}}) is calculated; and assuming that dₓ>d_{y}>d_{z}, the bounding box corresponds to a cuboid. During geometry partitioning, binary tree partitioning is performed first based on the x-axis to obtain two child nodes; binary tree partitioning continues until the condition of dₓ=d_{y}>d_{z} is met, quadtree partitioning is performed continually based on the x and y axes to obtain four child nodes; and then, when the condition of dₓ=d_{y}=d_{z} is met, octree partitioning is performed continually until the leaf node obtained through partitioning is a unit cube with a size of 1×1×1, at which the partitioning operation terminates. After that, the points in the leaf nodes are encoded to generate a binary bitstream. During the process of binary tree/quadtree/octree-based partitioning, two parameters, K and M, are introduced. Parameter K indicates the maximum number of binary tree/quadtree partitionings before octree partitioning is performed; and parameter M is used to indicate that the side length of the corresponding minimum block is 2^{M} when binary tree/quadtree partitioning is performed. At the same time, K and M must meet the condition: assuming that dₘₐₓ=max(dₓ,d_{y},d_{z}),dₘᵢₙ=min(dₓ,d_{y},d_{z}), parameter K meets the condition of K>=dₘₐₓ−dₘᵢₙ; and parameter M meets the condition of M>=dₘᵢₙ. The reason why parameters K and M meet the above conditions is that, during the current process of G-PCC geometry implicit partitioning, the priority of the partitioning manners is binary tree, quadtree and octree. Only when the block size of the node does not meet the condition of binary tree/quadtree, octree partitioning will be performed on the node until the minimum unit of the partitioned leaf node has a size of 1×1×1.

The octree-based geometry information encoding mode may effectively encode the geometry information of the point cloud by utilizing the correlation between neighboring points in space. However, for some relatively planar nodes or nodes with planar characteristics, the coding efficiency of the geometry information of point cloud may be further improved by utilizing the planar coding.

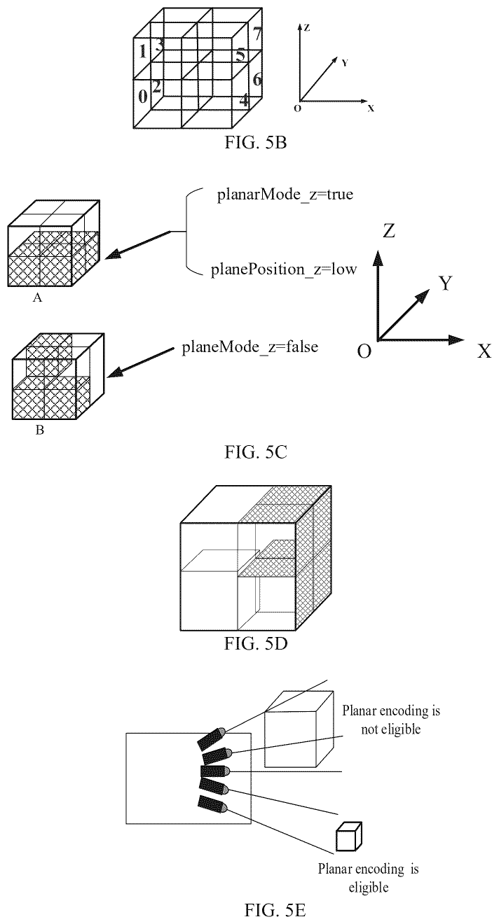

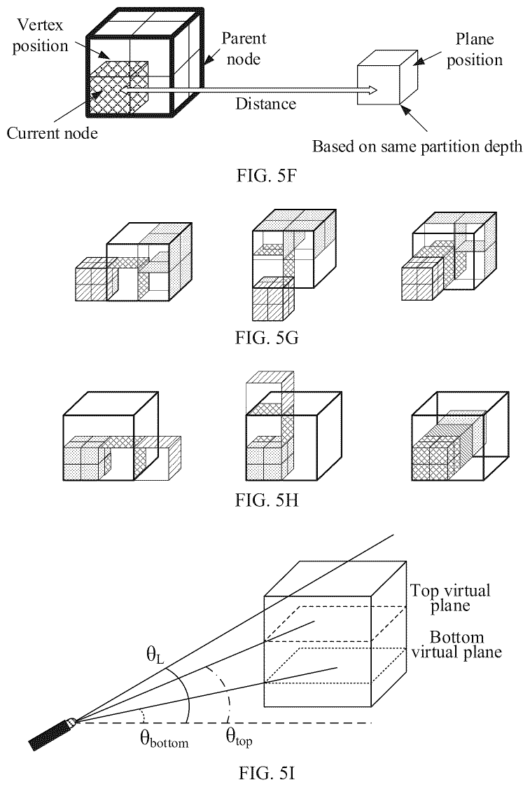

For example, as illustrated in FIG. 5A, A series belongs to a low plane position in a Z-axis direction, and B series belongs to a high plane position in the Z-axis direction. Taking A as an example, it can be seen that the four occupied child nodes of the current node are all located in the low plane positions of the current node in the Z-axis direction. Therefore, it may be considered that the current node belongs to a Z plane and is a low plane in the Z-axis direction. Similarly, B indicates that the occupied child nodes of the current node are located in the high plane positions of the current node in the Z-axis direction.

Taking A as an example, the octree encoding and the planar encoding are compared in terms of efficiency. As illustrated in FIG. 5B, if an octree encoding manner is used for A in FIG. 5A, occupancy information of the current node is represented as: 11001100. Whereas if a planar encoding manner is used, first, an identifier needs to be encoded to represent that the current node is a plane in the Z axis direction; second, if the current node is a plane in the Z axis direction, the planar position of the current node needs to be represented; and then only occupancy information of low planar nodes in the Z axis direction needs to be encoded (e.g., occupancy information of four child nodes 0246). Therefore, based on the planar encoding manner, only 6 bits are needed to encode the current node, which may reduce 2 bits of representation compared to the original octree encoding. Based on this analysis, the planar encoding has more significant encoding efficiency than the octree encoding. Therefore, for an occupied node, if the planar coding is used for encoding in a certain dimension, as illustrated in FIG. 5C, first, planar flag (planarMode) information and planar position (PlanePos) information of the current node in this dimension need to be represented, and then occupancy information of the current node is encoded based on planar information of the current node. It will be noted that: for PlaneModei (i is equal to 0, 1 or 2): 0 represents that the current node is not a plane in an i-axis direction. In a case where the node is a plane in the i-axis direction, for PlanePositioni: 0 represents that the current node is a plane in the i-axis direction, and its planar position is a low plane, 1 represents that the current node is a high plane in the i-axis direction. For example, i=0 represents the X axis, i=1 represents the Y axis, and i=2 represents the Z axis.

In the current GPCC standard, a determination of whether a node meets conditions for the planar encoding, and predictive encoding of planar flag and planar position information of the node in a case where the current node meets the conditions for the planar encoding, are introduced in detail below.

In the current G-PCC standards, there are three types of determination condition for determining whether a node meets planar coding, which are described in detail below.

The first type: the determination is performed according to a plane probability of the node in each dimension.

First, a local node density (local_node_density) of the current node and a probability of the current node Prob(i) in each dimension are determined.

When the local_node_density of the node is less than a threshold Th (Th=3), the plane probabilities of the current node in three coordinate dimensions Prob(i) are compared with thresholds Th0, Th1 and Th2, where Th0<Th1<Th2 (Th0=0.6, Th1=0.77 and Th2=0.88). Hereafter, Eligibleᵢ (i=0, 1, 2) is used to represent whether the planar coding is enabled in each dimension, the determination process of Eligibleᵢ is shown in equation (1). For example, if Eligibleᵢ>=threshold, it indicates that planar coding is enabled in the i-th dimension:

$${Eligible}_{i} = Prob ( i ) >= threshold \qquad ( 1 )$$

It is to be noted that the thresholds is adaptively changed. For example, when Prob(1) is greater than Prob(0) and less than Prob(2) (i.e., Prob(0)>Prob(1)>Prob(2)), a value of the threshold is as shown in equation (2):

$${Eligible}_{0} = Prob ( 0 ) > = Th 0 \qquad ( 2 )$$

$${Eligible}_{1} = Prob ( 1 ) > = Th 1$$

$${Eligible}_{2} = Prob ( 2 ) > = Th 2$$

The update process of local_node_density and the updating of Prob(i) are described below.

In an example, Prob(i) is updated as the following equation (3):

$$Prob {( i )}_{new} = ( Lx Prob ( i ) + δ ( coded node ) ) / L + 1 \qquad ( 3 )$$

Where, L is equal to 255 (L=255). When the coded node is a plane, δ(coded node) is 1; otherwise, δ(coded node) is 0.

In an example, local_node_density is updated as the following equation (4):

$$local\_node {\_density}_{new} = local\_node \_density + 4 * numSiblings \qquad ( 4 )$$

Where local_node_density is initialized to 4, and numSiblings is the number of sibling nodes of the node. As illustrated in FIG. 5D, in a case where the current node is a left node and the right nodes are siblings of the current node, the number of the siblings of the current node is 5 (including the current node itself).

The second type: it is determined whether the nodes in the current level (or referred to as layer) meet planar coding according to the point cloud density of the current level.

The density of points in the current level is used to determine whether to perform planar coding on the nodes in the current level. Assuming that the number of points in the current to-be-encoded point cloud is pointCount, and the number of points reconstructed after IDCM encoding is numPointCountRecon. Because octree coding is performed based on the order of breadth-first traversal, the number of nodes to be encoded in the current level is assumed to be nodeCount; and then the determination of whether planar coding is enabled on the current level is assumed to be planarEligibleKOctreeDepth. Where the determination process of planarEligibleKOctreeDepth is shown in equation (5):

planarEligibleKOctreeDepth=(pointCount-numPointCountRecon)<nodeCount*1.3 (5)

When planarEligibleKOctreeDepth is true, planar coding is performed on all nodes in the current level; otherwise, planar coding is not performed on all nodes in the current level, and octree coding is adopted only.

The third type: it is determined whether the current node meets planar coding according to a collection parameter of a laser radar point cloud.

As illustrated in FIG. 5E, it may be seen that a node of large cube at top is passed through by two lasers simultaneously, so the current node is not a plane in a direction perpendicular to the Z axis, and a node of small cube at bottom is small enough that it cannot be passed through by two nodes simultaneously, so the current node is likely to be a plane. Therefore, whether the current node meets the planar encoding is determined based on the number of lasers corresponding to the current node.

For a node meeting the condition for planar coding, predictive coding on the planar flag information and the plane position information are introduced below.

### I. Predictive Coding of the Planar Flag Information.

Currently, the planar flag information is encoded using three contexts. That is, the context is designed separately for planar representations in each dimension.

Encoding of planar position information of non-lidar point clouds and encoding of planar position information of laser radar point clouds are introduced separately below.

### I. Encoding of the Planar Position Information of the Non-Lidar Point Clouds

### 1. Predictive Coding of the Plane Position Information.

The predictive coding is performed on the plane position information based on the following information:
(1) the plane position information of the current node obtained by using the occupancy information of neighborhood nodes for prediction, the plane position information being three elements: predicted as a low plane, predicted as a high plane or unpredictable;
(2) the spatial distance between a node at the same partitioning depth and the same coordinate as the current node and the current node: “near” or “far”;
(3) a planar position of a node at the same partition depth and the same coordinate as the current node; and
(4) coordinate dimension (i=0, 1, 2).

As illustrated in FIG. 5F, the current node to be encoded is a left node, a neighborhood node is searched for as a right node at the same octree partition depth level and the same vertical coordinate, a distance between those two nodes is determined as “near” or “far”, with reference to the planar position of the node.

In an example, as illustrated in FIG. 5G, a node filled with gridding is the current node; and if the current node is located at a low plane of a parent node, the planar position of the current node is determined in manners as follows.
a) If any one of child nodes 4 to 7 of a node filled with slashes is occupied, and all nodes filled with points are not occupied, there is a high probability that there is a plane in the current node, and the plane position is located lower.
b) If none of the child nodes 4 to 7 of the node filled with slashes is occupied, and any node filled with points are occupied, there is a high probability that there is a plane in the current node, and the plane position is located higher.
c) If all the child nodes 4 to 7 of the node filled with slashes are empty nodes, and all the nodes filled with points are empty nodes, the plane position cannot be inferred and is therefore marked as unknown.
d) If any one of the child nodes 4 to 7 of the node filled with slashes is occupied, and any one of the nodes filled with points is occupied, the plane position still cannot be inferred and is therefore marked as unknown.

In another example, as illustrated in FIG. 5H, a black node is the current node; and if the current node is located at a high planar position of a parent node, the planar position of the current node is determined in manners as follows.
a) If any one of child nodes 4 to 7 of a node filled with points is occupied, and a node filled with slashes is not occupied, there is a high probability that there is a plane in the current node, and the plane position is located lower.
b) If the child nodes 4 to 7 of the node filled with points are not occupied, and the node filled with slashes is occupied, there is a high probability that there is a plane in the current node, and the plane position is located higher.
c) If all the child nodes 4 to 7 of the node filled with points are not occupied, and the node filled with slashes is not occupied, the plane position cannot be inferred and is therefore marked as unknown.
d) If any one of the child nodes 4 to 7 of the node filled with points is occupied, and the node filled with slashes is occupied, the plane position cannot be inferred and is therefore marked as unknown.

### II. Encoding of the Planar Position Information of Laser Radar Point Clouds

FIG. 5I illustrates the predictive encoding of the planar position information of the laser radar point cloud. The planar position of the current node is predicted by using parameters collected by a laser radar, and the position is quantized into four intervals by using positions of intersection of the current node and laser rays, which finally serve as the context of the planar position of the current node. A specific calculation process is the following: assuming that coordinates of the laser radar are (x_{Lidar}, y_{Lidar}, z_{Lidar}) and geometric coordinates of the current point are (x, y, z), a vertical tangent value tan [symbol] θ of the current point relative to the laser radar is first calculated, with the calculation process shown in formula (6):

$$tan θ = \frac{z - {z}_{Lidar}}{\sqrt{{( x - {x}_{Lidar} )}^{2} + {( y - {y}_{Lidar} )}^{2}}} \qquad ( 6 )$$

In addition, since each laser has a certain offset angle relative to the laser radar, a relative tangent value tan θ_{corr,L} of the current node relative to the laser is calculated, with the specific calculation process shown in formula (7):

$$tan {θ}_{corr , L} = \frac{z - {z}_{Lidar} - {z}_{L}}{\sqrt{{( x - {x}_{Lidar} )}^{2} + {( y - {y}_{Lidar} )}^{2}}} = tan θ - \frac{{z}_{L}}{r} \qquad ( 7 )$$

Finally, the planar position of the current node is predicted by using a corrected tangent value of the current node. Specifically, assuming that a tangent value of a lower boundary of the current node is tan(θ bottom), and a tangent value of an upper boundary is tan(θ top), the planar position is quantized into 4 quantization intervals based on tan θ_{corr,L}, i.e., the context of the planar position.

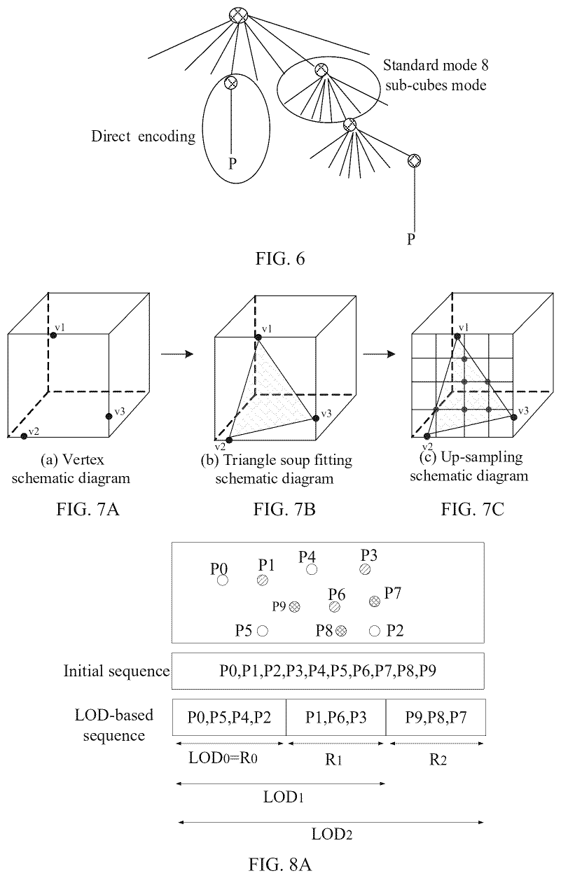

However, the octree-based geometry information encoding mode only has an efficient compression rate for points that are correlated in space. For points that are isolated in the geometric space, use of the direct coding model (DCM) may greatly reduce complexity. For all nodes in the octree, use of DCM is not represented by flag information, but is inferred from the parent node and neighboring information of the current node. There are three manners to determine whether the current node is eligible for the DCM encoding, as illustrated in FIG. 6.

(1) The current node has no sibling child nodes, that is, the parent node of the current node has only one child node, and the parent node of the parent node of the current node has only two occupied child nodes, that is, the current node has at most one neighboring node.

(2) The parent node of the current node has only one occupied child node (i.e., the current node); and the six neighboring nodes that share a face with the current node also belong to empty nodes.

(3) The number of sibling nodes of the current node is greater than 1.

If the current node is not eligible for DCM encoding, octree partitioning will be performed on the current node. If the current node is eligible for DCM encoding, the number of points included in the node will be further determined. When the number of points is less than a threshold (e.g., 2), DCM encoding will be performed on the node, otherwise, octree partitioning will continue to be performed on the node. When the DCM coding mode is applied, it is necessary to encode whether the current node is a real isolated point firstly, i.e., IDCM_flag. When IDCM_flag is true, the current node adopts DCM encoding, otherwise, it is still adopts octree coding. When the current node meets the condition for DCM encoding, it is necessary to encode the DCM coding mode of the current node. At present, there are two DCM modes, which are: (1) existing only one point (or multiple points, but they are duplicate points); and (2) containing two points. Finally, it is necessary to encode the geometry information of each point. Assuming that a side length of the node is 2^{d}, d bits are required to encode each component of the geometry coordinates of the node, and this bit information is directly encoded into the bitstream. It is to be noted here that when encoding is performed on the laser radar point cloud, predictive coding is performed on the coordinate information with three dimensions by using the laser radar acquisition parameters, thereby further improving the coding efficiency of the geometry information.

It is also to be noted that when a node is partitioned into leaf nodes, under geometry lossless encoding, the number of duplicate points in the leaf nodes needs to be encoded. Finally, the occupancy information of all nodes is encoded to generate a binary bitstream. In addition, a planar coding mode is introduced in G-PCC currently. During the process of geometry partitioning, it will be determined whether the child nodes of the current node are co-planar. If the child nodes of the current node meet the condition for co-planar, the child nodes of the current node will be represented by the plane.

For the octree-based geometric decoding, before decoding the occupancy information of each node, a decoding side will first determine, in the order of breadth-first traversal, whether to perform the planar decoding or the IDCM decoding on the current node by using the reconstructed geometry information. If the current node meets a condition for the planar decoding, the decoding side will first decode the planar flag and planar position information of the current node, and then decode the occupancy information of the current node based on the planar information. If the current node meets a condition for the IDCM decoding, the decoding side will first decode whether the current node is a true IDCM node; and if the current node is a true IDCM node, the decoding side will continue to parse the DCM decoding mode of the current node, and then the decoding side may obtain the number of points in the current DCM node and finally decode the geometry information of each point. For a node that does not meet either the planar decoding or the DCM decoding, the occupancy information of the current node will be decoded. By continuously parsing in this manner, an occupancy code of each node is obtained, and the partitioning is continued for the nodes in turn until unit cubes of 1×1×1 are obtained. The number of points included in each leaf node is parsed, and geometric reconstruction point cloud information is restored finally.

In a geometry information encoding architecture based on trisoup (triangle soup), similarly, geometric partitioning is also performed first. However, unlike the binary tree/quadtree/octree-based geometry information encoding, this method does not need to partition the point cloud into unit cubes with side lengths of 1×1×1 step by step, but stops partitioning once there exist blocks (sub-blocks) with a side length of W. Based on a surface formed in each block by the distribution of the point cloud, at most twelve vertices (intersections) generated by this surface and twelve sides of the block are obtained. Vertex coordinates of each block are encoded in turn to generate a binary bitstream.

For trisoup-based point cloud geometry information reconstruction, in response to performing the point cloud geometry information reconstruction, the decoding side first decodes the vertex coordinates to complete triangle soup reconstruction, a process of which is illustrated in FIG. 7A to FIG. 7C. There are three vertices (v1, v2, v3) in a block illustrated in FIG. 7A, and the triangle soup, i.e., trisoup, formed by these three vertices in a certain order is illustrated in FIG. 7B. Afterwards, sampling is performed on the triangle soup to obtain sampling points, which will serve as a reconstructed point cloud within the block, as illustrated in FIG. 7C.

The predictive tree-based geometric encoding includes steps as follows. First, an input point cloud is sorted, and the sorting methods currently used include unordered, Morton order, azimuth order, and radial distance order. An encoding side establishes a prediction tree structure by using two different manners including a high-latency slow mode (KD-Tree), and a low-latency fast mode in which each point is assigned to a different laser by using laser radar calibration information, and a prediction tree structure is established according to different lasers. Next, each node in the prediction tree is traversed based on the prediction tree structure, and geometric position information of the node is predicted by selecting different prediction modes to obtain a prediction residual, and the geometric prediction residual is quantized by using a quantization parameter. Finally, the prediction residual of the position information of the nodes in the prediction tree, the prediction tree structure, and the quantization parameter are encoded through continuous iteration to generate a binary bitstream.

For the predictive tree-based geometry decoding, the decoding side reconstructs the prediction tree structure by continuously parsing the bitstream, and then obtains the prediction residual information of the geometric position and a quantization parameter of each prediction node through parsing, and performs inverse quantization on the prediction residual for recovering, so as to obtain the reconstructed geometric position information of each node, and finally completes the geometric reconstruction on the decoding side.

The geometry information is reconstructed after the geometric encoding is completed. Currently, attribute encoding is mainly performed on color information. First, the color information is transformed from an RGB color space to a YUV color space. The point cloud is then recolored by using the reconstructed geometry information, to enable unencoded attribute information to correspond to the reconstructed geometry information. In color information encoding, there are two main transformation manners: one is distance-based lifting transformation that relies on LOD (level of detail) partitioning, and the other is that RAHT (Region Adaptive Hierarchal Transform) transformation is performed directly. Both manners can transform the color information from a spatial domain to a frequency domain, a high-frequency coefficient and a low-frequency coefficient are obtained through the transformation, and finally the coefficients are quantized and encoded to generate a binary bitstream.

When the attribute information is predicted by using the geometry information, Morton code may be used for performing nearest neighbor search, where the Morton code corresponding to each point in the point cloud may be obtained from geometric coordinates of this point. A specific method for calculating the Morton code is described below. For a three-dimensional coordinate with each component represented by a d-bit binary value, its three components may be represented as formula (8):

$$x = {\sum }_{ℓ = 1}^{d} {2}^{d - ℓ} {x}_{ℓ} , y = {\sum }_{ℓ = 1}^{d} {2}^{d - ℓ} {y}_{ℓ} , z = {\sum }_{ℓ = 1}^{d} {2}^{d - ℓ} {z}_{ℓ} , \qquad ( 8 )$$

Where [symbol] , [symbol] , [symbol] ∈{0,1} are binary values corresponding to bits, from the highest ( [symbol] =1) to the lowest ( [symbol] =d), of x, y, z, respectively. For x, y, z, starting from the highest bit, [symbol] , [symbol] , [symbol] are crosswise arranged in e-quaintance by using the Morton code M up to the lowest bit. Calculation formula of M is shown in formula (9):

$$M = {\sum }_{ℓ = 1}^{d} {2}^{3 ( d - ℓ )} ( 4 {x}_{ℓ} + 2 {y}_{ℓ} + {z}_{ℓ} ) = {\sum }_{{ℓ}^{′} = 1}^{3 d} {2}^{3 d - {ℓ}^{′}} {m}_{{ℓ}^{′}} \qquad ( 9 )$$

Where [symbol] ∈{0, 1} are values of M from the highest bit ( [symbol] =1) to the lowest bit ( [symbol] =3d). After the Morton code M of each point in the point cloud is obtained, the points in the point cloud are arranged in order of Morton code in an ascending order, and a weight value w of each point is set to 1.

There are 4 general test conditions for GPCC:
Condition 1: geometry positions with limited loss, and attributes with loss;
Condition 2: geometry positions lossless, but attributes with loss;
Condition 3: geometry positions lossless, and attributes with limited loss; and
Condition 4: geometry positions lossless, and attributes lossless.

The general test sequence includes four categories: Cat1A, Cat1B, Cat3-fused and Cat3-frame. Cat3-frame point cloud only includes reflectance attribute information, Cat1A and Cat1B point clouds only include color attribute information, and Cat3-fused point cloud includes both color and reflectance attribute information.

There are two technical routes for GPCC, which are distinguished by the algorithm used for geometry compression and classified into an octree coding branch and a predictive tree coding branch.

In the octree coding branch, at the encoding side, a bounding box is continuously partitioned into sub-cubes; and partitioning is continued for non-empty sub-cubes (including points in the point cloud) until leaf nodes obtained by partitioning are unit cubes of 1×1×1. In a case of geometric lossless encoding, the number of points included in the leaf node needs to be encoded to finally complete the encoding of the geometric octree and generate the binary bitstream. At the decoding side, the decoding side obtains, in the order of breadth-first traversal, an occupancy code of each node by continuous parsing, and the partitioning is continued for the nodes in turn until unit cubes of 1×1×1 are obtained. In the case of the geometric lossless decoding, the number of points included in each leaf node needs to be parsed, and the geometric reconstruction point cloud information is restored finally.

In the predictive tree coding branch, at the encoding side, a prediction tree structure is established by using two different manners including a high-latency slow mode (KD-Tree), and a low-latency fast mode in which each point is assigned into a different laser by using laser radar calibration information, and a prediction tree structure is established according to different lasers. Next, each node in the prediction tree is traversed based on the prediction tree structure, and geometric position information of the node is predicted by selecting different prediction modes to obtain a prediction residual, and the geometric prediction residual is quantized by using a quantization parameter. Finally, the prediction residual of the position information of the nodes in the prediction tree, the prediction tree structure, and the quantization parameter are encoded through continuous iteration to generate a binary bitstream. At the decoding side, the decoding side reconstructs the prediction tree structure by continuously parsing the bitstream, and then obtains the prediction residual information of the geometric position and a quantization parameter of each prediction node through parsing, and performs inverse quantization on the prediction residual for recovering, so as to obtain the reconstructed geometric position information of each node, and finally completes the geometric reconstruction on the decoding side.

The geometric encoding and decoding under the G-PCC coding framework are introduced above. The attribute encoding and decoding under the G-PCC coding framework are introduced below.

As illustrated in FIG. 4A, the current G-PCC coding framework includes three attribute encoding methods: predicting transform (PT), lifting transform (LT), and region adaptive hierarchical transform (RAHT). The first two methods perform predictive encoding on the point cloud based on the generation order of LODs, and the RAHT adaptively transforms attribute information from bottom to top based on the construction hierarchy of the octree. These three point cloud attribute encoding methods are explained separately below.

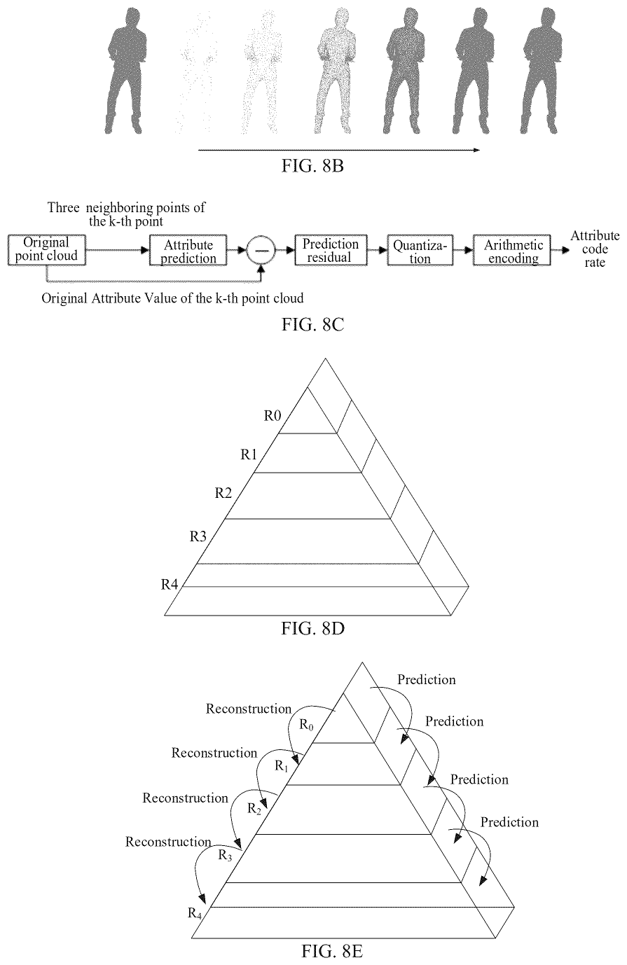

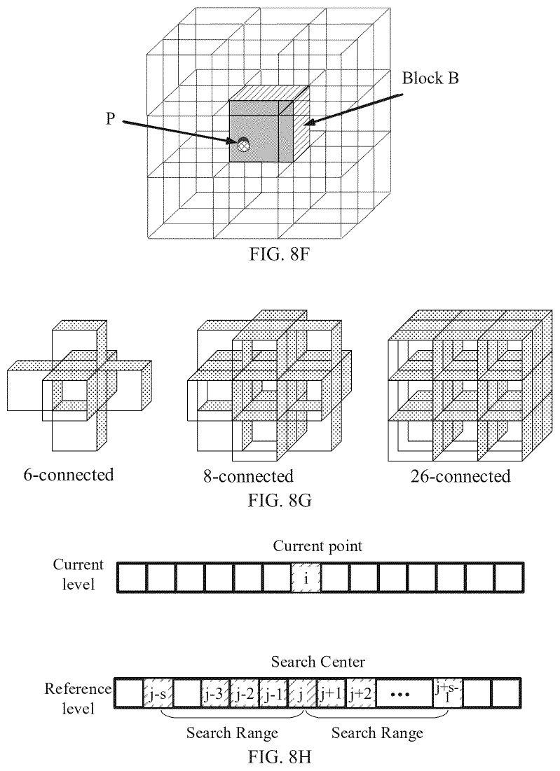

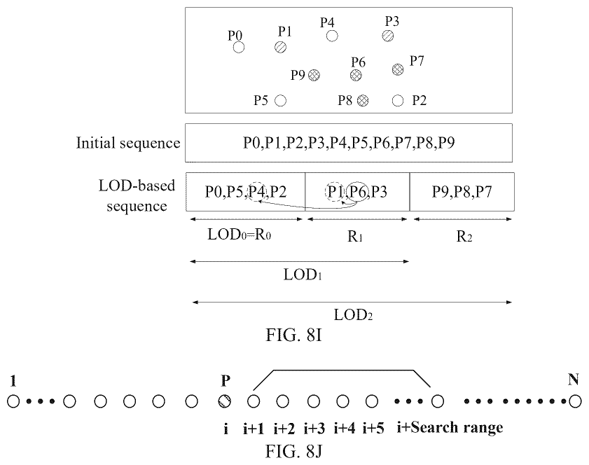

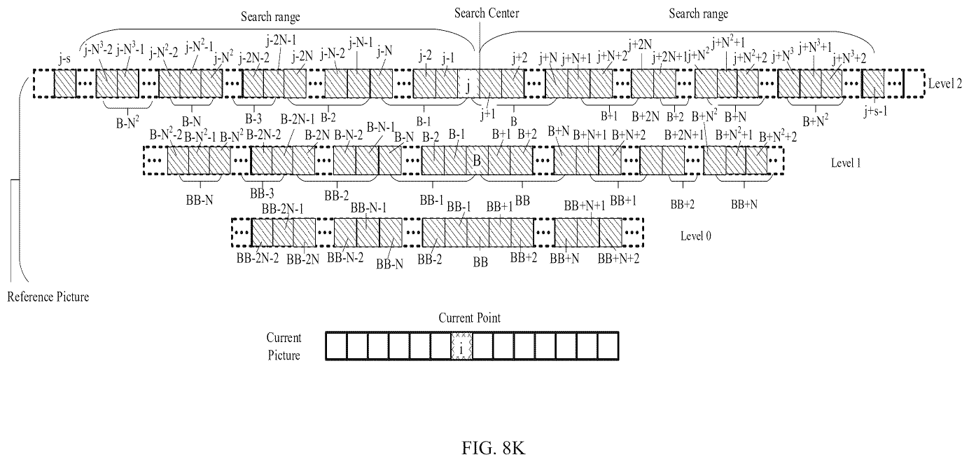

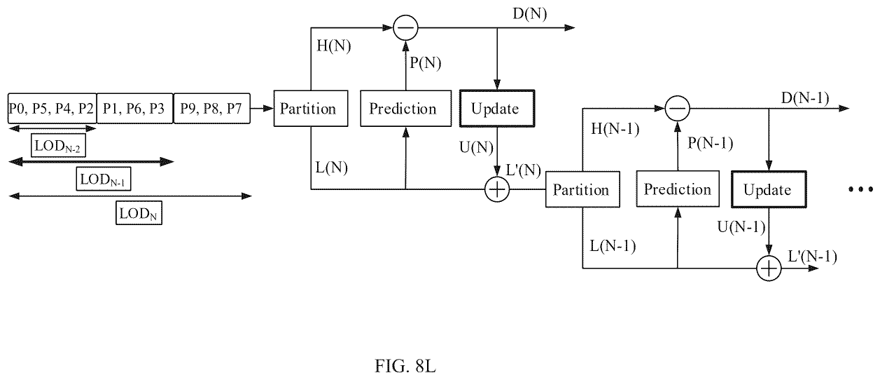

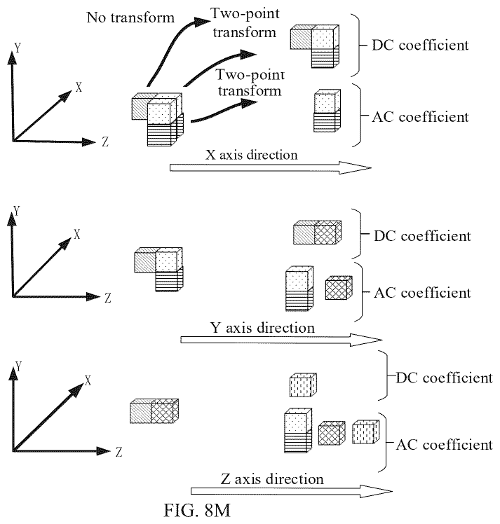

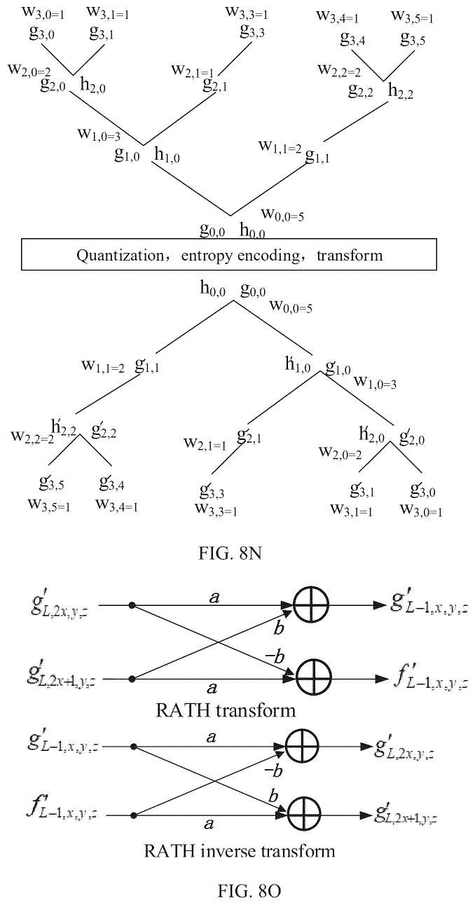

The current attribute prediction module of G-PCC uses a nearest neighbor attribute prediction encoding scheme based on a level-of-details (LoDs) structure. The LOD construction methods include a distance-based LOD construction scheme, a fixed sampling rate-based LOD construction scheme, and an octree-based LOD construction scheme. In the LOD construction scheme based on a distance threshold, the point cloud is first Morton sorted before constructing LOD to ensure that there is a strong attribute correlation between neighboring points. As illustrated in FIG. 8A, an example of a distance-based LOD construction process is given, in which the point clouds are partitioned into L different point cloud levels of detail (Rl) l=0, 1, . . . L−1 based on L Manhattan distances (dl) 1=0,1, . . . L−1 preset by the user, where (dl) 1=0,1, . . . L−1 meets dl less than dl−1. The construction process of LOD is as follows. (1) First, all points in the point cloud are marked as unvisited, and a set V is established to store the visited point set; (2) For each iteration 1, by traversing the points in the point cloud, if the current point has been visited, the current point is skipped, otherwise the minimum distance D from the current point to the point set V is calculated, if D less than dl, the point is skipped; otherwise, the current point is marked as visited, and the current point is added to the levels of detail Rl and the point set V; (3) The points in the level of detail LODl are composed of the points in the levels of detail R0, R1, R2 . . . R1; (4) The above steps are repeated until all points have been marked as visited.

Based on the LOD structure, the attribute value of each point is linearly weighted predicted by using the reconstructed attribute value of the point in the same or higher LOD level, where the maximum number of reference prediction neighbors is determined based on the encoder high-level syntax elements. For the attributes of each point, the rate-distortion optimization algorithm is used at the encoding side to select weighted prediction by using the attributes of the N nearest neighbor points searched or selecting the attributes of a single nearest neighbor point for prediction, and finally the selected prediction mode and prediction residual are encoded.

For example, the attribute prediction value is determined based on the following equation (10):

$${Attr}_{i}^{′} = Round ( \frac{1}{N} {\sum }_{m ∈ {p}_{i}} \frac{\frac{1}{{D}_{m}^{2}}}{{\sum }_{m ∈ {p}_{i}} \frac{1}{{D}_{m}^{2}}} {Attr}_{m} ) \qquad ( 10 )$$

Where N represents the number of prediction points in the nearest neighbor point set of point i, Pᵢ represents a sum of the N nearest neighbor points of point i, Dₘ represents a spatial geometry distance from the nearest neighbor point m to the current point i, Attrₘ represents the attribute value of the nearest neighbor point m after reconstruction, Attrᵢ′ represents the attribute prediction value of the current point i, and the number of points N is a preset value.

In order to balance the attribute encoding efficiency and parallel processing between different LOD levels, a switch is introduced in the encoder high-level syntax element to control whether to introduce intra-LOD level prediction. If the switch is turned on, intra-LOD level prediction is started, and points in the same LOD level may be used for prediction. It should be noted that in a case where the number of LOD levels is 1, intra-LOD level prediction is always used.

In an example, FIG. 8B illustrates a visualization result of LOD. The points at the first level represent outer contours of the point cloud. As the number of levels of LOD increases, the detail description of the point cloud becomes clearer.

In an example, FIG. 8C illustrates a flowchart of G-PCC attribute prediction. That is, for the k-th point in the point cloud, three neighboring points of the k-th point are first determined, and an attribute prediction value of the k-th point is determined based on the attribute reconstructed information of the three neighboring points. Next, an attribute prediction residual of the k-th point is obtained based on an original attribute value and the attribute prediction value of the k-th point, and after the attribute prediction residual is quantized, arithmetic encoding is performed to obtain an attribute bitstream.

In some embodiments, after the LOD is constructed, the three nearest neighbor points of the current point to be encoded are first found from the encoded data points based on the generation order of the LOD. The attribute reconstructed values of the three nearest neighbor points are used as candidate prediction values of the current point to be encoded; then, the optimal prediction value is selected from the attribute reconstructed values of the three nearest neighbor points according to the rate-distortion optimization (RDO). For example, in a case of encoding the attribute value of point P2 in FIG. 8A, the predictor variable index of the attribute value of the nearest neighbor point P4 is set to 1; the attribute predictor variable indexes of the second neighboring point P5 and the third neighboring point P0 are set to 2 and 3 respectively; and the predictor variable index of the weighted average of points P0, P5 and P4 is set to 0, as shown in Table 2:

TABLE 2
Samples of candidate prediction items for attribute encoding

| Prediction | |
|---|---|
| mode | Prediction value |
| 0 | Weighted average of attributes of three neighbors |
| 1 | P4 (an attribute value of the first neighbor) |
| 2 | P5 (an attribute value of the second neighbor) |
| 3 | P0 (an attribute value of three neighbor) |

Finally, the optimal predictor variable is selected using RDO. The formula of weighted average is shown in equation (11):

$${\hat{a}}_{i} = Round ( {\sum }_{j = 0}^{2} \frac{{\tilde{w}}_{ij}}{{\sum }_{j = 0}^{2} {\tilde{w}}_{ij}} {\tilde{a}}_{j} ) \qquad ( 11 )$$

In equation (11), \tilde{w}ᵢⱼ represents the spatial geometric weight from the neighboring point j to the current point i, and the calculation equation is shown in equation (12):

$${\tilde{w}}_{ij} = \frac{1}{{( {x}_{i} - {x}_{ij} )}^{2} + {( {y}_{i} - {y}_{ij} )}^{2} + {( {z}_{i} - {z}_{ij} )}^{2}} \qquad ( 12 )$$

Where âᵢ represents the attribute prediction value of the current point i, j represents the indexes of the three neighboring points, ãⱼ represents the attribute value of the neighbor points after reconstruction, xᵢ, yᵢ, zᵢ are the geometry position coordinates of the current point i, and xᵢⱼ, yᵢⱼ, zᵢⱼ are the geometry coordinates of the neighboring points j.

The attribute prediction residual and quantification are introduced below.

Through the above prediction, the attribute prediction value (âᵢ)_{i∈0 . . . k-1} (where k represents a total number of points in the point cloud) of the current point i is obtained. Let (aᵢ)_{i∈0 . . . k-1} be the original attribute value of the current point, then as shown in equation (13), the attribute residual (rᵢ)_{i∈0 . . . k-1} is denoted as:

$${r}_{i} = {a}_{i} - {\hat{a}}_{i} \qquad ( 13 )$$

Furthermore, the prediction residual is quantified based on the following equation (14):

$${Q}_{i} = \frac{{r}_{i}}{Qs} \qquad ( 14 )$$

In equation (14), Qᵢ represents the quantized attribute residual of the current point i, and Qs represents the quantization step, which may be calculated by the quantization parameter (QP) specified by CTC.

### Reconstruction of the Attribute Value at the Encoding Side

The purpose of reconstruction at the encoding side is to predict subsequent points. Before the reconstruction of the attribute value, the residual needs to undergo inverse quantization, as shown in equation (15), \hat{r}ᵢ is denoted as the residual after inverse quantization:

$${\hat{r}}_{i} = {Q}_{i} \times Qs \qquad ( 15 )$$

Then, based on the following equation (16), the reconstructed value ãᵢ of the point i is obtained by adding \hat{r}ᵢ to the prediction value âᵢ:

$${\tilde{a}}_{i} = {\hat{r}}_{i} + {\hat{a}}_{i} \qquad ( 16 )$$

When performing attribute nearest neighbor search based on LOD partition, there are currently two major types of algorithms: intra nearest neighbor search and inter nearest neighbor search. The intra nearest neighbor search is divided into two algorithms: inter-level nearest neighbor search and intra-level nearest neighbor search.

### Intra Nearest Neighbor Search

The intra nearest neighbor search is divided into two algorithms: inter-level nearest neighbor search and intra-level nearest neighbor search. After LOD partition, a pyramid structure similar to that illustrated in FIG. 8D is obtained.

### 1. Inter-Level Nearest Neighbor Search

As illustrated in FIG. 8E and FIG. 8A, different LOD levels, namely LOD0, LOD1 and LOD2, are obtained based on the geometry information partitioning, and points in LOD0 are used to predict attributes of points in a next LOD during the process of the inter-level nearest neighbor search.

The entire process of the intra nearest neighbor search is described in detail below.

In the entire process of LOD partition, there are three sets O(k), L(k) and I(k), where k is the index of the LOD level during LOD partition, and I(k) is the input point set during the current LOD level partition. After LOD partition, O(k) and L(k) sets are obtained. The O(k) set stores the sampling point set, and L(k) is the point set in the current LOD level. That is, the entire process of LOD partitioning is as follows.

(1) Initialization

$$if k = 0 , L ( k ) ← \{ \} . Otherwise L ( k ) ← L ( k - 1 )$$

$$O ( k ) ← \{ \}$$

(2) Based on the LOD partition algorithm, the sampling points are stored in (k), and the remaining points are partitioned into (k).

(3) In a case of performing the next iteration, I←(k).

It is to be noted here that since the entire process of LOD partition is based on the Morton code, O(k), L(k) and I(k) store the Morton code index corresponding to the point.

When performing inter-level nearest neighbor search, that is, the points in the L(k) set performing nearest neighbor search in the O(k) set, the specific search algorithm is as follows.

### Nearest Neighbor Search is Performed Based on Spatial Relationships

When predicting the current point P, neighbor search is performed by using the parent block (Block B) corresponding to the point P, as illustrated in FIG. 8F, to search for points in neighbor blocks that are co-planar or co-edged with the current parent block to perform attribute prediction.

For example, the spatial relationship of co-planar, co-edge and co-vertex is illustrated in FIG. 8G.

First, the coordinates of the current point are used to obtain a corresponding spatial block. Secondly, the nearest neighbor search is performed in the previously encoded LOD level to find spatial blocks that are co-planar, co-edged, and co-pointed with the current block to obtain the N neighbors of the current point.

If the N neighbors of the current point are still not obtained after performing co-planar, co-edge and co-vertex nearest neighbor searches, the N neighbors of the current point will be obtained based on a fast search algorithm, and the specific algorithm is illustrated in FIG. 8H. When performing inter-attribute level prediction, the Morton code corresponding to the current point is first obtained using the geometric coordinates of the current point to be encoded. Secondly, based on the Morton code of the current point, the reference point j) whose Morton code is a first one greater than the Morton code of the current point is found in the reference picture. Then, the nearest neighbor search is performed in the range of [j−searchRange, j+searchRange].

The rest of the specific algorithms for updating the nearest neighbor are the same as the inter nearest neighbor search algorithm, which will not be repeated here. The specific algorithms will be mentioned in the inter nearest neighbor search algorithm.

### 2. Intra-Level Nearest Neighbor Search

As illustrated in FIG. 8I, when the intra-level prediction algorithm is turned on, in the same LOD level, a nearest neighbor search is performed on the set of encoded points in the same level to obtain the N neighbors of the current point (inter-level nearest neighbor search is also performed).

When performing attribute inter-level prediction, the nearest neighbor search is performed based on the fast search algorithm. The specific algorithm is illustrated in FIG. 8J. Assuming that the Morton code index of the current point is i, the nearest neighbor search will be performed in [i+1, i+searchRange]. The specific nearest neighbor search algorithm is consistent with the block-based inter fast search algorithm, which will not be repeated here and will be discussed in detail later.

The intra nearest neighbor search is described above. The inter nearest neighbor search is described below.

### Inter Nearest Neighbor Search

As illustrated in FIG. 8H, when performing attribute inter prediction, the Morton code corresponding to the current point are first obtained using the geometric coordinates of the current point to be encoded. Secondly, based on the Morton code of the current point, the reference point (j) whose Morton code is a first one larger than the Morton code of the current point is found in the reference picture. Then, the nearest neighbor search is performed in the range of [j−searchRange, j+searchRange].

Currently, when performing intra nearest neighbor search and inter nearest neighbor search, the neighborhood search is performed based on blocks, as illustrated in FIG. 8K. When searching for the neighborhood of the current point (Morton code index is i), the points in the reference picture are first partitioned into N (N is equal to 3) levels according to the Morton code. The specific partition algorithm is as follows.

First level: it is assumed that the reference picture contains numPoints points, the points in the reference picture are first partitioned into a block every M (M=2⁵=32) points.

Second level: on the basis of the first level, the blocks of the first level are partitioned into one block every M (M=2⁵=32) blocks according to the order of Morton code.

Third level: on the basis of the second level, the blocks of the first level are partitioned into one block every M (M=2⁵=32) blocks according to the order of Morton code.

Finally, the prediction structure illustrated in FIG. 8K is obtained.

When performing attribute prediction based on the prediction structure illustrated in FIG. 8K, assuming that the Morton code index of the current point to be encoded is i, the point in the reference picture whose Morton code is a first one greater than or equal to the Morton code of the current point is first obtained, with an index of j. Secondly, the block index of the reference point is calculated based on j. The specific calculation method is as follows.

$$First level : BucketSize\_ 0 = {2}^{5} = 32 .$$

$$Second level : BucketSize\_ 1 = {2}^{5} = 32 \times BucketSize\_ 0 = 10 24.$$

$$Third level : BucketSize\_ 2 = {2}^{5} = 32 \times BucketSize\_ 1 = 32768 .$$

Assuming that the reference range in the prediction picture of the current point is [j−searchRange, j+searchRange], the starting index of the third level is calculated using j−searchRange, and the ending index of the third level is calculated using j+searchRange. Next, it is determined whether some blocks of the second level need to undergo nearest neighbor search in the blocks of the third level; then, moving to the second level, it is determined whether a search is needed for each block of the first level; if some blocks of the first level need to undergo nearest neighbor search, some points of the blocks of the first level will be determined point by point to update the nearest neighbors.

The index-based calculation block algorithm is introduced below. Assuming that the Morton code index corresponding to the current point is “index”, the index of the corresponding third level block is as shown in equation (17):

$$idx\_ 2 = index / BucketSize\_ 2 \qquad ( 17 )$$

After the index idx_2 of the third level block is obtained, the starting index and the ending index of the block of the second level corresponding to the current block may be obtained using idx_2, as shown in equation (18):

$$startIdx 1 = idx\_ 2 \times BucketSize\_ 1 \qquad ( 18 )$$

$$endIdx = idx\_ 2 \times BucketSize\_ 1 + BucketSize\_ 1 - 1$$

Based on the same algorithm, the index of the first level block is obtained based on the index of the second level block.

When performing nearest neighbor search based on blocks, it is first determined whether the current block needs to undergo nearest neighbor search, that is, filter the nearest neighbor search of the block. Each spatial block may be obtained based on two variables minPos and maxPos, where minPos represents the minimum value of the block and maxPos represents the maximum value of the block.

It is assumed that the distance of the farthest point among the N neighbors of the current point is Dist, the coordinates of the point to be encoded are (x, y, z), and the current block is represented by (minPos, maxPos), where minPos is the minimum value of the bounding box in three dimensions, and maxPos is the maximum value of the bounding box in three dimensions, then the distance D between the current point and the bounding box is calculated as shown in equation (19):

$$int dx = int ( std \text{::} max ( std \text{::} max ( minPos [ 0 ] - point [ 0 ] , 0 ) , point [ 0 ] - maxPos [ 0 ] ) ) ; int dy = int ( std \text{::} max ( std \text{::} max ( minPo s [ 1 ] - point [ 1 ] , 0 ) , point [ 1 ] - maxPos [ 1 ] ) ) ; int dz = int ( std \text{::} max ( std \text{::} max ( minPos [ 2 ] - point [ 2 ] , 0 ) , point [ 2 ] - maxPos [ 2 ] ) ) ; D = dx + dy + dz \qquad ( 19 )$$

When D is less than or equal to Dist, the points in the current block will be traversed.

The lifting transform encoding of the attribute information of the point cloud is introduced below.

FIG. 8L illustrates an encoding process of the lifting transform. The lifting transform also performs predictive encoding on the attributes of the point cloud based on LOD. The difference from the prediction transform is that the lifting transform first partitions the LOD into higher and lower levels, performs prediction in the reversed order of the LOD level generation, and introduces an update operator in the prediction process to update the quantization weights of the points in the lower LOD level to improve the accuracy of the prediction. This is because the attribute values of points in the lower LOD level are frequently used to predict the attribute values of points in the higher LOD level, and points in the lower LOD level should have greater influence.

### Step 1: Partitioning Process

The partitioning process is to partition the complete LOD level into lower LOD levels L(N) and higher LOD levels H(N). If a point cloud has three levels of LOD, i.e., (LODₗ)_{l=0,1,2}, after partitioning, LOD₂ is the higher LOD level and denoted as H(N), and (LODₗ)_{l=0,1} are the lower LOD levels and denoted as L(N).

### Step 2: Prediction Process

The point in the higher LOD level selects the attribute information of the nearest neighbor points from the lower LOD level as the attribute prediction value P(N) of the current point to be encoded. The prediction residual D(N) is shown in equation (20):

$$D ( N ) = H ( N ) - P ( N ) \qquad ( 20 )$$

### Step 3: Update Process

The attribute prediction residual D(N) in the higher LOD level is updated to obtain U(N), and the attribute values of the points in the lower LOD level are lifted using U(N), as shown in (21):

$${L}^{′} ( N ) = L ( N ) + U ( N ) \qquad ( 21 )$$

The above process will iterate continuously until the lowest LOD level according to the order of LOD from high to low.

Since the LOD-based prediction scheme makes the points in the lower LOD levels have greater influence, the transform scheme based on lifting wavelet transform introduces quantization weights and updates the prediction residual according to the prediction residual D(N) and the distance between the prediction point and the neighboring points. Finally, adaptive quantization is performed on the prediction residual using the quantization weights in the transform process. It should be noted that the quantization weight value of each point may be determined by geometric reconstruction at the decoding side, so the quantization weight do not need to be encoded.

The region adaptive hierarchical transform is introduced below.

The region adaptive hierarchical transform (RAHT) is a Haar wavelet transform that may transform the attribute information of the point cloud from the spatial domain to the frequency domain and further reduce the correlation between the attributes of the point cloud. The main idea is to transform the nodes in each level from the three dimensions of x, y, and z (as illustrated in FIG. 8M) in a bottom-up manner according to the octree structure, and to perform iteration until reaching the root node of the octree. As illustrated in FIG. 8N, the basic idea is to perform wavelet transform based on the hierarchical structure of the octree, associate the attribute information with the nodes of the octree, and recursively transform the attributes of the occupied nodes in the same parent node in a bottom-up manner. The nodes in each level are transformed from the three dimensions of x, y, and z until reaching the root node of the octree. In the process of hierarchical transform, the low-pass (DC) coefficients obtained after transforming the nodes in the same level are passed to the nodes in the next level for further transformation, while all high-pass (AC) coefficients are encoded by the arithmetic encoder.

During the transformation process, the DC coefficient (direct current component) of the nodes in the same level after transformation will be passed to the previous level for further transformation, and the AC coefficient (alternating current component) after transformation of each level will be quantized and encoded. The main transformation process is introduced below.

FIG. 8O illustrates the corresponding transform and inverse transform process. Assuming that g_{L,2x,y,z}′ and g_{L,2x+1,y,z}′ are two attributes DC coefficients that are neighboring points in the L level. After the linear transformation, the information of the L−1 level is the AC coefficient f_{L-1,x,y,z}′ and the DC coefficient g_{L-1,x,y,z}′; then, no more transform will be performed on f_{L-1,x,y,Z}′, and quantization encoding will be performed on f_{L-1,x,y,z}′ directly; g_{L-1,x,y,z}′ will continue to search nearest neighbors for transformation, and it will be passed directly to the L−2 level if none are found. That is, the RAHT transform is only valid for nodes with neighboring points, and nodes without neighboring points will be passed directly to the previous level. In the above transformation process, the weights corresponding to g_{L,2x,y,z}′ and g_{L,2x+2,y,z}′ (the number of non-empty child nodes in a node) are w_{L,2x,y,z}′ and w_{L,2x+1,y,z}′ (abbreviated as w₀′ and w₁′), and the weight of g_{L-1,x,y,z}′ is w_{L-1,x,y,z}′, then the general transformation equation (22) is:

$$[ \begin{matrix}{g}_{L - 1 , x , y , z}^{′} \\ {f}_{L - 1 , x , y , z}^{′}\end{matrix} ] = {T}_{w 0 , w 1} [ \begin{matrix}{g}_{L , 2 x , y , z}^{′} \\ {g}_{L , 2 x + 1 , y , z}^{′}\end{matrix} ] \qquad ( 22 )$$

For example, T_{w0,w1} in the formula is a transformation matrix determined according to the following equation (23):

$${T}_{w 0 , w 1} = \frac{1}{\sqrt{{w}_{0}^{′} + {w}_{1}^{′}}} [ \begin{matrix}\sqrt{{w}_{0}^{′}} & \sqrt{{w}_{1}^{′}} \\ - \sqrt{{w}_{1}^{′}} & \sqrt{{w}_{0}^{′}}\end{matrix} ] \qquad ( 23 )$$

The transformation matrix will be updated as the weights corresponding to each point change adaptively. The above process will be continuously iterated and updated based on the partition structure of the octree until reaching the root node of the octree.

The encoding and decoding technology of the geometry information of the point cloud and the encoding and decoding technology of the attribute information of the point cloud are described above.

In the process of the point cloud encoding, for some relatively planar nodes or nodes with planar characteristics, the coding efficiency of the geometry information of point cloud can be further improved by utilizing the planar coding. However, in the related art, predictive coding is performed on the planar structure information of the current node only through some prior reference information, resulting in poor predictive coding performance of the planar structure information.

In order to solve the above technical problems, in the embodiments of the present disclosure, when encoding or decoding nodes, N neighborhood nodes of the current node are determined; and predictive decoding is performed on the planar structure of the current node based on the occupancy information of the N neighborhood nodes, thereby improving the predictive encoding and decoding performance of the planar structure information and improving the encoding and decoding efficiency and performance of the point cloud.

The point cloud encoding and decoding method according to the embodiments of the present disclosure is introduced below in conjunction with specific embodiments.

First, taking the decoding side as an example, the point cloud decoding method provided by the embodiments of the present disclosure is introduced.

FIG. 9 is a flowchart of a point cloud decoding method provided by an embodiment of the present disclosure. The point cloud decoding method in the embodiments of the present disclosure may be implemented by the point cloud decoding device or point cloud decoder illustrated in FIG. 3 or FIG. 4B above.

As illustrated in FIG. 9, the point cloud decoding method in the embodiments of the present disclosure includes the following steps.

In S101: first information corresponding to a current node is determined.

The first information is used to indicate whether first-type neighborhood nodes of the current node are valid, and the first-type neighborhood nodes are neighborhood nodes whose geometry information has been decoded.

As can be seen from the above, the point cloud has geometry information and attribute information, and decoding of the point cloud includes geometric decoding and attribute decoding. The embodiments of the present disclosure relate to geometric decoding of the point cloud.

In some embodiments, the geometry information of the point cloud is also referred to as position information of the point cloud, and therefore, the geometric decoding of the point cloud is also referred to as position decoding of the point cloud.

In the octree-based coding manner, the encoding side constructs an octree structure of the point cloud based on the geometry information of the point cloud, as illustrated in FIG. 10, where a minimum cuboid is used to surround the point cloud. First, octree partitioning is performed on the bounding box to obtain 8 nodes, and then, octree partitioning is continuously performed on occupied nodes among these 8 nodes (that is, nodes including points), and so on, until partitioned into a voxel-level position, for example, until partitioned into a 1×1×1 cube. The point cloud octree structure obtained by such partitioning includes multiple levels of nodes, for example, including N levels. During encoding, occupancy information of each level is encoded level by level until the voxel-level leaf nodes of the last level are encoded. That is, in octree encoding, by performing octree partitioning on the point cloud, the points in the point cloud are finally partitioned into voxel-level leaf nodes of the octree; and the encoding of the point cloud is realized by encoding the entire octree.

Correspondingly, first, at the decoding side, the geometry bitstream of the point cloud is decoded to obtain occupancy information of a root node of the octree of the point cloud, and child nodes included in the root node are determined based on the occupancy information of the root node, that is, the nodes included in the second level of the octree. Next, the geometry bitstream is decoded to obtain occupancy information of each node in the second level, and nodes included in the third level of the octree are determined based on the occupancy information of each node, and so on.

However, for some relatively planar nodes or nodes with planar characteristics, the coding efficiency of the geometry information of point cloud may be further improved by utilizing the planar coding. For example, as illustrated in FIG. 5A, the four occupied child nodes of the current node are all located at the low plane position of the current node in the Z-coordinate axis direction, and thus, the occupancy information of the current node is represented as: 11001100. In this way, when the current node is encoded by using the planar coding manner, first, a flag needs to be encoded to represent that the current node is a plane in the Z-axis direction. Secondly, if the current node is a plane in the Z-axis direction, the planar position of the current node needs to be represented, for example, 1 bit is used to represent that the four occupied child nodes of the current node are located in the low plane position of the current node in the Z-axis direction. Thirdly, only the occupancy information of the low plane nodes in the Z-coordinate axis direction needs to be encoded (i.e., the occupancy information of the four child nodes 0, 2, 4 and 6). Therefore, when encoding the current node based on the planar coding manner, only 6 bits are needed to be encoded, which may reduce 2 bits of representation compared to the original octree coding, thereby improving the coding performance of the point cloud.

As can be seen from the above, when encoding the current node using the planar coding manner, the encoding side needs to perform predictive encoding on the planar structure information of the current node. Correspondingly, the decoding side performs predictive decoding on the planar structure information of the current node, and then obtains the geometry information of the current node based on the decoded planar structure information.

At present, predictive encoding is performed on the planar structure information of the current node based on some prior reference information (such as a spatial distance between a node at the same partition depth and the same coordinate as the current node and the current node and/or a planar position of the node at the same partition depth and the same coordinate as the current node), resulting in poor predictive coding performance of the planar structure information.

In order to solve the above problems, in the embodiments of the present disclosure, the decoding side performs predictive decoding on the planar structure of the current node based on the occupancy information of the N neighborhood nodes of the current node, thereby improving the predictive encoding and decoding performance of the planar structure information and improving the encoding and decoding efficiency and performance of the point cloud.

In the embodiments of the present disclosure, in order to improve the prediction decoding accuracy of the planar structure information of the current node, the occupancy information of the N neighborhood nodes of the current node whose geometry information has been decoded is usually used to perform predictive decoding on the planar structure information of the current node.

In some embodiments, for the sake of ease of description, the N neighborhood nodes of the current node whose geometry information has been decoded are recorded as the first-type neighborhood nodes.

In the embodiments of the present disclosure, the first-type neighborhood nodes may be understood as that occupancy status of child nodes included in the neighborhood nodes has been decoded. For example, the occupied status of 8 child nodes of neighborhood node 1 is 11001010, 1 representing occupied and 0 representing unoccupied.

It is to be noted that, the specific manner for determining the first-type neighborhood nodes is not limited in the embodiments of the present disclosure.

In an example, as illustrated in FIG. 11, the first-type neighborhood nodes of the current node include any node whose geometry information has been decoded within a point cloud spatial area of 3×3.

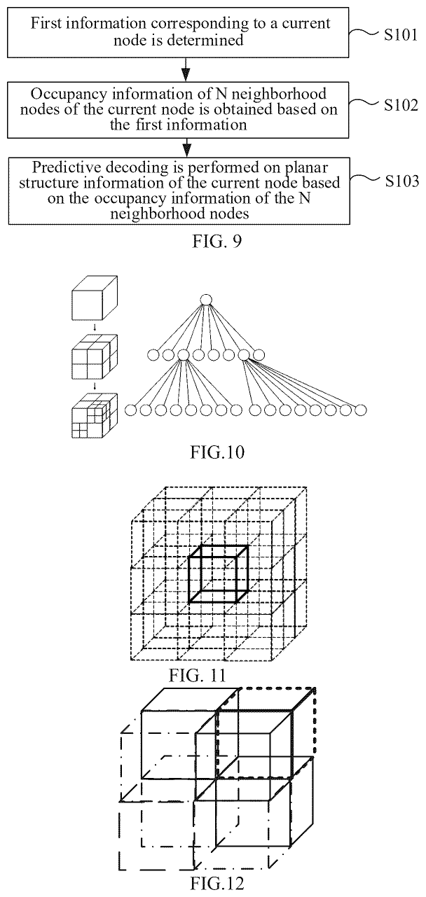

In an example, as illustrated in FIG. 12, a node with thick dashed line is the current node to be encoded, the nodes with solid line are three neighborhood nodes sharing a face with the current node, the nodes with dotted line are three neighborhood nodes sharing an edge with the current node, and a node with long dashed line is a neighborhood node sharing a vertex with the current node. Since geometry information of the seven neighborhood nodes that share a face, an edge or a vertex (in left, front or lower direction) with the current node illustrated in FIG. 12 has been decoded when the occupancy information of the current node is decoded according to the order of point cloud decoding, these 7 neighborhood nodes may be recorded as the first-type neighborhood nodes.

In an example, the first-type neighborhood nodes of the current node may include, in addition to the seven neighborhood nodes that share a face, an edge or a vertex (in left, front, or lower direction) with the current node as illustrated in FIG. 12, other nodes whose geometry information has been decoded within a preset reference neighborhood range, which is not limited in the embodiments of the present disclosure.

In some embodiments, the first-type neighborhood nodes of the current node are invalid, for example, the current node does not have the first-type neighborhood nodes (i.e., the neighborhood nodes whose geometry information has been decoded), in this case, the decoding side cannot use the occupancy information of the first-type neighborhood nodes to perform predictive decoding on the planar structure information of the current node.

Based on this, before performing predictive decoding on the planar structure information of the current node, the decoding side first needs to determine the first information corresponding to the current node, where the first information is used to indicate whether the current node has the first-type neighborhood nodes (i.e., the neighborhood nodes whose geometry information has been decoded). Next, based on the first information, N neighborhood nodes of the current node are determined. For example, when the first information indicates that the current node has the first-type neighborhood nodes, the decoding side determines N first-type neighborhood nodes of the current node and performs predictive decoding on the planar structure information of the current node based on the geometry information of the first-type neighborhood nodes. For another example, when the first information indicates that the current node does not have the first-type neighborhood nodes, the decoding side determines N other-type neighborhood nodes of the current node and then performs predictive decoding on the planar structure information of the current node based on the geometry information of these N other-type neighborhood nodes.

The specific process for the decoding side to determine the first information corresponding to the current node is introduced below.

The specific form of the first information neighAvaibale is not limited in the embodiments of the present disclosure, which may be any information that can express whether the current node has the first-type neighborhood nodes.

In a possible implementation, the first information neighAvaibale includes a flag, and the decoding side may determine whether the current node has the first-type neighborhood nodes according to the value of the flag. For example, if the value of the flag is true, it indicates that the current node has the first-type neighborhood nodes; or if the value of the flag is false, it indicates that the current node does not have the first-type neighborhood nodes.

The specific manner in which the decoding side determines the first information neighAvaibale corresponding to the current node is not limited in the embodiments of the present disclosure.

In some embodiments, when encoding the geometry information of the current node, the encoding side determines whether the current node has the first-type neighborhood nodes; determines the first information neighAvaibale corresponding to the current node based on whether the current node has the first-type neighborhood nodes, and then signals (writes) the first information neighAvaibale into the bitstream. For example, when the current node has the first-type neighborhood nodes, the first information neighAvaibale is set to be true and signaled into the bitstream; or when the current node does not have the first-type neighborhood nodes the first information neighAvaibale is set to be false and signaled into the bitstream. In this way, the decoding side obtains the first information corresponding to the current node by decoding the bitstream; and then determines whether the current node has the first-type neighborhood nodes based on the first information neighAvaibale.

In some embodiments, the decoding side determines the first information neighAvaibale corresponding to the current node by itself. For example, the decoding side searches whether there are first-type neighborhood nodes whose geometry information has been decoded among the neighborhood nodes of the current node. For example, when the current node has the first-type neighborhood nodes, the first information neighAvaibale is set to be true; or when the current node does not have the first-type neighborhood nodes, the first information neighAvaibale is set to be false.

After determining the first information corresponding to the current node based on the above step, the decoding side performs the following step S102.

In S102: occupancy information of N neighborhood nodes of the current node is obtained based on the first information.

Where N is a positive integer.

After determining the first information corresponding to the current node based on the above step, the decoding side determines whether the current node has the first-type neighborhood nodes based on the first information. In this way, the occupancy information of the N neighborhood nodes of the current node may be obtained based on the first information.

The specific process for the decoding side to obtain the occupancy information of the N neighborhood nodes of the current node based on the first information is not limited in the embodiments of the present disclosure.

Case I: in response to the first information indicating that at least one first-type neighborhood node of the current node is valid, the decoding side obtains the occupancy information of N first-type neighborhood nodes of the current node, and uses the occupancy information of the N first-type neighborhood nodes as the occupancy information of the N neighborhood nodes of the current node.

In Case I, in response to the first information corresponding to the current node indicating that the at least one first-type neighborhood node of the current node is valid (i.e., exists), since the geometry information of the first-type neighborhood node(s) has been decoded, the prediction accuracy of the planar structure information of the current node may be improved when the planar structure information of the current node is predicted by using the occupancy information of the first-type neighborhood node(s) whose geometry information has been decoded. Therefore, the decoding side obtains the occupancy information of the N first-type neighborhood nodes of the current node, and performs predictive decoding on the planar structure information of the current node based on the occupancy information of the N first-type neighborhood nodes.

In the embodiments of the present disclosure, the number and specific positions of the N first-type neighborhood nodes are not limited.

In some embodiments, the N first-type neighborhood nodes include at least one of: three first co-planar neighborhood nodes, three first co-edge neighborhood nodes or one first co-vertex neighborhood node. As illustrated in FIG. 12, the three first co-planar neighborhood nodes include a neighborhood node sharing a face with a front surface of the current node, a neighborhood node sharing a face with a left surface of the current node, and a neighborhood node sharing a face with a bottom surface of the current node; the three first co-edge neighborhood nodes include a neighborhood node sharing an edge with a left edge of the front surface of the current node, a neighborhood node sharing an edge with a bottom edge of the front surface of the current node, and a neighborhood node sharing an edge with a left edge of the bottom surface of the current node; and the first co-vertex neighborhood node is a neighborhood node sharing a vertex with a bottom left front vertex of the current node.

In some embodiments, as illustrated in FIG. 12, when all seven first-type neighborhood nodes of the current node exist, in this case, in an example, the seven first-type neighborhood nodes may be used as the N first-type neighborhood nodes of the current node, and N=seven; and in another example, the N first-type neighborhood nodes may be selected from the seven first-type neighborhood nodes, and N is a positive integer less than seven.

In some embodiments, as illustrated in FIG. 12, when only a part of the first-type neighborhood nodes of the seven first-type neighborhood nodes of the current node exist, in an example, the existing part of first-type neighborhood nodes may be used as the N first-type neighborhood nodes of the current node; and in another example, the N first-type neighborhood nodes may be selected from the existing part of first-type neighbor nodes.

In another specific embodiment, the above N first-type neighborhood nodes of the current node include the seven neighborhood nodes illustrated in FIG. 12.

In another specific embodiment, the above N first-type neighborhood nodes of the current node include neighborhood nodes that share a face and a vertex with the current node among the seven neighborhood nodes illustrated in the above FIG. 12, for example, including three first co-planar neighborhood nodes that share a face with the current node and one first co-vertex neighborhood node that shares a vertex with the current node.

In another specific embodiment, the above N first-type neighborhood nodes of the current node include neighborhood nodes that share an edge and a vertex with the current node among the seven neighborhood nodes illustrated in the above FIG. 12, for example, including three first co-edge neighborhood nodes that share an edge with the current node and one first co-vertex neighborhood node that shares a vertex with the current node.

In another specific embodiment, the above N first-type neighborhood nodes of the current node include the neighborhood nodes that share an edge and a face with the current node among the seven neighborhood nodes illustrated in the above FIG. 12, for example, including three first co-planar neighborhood nodes that share a face with the current node and three first co-edge neighborhood nodes that share an edge with the current node.

In another specific embodiment, the above N first-type neighborhood nodes of the current node only include at least one first co-planar neighborhood node sharing a face with the current node, or at least one first co-edge neighborhood node sharing an edge with the current nod or a first co-vertex neighborhood node sharing a vertex with the current node, among the seven neighborhood nodes illustrated in the above FIG. 12.

Based on the above method, the decoding side determines the N first-type neighborhood nodes of the current node. Since the geometry information of the above N first-type neighborhood nodes has been decoded, the decoding side may obtain the occupancy information of the N first-type neighborhood nodes, where the occupancy information of the first-type neighborhood nodes indicates whether each child node of the first-type neighborhood nodes is unoccupied. For example, when octree coding is adopted in the present disclosure, the occupancy information of the first-type neighborhood nodes is 8-bit information.

The specific process of obtaining the geometry information of the N first-type neighborhood nodes when the first information indicates that the current node has the first-type neighborhood nodes in Case I is introduced above.

Case II: in response to the first information indicating that all first-type neighborhood nodes of the current node are invalid, occupancy information of N second-type neighborhood nodes of the current node is obtained, and the occupancy information of the N second-type neighborhood nodes is used as the occupancy information of the N neighborhood nodes of the current node.

In Case II, in response to the first information corresponding to the current node indicating that the first-type neighborhood nodes of the current node are invalid (i.e., do not exist), the decoding side cannot use the occupancy information of the first-type neighborhood nodes to perform predictive decoding on the planar structure information of the current node. In this way, the decoding side determines the N second-type neighborhood nodes of the current node, and performs predictive decoding on the planar structure information of the current node based on the occupancy information of the N second-type neighborhood nodes.

A second-type neighborhood node is a neighborhood node whose geometry information has not been decoded.

In the embodiments of the present disclosure, the geometry information of the second-type neighborhood node has not been decoded, therefore, occupancy status of child nodes of the second-type neighborhood node is unknown, but whether the second-type neighborhood node is occupied is known. For example, when the second-type neighborhood node is occupied, the occupancy information of the second-type neighborhood node is represented as 1, and when the second-type neighborhood node is not occupied, the occupancy information of the second-type neighborhood node is represented as 0.

As can be seen from the above, in the embodiments of the present disclosure, the occupancy information of the second-type neighborhood nodes is different from the occupancy information of the first-type neighborhood nodes. The occupancy information of the first-type neighborhood node indicates whether the child nodes of the first-type neighborhood nodes are occupied, which is 8-bit information. While the occupancy information of the second-type neighborhood node indicates whether the second-type neighborhood node is occupied, which is 1-bit information.

In the embodiments of the present disclosure, the number and specific positions of the N second-type neighborhood nodes are not limited.

In some embodiments, the N second-type neighborhood nodes include any one neighborhood node among neighborhood nodes of the current node except the first-type neighborhood nodes.

In some embodiments, the N second-type neighborhood nodes include at least one of: three second co-planar neighborhood nodes or nine second co-edge neighborhood nodes. For example, as illustrated in FIG. 13, the three second co-planar neighborhood nodes include a neighborhood node sharing a face with a rear surface of the current node, a neighborhood node sharing a face with a right surface of the current node, and a neighborhood node sharing a face with a top surface of the current node; and the nine second co-edge neighborhood nodes include four neighborhood nodes respectively sharing an edge with four edges of the right surface of the current node, three neighborhood nodes respectively sharing an edge with a front edge, a left edge and a rear edge of the top surface of the current node, and two neighborhood nodes respectively sharing an edge with a left edge and a bottom edge of the rear surface of the current node.

In some embodiments, as illustrated in FIG. 13, when all twelve second-type neighborhood nodes of the current node exist, in this case, in an example, the twelve second-type neighborhood nodes may be used as the N second-type neighborhood nodes of the current node, and N=twelve; and in another example, the N second-type neighborhood nodes may be selected from the twelve second-type neighborhood nodes, where N is a positive integer less than twelve.

In some embodiments, as illustrated in FIG. 13, when only a part of the second-type neighborhood nodes of the twelve second-type neighborhood nodes of the current node exist, in this case, in an example, the existing part of second-type neighborhood nodes may be used as the N second-type neighborhood nodes of the current node; and in another example, the N second-type neighborhood nodes may be selected from the existing part of second-type neighborhood nodes.

In another specific embodiment, the above N second-type neighborhood nodes of the current node include the twelve neighborhood nodes illustrated in FIG. 13.

In another specific embodiment, the above N second-type neighborhood nodes of the current node include neighborhood nodes that share a face with the current node among the twelve neighborhood nodes illustrated in FIG. 13, for example, including three second co-planar neighborhood nodes that sharing a face with the current node.

In another specific embodiment, the above N second-type neighborhood nodes of the current node include neighborhood nodes that share an edge with the current node among the twelve neighborhood nodes illustrated in FIG. 13, for example, including nine second co-edge neighborhood nodes that share an edge with the current node.

Based on the above method, the decoding side determines the N second-type neighborhood nodes of the current node. Since the geometry information of the above N second-type neighborhood nodes has not been decoded, the decoding side may obtain the occupancy status of each second-type neighborhood node among the N second-type neighborhood nodes, and then determine the occupancy status of the second-type neighborhood nodes as the occupancy information of the second-type neighborhood nodes. For example, when the second-type neighborhood node is occupied, the occupancy information of the second-type neighborhood node is determined to be 1; and when the second-type neighborhood node is not occupied, the occupancy information of the second-type neighborhood node is determined to be 0, that is, the occupancy information of the second-type neighborhood node is 1-bit information.

After determining the N neighborhood nodes of the current node based on the first information, the decoding side performs the following step S103.

In S103: predictive decoding is performed on planar structure information of the current node based on the occupancy information of the N neighborhood nodes.

In the embodiments of the present disclosure, the planar structure information of the current node includes planar flag information of the current node and/or planar position information of the current node.

As can be seen from above, the planar flag of the current node is represented by PlaneModei (i=0, 1, 2), where i=0 represents the X-coordinate axis, i=1 represents the Y-coordinate axis and i=2 represents the Z-coordinate axis. PlaneModei=0 represents that the current node is not a plane in the direction of the i-th coordinate axis, and PlaneModei=1 represents that the current node is a plane in the direction of the i-th coordinate axis.

When the current node is a plane in the direction of the i-th coordinate axis, i.e., PlaneModei=1, the decoding side continues to decode the planar position information of the current node in the i-th coordinate axis. Exemplarily, PlanePositioni is used to represent the planar position information of the current node in the i-th coordinate axis direction. For example, PlanePositioni=0 represents that the current node is a plane in the i-th coordinate axis direction, and the planar position is a low plane, and PlanePositioni=1 represents that the current node is a high plane in the i-th coordinate axis direction.

In the embodiments of the present disclosure, predictive decoding is performed on the planar structure information of the current node based on the occupancy information of the N neighborhood nodes, that is, predictive decoding is performed on the planar flag and/or the planar position information of the current node.

For example, predictive decoding is performed on the planar flag of the current node in the i-th coordinate axis based on the occupancy information of the N neighborhood nodes of the current node.

For another example, predictive decoding is performed on the planar position information of the current node in the i-th coordinate axis based on the occupancy information of the N neighborhood nodes of the current node.

In the embodiments of the present disclosure, the operation that predictive decoding is performed on the planar structure information of the current node based on the occupancy information of the N neighborhood nodes of the current node may be understood as that the occupancy information of the N neighborhood nodes of the current node is used as context information of the planar structure information of the current node to perform predictive decoding on the planar structure information of the current node. For example, a context model index is determined based on the occupancy information of the N neighborhood nodes of the current node; a context model is determined based on the context model index; and predictive decoding is performed on the planar structure information of the current node based on the context model, for example, predictive decoding is performed on the planar flag of the current node based on the context model, or predictive decoding is performed on the planar position information of the current node based on the context model.

The specific manner in which the decoding side performs predictive decoding on the planar structure information of the current node based on the occupancy information of the N neighborhood nodes is not limited in the embodiments of the present disclosure.

In some embodiments, as can be seen from the above, the N neighborhood nodes of the current node may be the first-type neighborhood nodes or the second-type neighborhood nodes. However, in the present embodiment, the types of the N neighborhood nodes are not considered, and the decoding side uses the occupancy information of the N neighborhood nodes as the context information to perform predictive decoding on the planar structure information of the current node. For example, the occupancy information of the N neighborhood nodes of the current node is used as the context information to determine a context model index; a context model is determined based on the context model index; and predictive decoding is performed on the planar structure information of the current node based on the context model.

In some embodiments, when the planar structure information of the current node includes the planar position information of the current node, the decoding side considers the type of the neighborhood nodes when performing predictive decoding on the planar structure information of the current node based on the occupancy information of the N neighborhood nodes, and in this case, the S103 includes the following step S103-A.

In S103-A: predictive decoding is performed on the planar position information of the current node based on types and the occupancy information of the N neighborhood nodes.

In the present embodiment, when the decoding side performs predictive decoding on the planar position information of the current node based on the occupancy information of the N neighborhood nodes, the types of the neighborhood nodes are considered. For example, different manners may be adopted for different types of neighborhood nodes when performing predictive decoding on the planar position information of the current node based on the occupancy information of the neighborhood nodes.

In some embodiments, the decoding side may further use the types and the occupancy information of the N neighborhood nodes as the context information to perform predictive decoding on the planar structure information of the current node. For example, the types and the occupancy information of the N neighborhood nodes are used as the context information to determine a context model index; and a context model is determined based on the context model index; and predictive decoding is performed on the planar position information of the current node based on the context model.

In some embodiments, the S103-A includes the following steps.

In S103-A1: first context information and/or second context information corresponding to the i-th coordinate axis are determined based on the types and the occupancy information of the N neighborhood nodes, where the i-th coordinate axis is an X-coordinate axis, a Y-coordinate axis, or a Z-coordinate axis.

In S103-A2: predictive decoding is performed on planar position information of the current node in the i-th coordinate axis based on the first context information and/or the second context information corresponding to the i-th coordinate axis.

In the present embodiment, the decoding side determines at least one of the first context information or the second context information corresponding to the i-th coordinate axis based on the types and the occupancy information of the N neighborhood nodes, and then performs predictive decoding on the planar position information of the current node in the i-th coordinate axis based on the determined first context information and/or second context information. For example, the decoding side determines at least one of the first context information or the second context information corresponding to the X-coordinate axis based on the types and the occupancy information of the N neighborhood nodes, and then performs predictive decoding on the planar position information of the current node in the X-coordinate axis based on the first context information and/or the second context information corresponding to the X-coordinate axis. For another example, the decoding side determines at least one of the first context information or the second context information corresponding to the Y-coordinate axis based on the types and the occupancy information of the N neighborhood nodes, and then performs predictive decoding on the planar position information of the current node in the Y-coordinate axis based on the first context information and/or the second context information corresponding to the Y-coordinate axis. For yet another example, the decoding side determines at least one of the first context information or the second context information corresponding to the Z-coordinate axis based on the types and the occupancy information of the N neighborhood nodes, and then performs predictive decoding on the planar position information of the current node in the Z-coordinate axis based on the first context information and/or the second context information corresponding to the Z-coordinate axis.

In the embodiments of the present disclosure, due to different types of the neighborhood nodes, the implementation of the S103-A1 includes at least the following two cases.

Case I: in response to the N neighborhood nodes being the first-type neighborhood nodes, then the S103-A1 includes the following steps.

In S103-A1-a1: planar structure information of the N neighborhood nodes is determined based on the occupancy information of the N neighborhood nodes, where occupancy information of a neighborhood node indicates occupancy information of a child node of the neighborhood node.

In S103-A1-a2: the first context information and/or the second context information corresponding to the i-th coordinate axis are determined based on the planar structure information of the N neighborhood nodes.

In Case I, in a case where the current node has the first-type neighborhood nodes, when the decoding side uses the occupancy information of the first-type neighborhood nodes to perform predictive decoding on the planar position information of the current node, the planar structure information of the N first-type neighborhood nodes is determined first based on the occupancy information of the N first-type neighborhood nodes; and then, the first context information and/or the second context information corresponding to the i-th coordinate axis are determined based on the planar structure information of the N first-type neighborhood nodes. Finally, a target context model is determined based on the first context information and/or the second context information corresponding to the i-th coordinate axis, and predictive decoding is performed on the planar position information of the current node in the i-th coordinate axis by using the target context model, so as to improve the accuracy of predictive decoding of the planar position information of the current node.

In the embodiments of the present disclosure, for each of the N neighborhood nodes, the specific process of determining the planar structure information of the neighborhood node based on the occupancy information of the neighborhood node is consistent. For the sake of ease of description, any one neighborhood node among the N neighborhood nodes is taken as an example for explanation.

In some embodiments, the S103-A1-a1 includes the following step S103-A1-a11.

In S103-A1-a11: for any one neighborhood node among the N neighborhood nodes, at least one of the planar flag information or the planar position information of the neighborhood node is determined based on the occupancy information of the neighborhood node.

In the embodiments of the present disclosure, the decoding side may determine the planar flag information and/or the planar position information of the neighborhood node based on the occupancy information of the neighborhood node.

The specific process of determining the planar flag information of the neighborhood node based on the occupancy information of the neighborhood node is introduced below.

Exemplarily, the decoding side determines plane0 and plane1 corresponding to the i-th coordinate axis based on the occupancy information of the neighborhood node, and then determines the planar flag information corresponding to the neighborhood node in the i-th coordinate axis based on plane0 and plane1.

For example, the decoding side determines, based on the following codes, plane0 s respectively corresponding to the neighborhood node in the X, Y and Z-coordinate axes:

$$uint8\_t plane 0 = 0 ;$$

$$plane 0 \vert = !! ( occupancy \& 0 \times 0 f ) ≪ 0 ;$$

$$plane 0 \vert = !! ( occupancy \& 0 \times 33 ) ≪ 1 ;$$

$$plane 0 \vert = !! ( occupancy \& 0 \times 55 ) ≪ 2 ;$$

where occupancy represents the occupancy information of the neighborhood node, plane0|=!(occupancy & 0x0f)<<0 represents plane0 corresponding to the neighborhood node in the X-coordinate axis, plane0|=!!(occupancy & 0×33)<<1 represents plane0 corresponding to the neighborhood node in the Y-coordinate axis, and plane0|=!!(occupancy & 0×55)<<2 represents plane0 corresponding to the neighborhood node in the Z-coordinate axis. 0x0f represents 00001111, and AND operation is performed on the occupancy information of the neighborhood node occupancy and 0x0f to obtain values of the neighborhood node on the low plane in the X-coordinate axis, in which all the values are 0. 0×33 represents 00110011, and AND operation is performed on the occupancy information of the neighborhood node occupancy and 0×33 to obtain values of the neighborhood node on the low plane in the Y-coordinate axis, in which all the values are 0. 0×55 represents 01010101, and AND operation is performed on the occupancy information of the neighborhood node occupancy and 0×55 to obtain values of the neighborhood node on the low plane in the Z-coordinate axis, in which all the values are 0.

For example, the decoding side determines, based on the following codes, plane1 s respectively corresponding to the neighborhood node in the X, Y and Z-coordinate axes:

$$uint8\_t plane 1 = 0 ;$$

$$plane 1 \vert = !! ( occupancy \& 0 \times f 0 ) ≪ 0 ;$$

$$plane1 \vert = !! ( occupancy \& 0 \times cc ) ≪ 1 ;$$

$$plane 1 \vert = !! ( occupancy \& 0 \times aa ) ≪ 2 ;$$

where occupancy represents the occupancy information of the neighborhood node, & represents AND operation, plane1|=!!(occupancy & 0xf0)<<0 represents plane1 corresponding to the neighborhood node in the X-coordinate axis, plane1|=!!(occupancy & 0xcc)<<1 represents plane1 corresponding to the neighborhood node in the Y-coordinate axis, and plane1|=!!(occupancy & 0xaa)<<2 represents plane1 corresponding to the neighborhood node in the Z-coordinate axis. 0xf0 represents 11110000, and AND operation is performed on the occupancy information of the neighborhood node occupancy and 0xf0 to obtain values of the neighborhood node on the high plane in the X-coordinate axis, in which all the values are 0. 0xcc represents 11001100, and AND operation is performed on the occupancy information of the neighborhood node occupancy and 0xcc, to obtain values of the neighborhood node on the high plane in the Y-coordinate axis, in which all the values are 0. 0xaa represents 10101010, and AND operation is performed on the occupancy information of the neighborhood node occupancy and 0xaa to obtain values of the neighborhood node on the high plane in the Z-coordinate axis, in which all the values are 0.

Based on the above method, the decoding side may determine plane0 and plane1 corresponding to the neighborhood node in the i-th coordinate axis, and then determine the planar flag information corresponding to the neighborhood node in the i-th coordinate axis based on plane0 and plane1.

For example, for the i-th coordinate axis, XOR operation is performed on determined plane0 and plane1 in the i-th coordinate axis, so that the planar flag information of the neighborhood node in the i-th axis may be determined. The specific case is that it is a plane only when a single plane perpendicular to the axis is occupied.

For example, the decoding side determines the planar flag information of the neighborhood node in the i-th axis based on the following equation (24):

$$planarMode = plane 0 \hat{} plane 1 \qquad ( 24 )$$

Where planarMode represents the planar flag information of the neighborhood node in the i-th axis, and \hat{ } represents XOR operation.

As shown in the equation (24), the decoding side performs XOR operation on plane0 and plane1 corresponding to the neighborhood node in the X-coordinate axis to obtain the planar flag information of the neighborhood node in the X-coordinate axis. For another example, the decoding side performs XOR operation on plane0 and plane1 corresponding to the neighborhood node in the Y-coordinate axis to obtain the planar flag information of the neighborhood node in the Y-coordinate axis. For yet another example, the decoding side performs XOR operation on plane0 and plane1 corresponding to the neighborhood node in the Z-coordinate axis to obtain the planar flag information of the neighborhood node in the Z-coordinate axis.

The specific process of determining the planar position information of the neighborhood node is introduced below.

In the embodiments of the present disclosure, based on the above method, the decoding side may determine the planar flag information planarMode of the neighborhood node, and then determine the planar position information of the neighborhood node based on the planar flag information planarMode.

For example, the decoding side determines the planar position information of the neighborhood node in the i-th axis based on the following equation (25):

$$PlanePos = planarMode \& plane 1 \qquad ( 25 )$$

Where PlanePos represents the planar position information of the neighborhood node in the i-th axis, and & represents AND operation.

As shown in the above equation (25), the decoding side performs AND operation on the planar flag information of the neighborhood node in the X-coordinate axis and the corresponding plane1 in the X-coordinate axis to obtain the planar position information of the neighborhood node in the X-coordinate axis. For another example, the decoding side performs AND operation on the planar flag information in the Y-coordinate axis and the corresponding plane1 in the Y-coordinate axis to obtain the planar position information of the neighborhood node in the Y-coordinate axis. For yet another example, the decoding side performs AND operation on the planar flag information in the Z-coordinate axis and the corresponding plane1 in the Z-coordinate axis to obtain the planar position information of the neighborhood node in the Z-coordinate axis.

The example of the process in which the decoding side determines the planar flag information and the planar position information of the neighborhood node in the X-coordinate axis is described below. It is assumed that the occupancy information of the neighborhood node is 10110000, the occupancy information of the neighborhood node 10110000 is substituted into plane0 1=!!(10110000& 00001111)<<0, to obtain plane0 corresponding to the neighborhood node in the X-coordinate axis, in which plane0 is 00000000. The occupancy information of the neighborhood node 10110000 is substituted into plane1|=!!(10110000& 11110000)<<0, to obtain plane1 corresponding to the neighborhood node in the X-coordinate axis, in which plane1 is 10110000. Next, XOR operation is performed on plane0 and plane1 to obtain the planar flag information of the neighborhood node in the X-coordinate axis, that is, planarMode=00000000\hat{ }10110000=10110000. As can be seen from planarMode=10110000, the neighborhood node has no occupied node on the high plane in the X-coordinate axis, and has the occupied node on the low plane in the X-coordinate axis. Therefore, it may be determined that the neighborhood node is a plane in the X-coordinate axis direction. Next, the decoding side performs AND operation on the planar flag information planarMode and plane1 of the neighborhood node in the X-coordinate axis to obtain the planar position information of the neighborhood node in the X-coordinate axis, that is, PlanePos=10110000&10110000=10110000. As can be seen from PlanePos=10110000, the neighborhood node is a plane in the X-coordinate axis direction, and the planar position is a low plane.

The specific process of determining the planar flag information and the planar position information of the neighborhood node in the X-coordinate axis is introduced above. The specific process of determining the planar flag information and the planar position information of the neighborhood node in the Y-coordinate axis and the Z-coordinate axis can refer to the above process of determining the planar flag information and the planar position information of the neighborhood node in the X-coordinate axis, which will not be repeated here.

Based on the above steps, the decoding side determines the planar flag information and/or the planar position information of each of the N neighborhood nodes, and then performs predictive decoding on the planar position information of the current node based on the planar flag information and/or the planar position information of each of the N neighborhood nodes.

In the embodiments of the present disclosure, the operation that the first context information and/or the second context information corresponding to the i-th coordinate axis are determined based on the planar structure information of N neighborhood nodes in the above S103-A1-a2 is described.

The specific process for the decoding side to determine the first context information corresponding to the i-th coordinate axis based on the planar structure information of the N neighborhood nodes is introduced below.

It is to be noted that, in the embodiments of the present disclosure, the specific manner in which the decoding side determines the first context information corresponding to the i-th coordinate axis based on the planar structure information of the N neighborhood nodes includes, but is not limited to, the following.

Manner I: the decoding side determines the first context information corresponding to the i-th coordinate axis based on planar structure information of part of the N neighborhood nodes.

For example, the decoding side determines the first context information corresponding to the i-th coordinate axis based on planar structure information of P neighborhood nodes sharing a face with the current node among the N neighborhood nodes, P being a positive integer.

The planar structure information of the P neighborhood nodes includes planar flag information and/or planar position information of the P neighborhood nodes. That is, the decoding side determines the first context information corresponding to the i-th coordinate axis based on the planar flag information of the P co-planar neighborhood nodes. Alternatively, the decoding side determines the first context information corresponding to the i-th coordinate axis based on the planar position information of the P co-planar neighborhood nodes. Alternatively, the decoding side determines the first context information corresponding to the i-th coordinate axis based on the planar flag information and the planar position information of the P co-planar neighborhood nodes.

The specific manner in which the decoding side determines the first context information corresponding to the i-th coordinate axis based on the planar structure information of the P neighborhood nodes sharing a face with the current node among N neighborhood nodes is not limited in the embodiments of the present disclosure.

In a possible implementation, for any one neighborhood node among the P neighborhood nodes, the decoding side performs AND operation on planar structure information of the neighborhood node and a first preset value corresponding to the i-th coordinate axis to obtain a first value corresponding to the neighborhood node, and then performs weighting operation on first values corresponding to the P neighborhood nodes to obtain the first context information corresponding to the i-th coordinate axis. It is to be noted that different coordinate axes correspond to different first preset values, and the specific value of the respective first preset value corresponding to each coordinate axis is not limited in the embodiments of the present disclosure.

For example, the first preset value corresponding to the X-coordinate axis is 0, the first preset value corresponding to the Y-coordinate axis is 1, and the first preset value corresponding to the Z-coordinate axis is 2.

As can be seen from the above, the planar structure information of the neighborhood node includes the planar flag information and/or the planar position information, and therefore, in some embodiments, the above operation that the decoding side performs AND operation on the planar structure information of the neighborhood node and the first preset value corresponding to the i-th coordinate axis to obtain the first value corresponding to the neighborhood node includes: performing, by the decoding side, AND operation on planar flag information and/or planar position information of the neighborhood node and the first preset value corresponding to the i-th coordinate axis to obtain the first value corresponding to the neighborhood node. That is, the decoding side performs AND operation on the planar flag information of the P co-planar neighborhood nodes and the first preset value corresponding to the i-th coordinate axis and then performs weighting operation on the result, to obtain the first context information corresponding to the i-th coordinate axis. Alternatively, the decoding side performs AND operation on the planar position information of the P co-planar neighborhood nodes and the first preset value corresponding to the i-th coordinate axis and then performs weighting operation on the result, to obtain the first context information corresponding to the i-th coordinate axis. Alternatively, the decoding side performs AND operation on the planar flag information and the planar position information of the P co-planar neighborhood nodes and the first preset value corresponding to the i-th coordinate axis and then performs weighting operation on the result, to obtain the first context information corresponding to the i-th coordinate axis.

The specific manner in which weighting operation is performed on the first values corresponding to the P neighborhood nodes to obtain the first context information corresponding to the i-th coordinate axis is not limited in the embodiments of the present disclosure.

In some embodiments, weights of the first values corresponding to the P neighborhood nodes are preset values, so that weighting operation is performed on the first values corresponding to the P neighborhood nodes based on the weight of the first value corresponding to each of the P neighborhood nodes to obtain the first context information corresponding to the i-th coordinate axis.

In some embodiments, the operation that weighting operation is performed on the first values corresponding to the P neighborhood nodes to obtain the first context information corresponding to the i-th coordinate axis includes the following steps A1 and A2.

In step A1: a left-shift bit count corresponding to the first value is determined, and a weighted weight corresponding to the first value is determined based on the left-shift bit count.

In step A2: weighting operation is performed on the first values corresponding to the P neighborhood nodes based on the weighted weights of the first values to obtain the first context information corresponding to the i-th coordinate axis.

For example, it is assumed that the P neighborhood nodes sharing a face with the current node among the N neighborhood nodes are three co-planar neighborhood nodes illustrated in FIG. 12. The planar flag information of the three co-planar neighborhood nodes is respectively recorded as: coPlanarLeftPlaneMode, coPlanarFrontPlaneMode and coPlanarBelowPlaneMode. The planar position information of the three co-planar neighborhood nodes is respectively recorded as: coPlanarLeftPlanePos, coPlanarFrontPlanePos and coPlanarBelowPlanePos.

AND operation is performed on coPlanarLeftPlaneMode and the first preset value to obtain a first value 1, AND operation is performed on coPlanarFrontPlaneMode and the first preset value to obtain a first value 2, AND operation is performed on coPlanarBelowPlaneMode and the first preset value to obtain a first value 3, AND operation is performed on coPlanarLeftPlanePos and the first preset value to obtain a first value 4, AND operation is performed on coPlanarFrontPlanePos and the first preset value to obtain a first value 5, and AND operation is performed on coPlanarBelowPlanePos and the first preset value to obtain a first value 6. As such, the six first values occupy a total of six bits, so the left-shift bit counts corresponding to the six first values may be determined. It is assumed that the left-shift bit count corresponding to the first value 1 is 5, the left-shift bit count corresponding to the first value 2 is 4, the left-shift bit count corresponding to the first value 3 is 3, the left-shift bit count corresponding to the first value 4 is 2, the left-shift bit count corresponding to the first value 5 is 1, and the left-shift bit count corresponding to the first value 6 is 0.

In this way, the respective weighted weight corresponding to each first value may be determined based on the respective left-shift bit count corresponding to each first value. For example, when the left-shift bit count corresponding to the first value is m, 2^{m} is determined as the weighted weight corresponding to the first value. In this way, it may be determined that the weighted weight corresponding to the first value 1 is 2⁵, the weighted weight corresponding to the first value 2 is 2⁴, the weighted weight corresponding to the first value 3 is 2³, the weighted weight corresponding to the first value 4 is 2², the weighted weight corresponding to the first value 5 is 2¹, and the weighted weight corresponding to the first value 6 is 2⁰.

Then, weighting operation is performed on each first value based on the weighted weight of each first value to obtain the first context information corresponding to the i-th coordinate axis. It is to be understood that the above operation of performing weighting operation on each first value may be understood as performing splicing on each first value, that is, each first value is placed on the corresponding bit position to obtain the first context information corresponding to the i-th coordinate axis.

In an example, when the decoding side performs AND operation on the planar flag information of the P co-planar neighborhood nodes and the first preset value corresponding to the i-th coordinate axis and then performs weighting operation on the result to obtain the first context information corresponding to the i-th coordinate axis, the decoding side calculates the first context information Ctx1 through the method shown in the following codes:

$$Const int mask = 1 ≪ axisIdx ( axisIdx = 0 ( x ) , 1 ( y ) , 2 ( z ) )$$

$$\begin{matrix}Ctx 1 = ! ! ( coPlanarLeftPlaneMode \& mask ) ≪ 2 \vert \\ ! ! ( coPlanarFrontPlaneMode \& mask ) ≪ 1 \vert \\ ! ! ( coPlanarBelowPlaneMode \& mask )\end{matrix}$$

In an example, when the decoding side performs AND operation on the planar position information of the P co-planar neighborhood nodes and the first preset value corresponding to the i-th coordinate axis and then performs weighting operation on the result to obtain the first context information corresponding to the i-th coordinate axis, the decoding side calculates the first context information Ctx1 through the method shown in the following codes:

$$Const int mask = 1 ≪ axisIdx ( axisIdx = 0 ( x ) , 1 ( y ) , 2 ( z ) )$$

$$\begin{matrix}Ctx 1 = ! ! ( coPlanarLeftPlanePos \& mask ) ≪ 2 \\ ! ! ( coPlanarFrontPlanePos \& mask ) ≪ 1 \vert \\ ! ! ( coPlanarBelowPlanePos \& mask ) \vert\end{matrix}$$

In an example, when the decoding side performs AND operation on the planar flag information and the planar position information of the P co-planar neighborhood nodes and the first preset value corresponding to the i-th coordinate axis and then performs weighting operation on the result to obtain the first context information corresponding to the i-th coordinate axis, the decoding side calculates the first context information Ctx1 through the method shown in the following codes:

$$Const int mask = 1 ≪ axisIdx ( axisIdx = 0 ( x ) , 1 ( y ) , 2 ( z ) )$$

$$\begin{matrix}Ctx 1 = ! ! ( coPlanarLeftPlanePos \& mask ) ≪ 5 \\ ! ! ( coPlanarFrontPlanePos \& mask ) ≪ 4 \vert \\ ! ! ( coPlanarBelowPlanePos \& mask ) ≪ 3 \vert \\ ! ! ( coPlanarLeftPlaneMode \& mask ) ≪ 2 \vert \\ ! ! ( coPlanarFrontPlaneMode \& mask ) ≪ 1 \vert \\ ! ! ( coPlanarBelowPlaneMode \& mask )\end{matrix}$$

The specific process for the decoding side to determine the first context information corresponding to the i-th coordinate axis based on the planar structure information of the P neighborhood nodes sharing a face with the current node among the N neighborhood nodes is introduced above.

In some embodiments, the decoding side may further determine the first context information corresponding to the i-th coordinate axis based on planar structure information of neighborhood node(s) sharing an edge with the current node among the N neighborhood nodes.

In some embodiments, the decoding side may further determine the first context information corresponding to the i-th coordinate axis based on planar structure information of the neighborhood node(s) sharing a vertex with the current node among the N neighborhood nodes.

In some embodiments, the decoding side may further determine the first context information corresponding to the i-th coordinate axis based on planar structure information of at least one neighborhood node sharing a face or sharing an edge with the current node among the N neighborhood nodes.

In some embodiments, the decoding side may further determine the first context information corresponding to the i-th coordinate axis based on planar structure information of at least one neighborhood node sharing a face or sharing a vertex with the current node among the N neighborhood nodes.

In some embodiments, the decoding side may further determine the first context information corresponding to the i-th coordinate axis based on the planar structure information of at least one neighborhood node sharing an edge or sharing a vertex with the current node among the N neighborhood nodes.

The specific process for the decoding side to determine the first context information corresponding to the i-th coordinate axis based on the planar structure information of part of the N neighborhood nodes is introduced above.

Manner II: the decoding side determines the first context information corresponding to the i-th coordinate axis based on first planar structure information of the N neighborhood nodes.

The first planar structure information includes planar flag information and/or planar position information of the neighborhood nodes. That is, the decoding side determines the first context information corresponding to the i-th coordinate axis based on the planar flag information of the N neighborhood nodes. Alternatively, the decoding side determines the first context information corresponding to the i-th coordinate axis based on the planar position information of the N neighborhood nodes. Alternatively, the decoding side determines the first context information corresponding to the i-th coordinate axis based on the planar position information and the planar flag information of the N neighborhood nodes.

The specific manner in which the decoding side determines the first context information corresponding to the i-th coordinate axis based on the first planar structure information of the N neighborhood nodes is not limited in the embodiments of the present disclosure.

In a possible implementation, for any one neighborhood node among the N neighborhood nodes, the decoding side performs AND operation on first planar structure information of the neighborhood node and a first preset value corresponding to the i-th coordinate axis to obtain a second value corresponding to the neighborhood node, and then performs weighting operation on second values corresponding to the N neighborhood nodes to obtain the first context information corresponding to the i-th coordinate axis. It is to be noted that different coordinate axes correspond to different first preset values, and the specific value of the respective first preset value corresponding to each coordinate axis is not limited in the embodiments of the present disclosure.

For example, the first preset value corresponding to the X-coordinate axis is 0, the first preset value corresponding to the Y-coordinate axis is 1, and the first preset value corresponding to the Z-coordinate axis is 2.

As can be seen from the above, the planar structure information of the neighborhood node includes planar flag information and/or planar position information, and therefore, in some embodiments, the above operation that the decoding side performs AND operation on the first planar structure information of the neighborhood node and the first preset value corresponding to the i-th coordinate axis to obtain the second value corresponding to the neighborhood node includes: performing, by the decoding side, AND operation on the planar flag information and/or the planar position information of the neighborhood node and the first preset value corresponding to the i-th coordinate axis to obtain the first value corresponding to the neighborhood node. That is, the decoding side performs AND operation on the planar flag information of the N neighborhood nodes and the first preset value corresponding to the i-th coordinate axis and then performs weighting operation on the result, to obtain the first context information corresponding to the i-th coordinate axis. Alternatively, the decoding side performs AND operation on the planar position information of the N neighborhood nodes and the first preset value corresponding to the i-th coordinate axis and then performs weighting operation on the result, to obtain the first context information corresponding to the i-th coordinate axis. Alternatively, the decoding side performs AND operation on the planar flag information and the planar position information of the N neighborhood nodes and the first preset value corresponding to the i-th coordinate axis and then performs weighting operation on the result, to obtain the first context information corresponding to the i-th coordinate axis.

The specific manner in which weighting operation is performed on the second values corresponding to the N neighborhood nodes to obtain the first context information corresponding to the i-th coordinate axis is not limited in the embodiments of the present disclosure.

In some embodiments, weights of the second values corresponding to the N neighborhood nodes are preset values, so that weighting operation is performed on the second values corresponding to the N neighborhood nodes based on the weight of the second value corresponding to each of the N neighborhood nodes to obtain the first context information corresponding to the i-th coordinate axis.

In some embodiments, the above operation that weighting operation is performed on the second values corresponding to the N neighborhood nodes to obtain the first context information corresponding to the i-th coordinate axis includes the following steps B1 and B2.

In step B1: a left-shift bit count corresponding to the second value is determined, and a weighted weight corresponding to the second value is determined based on the left-shift bit count.

In step B2: weighting operation is performed on the second values corresponding to the N neighborhood nodes based on the weighted weights of the second values to obtain the first context information corresponding to the i-th coordinate axis.

For example, it is assumed that the N neighborhood nodes include three co-planar neighborhood nodes (coPlanarLeft, coPlanarFront and coPlanarBelow), three co-edge neighborhood nodes (coEdgerLeft, coEdgerFront and coEdgerBelow) and one co-vertex neighborhood node (coVertex) illustrated in FIG. 12. It is assumed that the planar flag information of the seven neighborhood nodes is respectively recorded as: coPlanarLeftPlaneMode, coPlanarFrontPlaneMode, coPlanarBelowPlaneMode, coEdgerLeftPlanarMode, coEdgerFrontPlanarMode, coEdgerBelowPlanarMode and coVertexPlanarMode. The planar position information of the seven neighborhood nodes is respectively recorded as: coPlanarLeftPlanePos, coPlanarFrontPlanePos, coPlanarBelowPlanePos, coEdgerLeftPlanePos, coEdgerFrontPlanePos, coEdgerBelowPlanePos and coVertexPlanePos.

For example, AND operation is performed on coPlanarLeftPlaneMode and the first preset value to obtain a second value 1, AND operation is performed on coPlanarFrontPlaneMode and the first preset value to obtain a second value 2, AND operation is performed on coPlanarBelowPlaneMode and the first preset value to obtain a second value 3, AND operation is performed on coEdgerLeftPlanarMode and the first preset value to obtain a second value 4, AND operation is performed on coEdgerFrontPlanarMode and the first preset value to obtain a second value 5, AND operation is performed on coEdgerBelowPlanarMode and the first preset value to obtain a second value 6, and AND operation is performed on coVertexPlanarMode and the first preset value to obtain a second value 7. As such, the seven second values occupy a total of seven bits, so the left-shift bit counts corresponding to the seven second values may be determined. It is assumed that the left-shift bit count corresponding to the second value 1 is 6, the left-shift bit count corresponding to the second value 2 is 5, the left-shift bit count corresponding to the second value 3 is 4, the left-shift bit count corresponding to the second value 4 is 3, the left-shift bit count corresponding to the second value 5 is 2, the left-shift bit count corresponding to the second value 6 is 1, and the left-shift bit count corresponding to the second value 7 is 0.

In this way, the respective weighted weight corresponding to each second value may be determined based on the respective left-shift bit count corresponding to each second value. For example, when the left-shift bit count corresponding to the second value is m, 2^{m} is determined as the weighted weight corresponding to the second value. In this way, it may be determined that the weighted weight corresponding to the second value 1 is 2⁶, the weighted weight corresponding to the second value 2 is 2⁵, the weighted weight corresponding to the second value 3 is 2⁴, the weighted weight corresponding to the second value 4 is 2³, the weighted weight corresponding to the second value 5 is 2², the weighted weight corresponding to the second value 6 is 2¹, and the weighted weight corresponding to the second value 7 is 2⁰.

Then, weighting operation is performed on each second value based on the weighted weight of each second value to obtain the first context information corresponding to the i-th coordinate axis. It is to be understood that the above operation of performing weighting operation on each second value may be understood as performing splicing on each second value, that is, each second value is placed on the corresponding bit position to obtain the first context information corresponding to the i-th coordinate axis.

In an example, when the decoding side performs AND operation on the planar flag information of the N neighborhood nodes and the first preset value corresponding to the i-th coordinate axis and then performs weighting operation on the result to obtain the first context information corresponding to the i-th coordinate axis, the decoding side calculates the first context information Ctx1 through the method shown in the following codes:

$$\begin{matrix}Const int mask = 1 << axisIdx ( axisIdx = 0 ( x ) , 1 ( y ) , 2 ( z ) ) \\ Ctx 1 = ! ! ( coPlanarLeftPlanarMode \& mask ) << 6 \vert \\ ! ! ( coPlanarFrontPlanarMode \& mask ) << 5 \vert \\ ! ! ( coPlanarBelowPlanarMode \& mask ) << 4 \vert \\ ! ! ( coEdgerLeftPlanarMode \& mask ) << 3 \vert \\ ! ! ( coEdgerFrontPlanarMode \& mask ) << 2 \vert \\ ! ! ( coEdgerBelowPlanarMode \& mask ) << 1 \vert \\ ! ! ( coVertexPlanarMode \& mask )\end{matrix}$$

In an example, when the decoding side performs AND operation on the planar position information of the N neighborhood nodes and the first preset value corresponding to the i-th coordinate axis and then performs weighting operation on the result to obtain the first context information corresponding to the i-th coordinate axis, the decoding side calculates the first context information Ctx1 through the method shown in the following codes:

$$\begin{matrix}Const int mask = 1 << axisIdx ( axisIdx = 0 ( x ) , 1 ( y ) , 2 ( z ) ) \\ Ctx 1 = ! ! ( coPlanarLeftPlanePos \& mask ) << 6 \vert \\ ! ! ( coPlanarFrontlanePos \& mask ) << 5 \vert \\ ! ! ( coPlanarBelowPlanePos \& mask ) << 4 \vert \\ ! ! ( coEdgerLeftPlanePos \& mask ) << 3 \vert \\ ! ! ( coEdgerFrontPlanePos \& mask ) << 2 \vert \\ ! ! ( coEdgerBelowPlanePos \& mask ) << 1 \vert \\ ! ! ( coVertexPlanePos \& mask )\end{matrix}$$

In an example, when the decoding side performs AND operation on the planar flag information and the planar position information of the N neighborhood nodes and the first preset value corresponding to the i-th coordinate axis and then performs weighting operation on the result to obtain the first context information corresponding to the i-th coordinate axis, the decoding side calculates the first context information Ctx1 through the method shown in the following codes:

$$\begin{matrix}Const int mask = 1 << axisIdx ( axisIdx = 0 ( x ) , 1 ( y ) , 2 ( z ) ) \\ Ctx 1 = ! ! ( coPlanarLeftPlanarMode \& mask ) << 13 \vert \\ ! ! ( coPlanarFrontPlanarMode \& mask ) << 12 \vert \\ ! ! ( coPlanarBelowPlanarMode \& mask ) << 11 \vert \\ ! ! ( coEdgerLeftPlanarMode \& mask ) << 10 \vert \\ ! ! ( coEdgerFrontPlanarMode \& mask ) << 9 \vert \\ ! ! ( coEdgerBelowPlanarMode \& mask ) << 8 \vert \\ ! ! ( coVertexPlanarMode \& mask ) << 7 \vert \\ ! ! ( coPlanarLeftPlanePos \& mask ) << 6 \vert \\ ! ! ( coPlanarFrontlanePos \& mask ) << 5 \vert \\ ! ! ( coPlanarBelowPlanePos \& mask ) << 4 \vert \\ ! ! ( coEdgerLeftPlanePos \& mask ) << 3 \vert \\ ! ! ( coEdgerFrontPlanePos \& mask ) << 2 \vert \\ ! ! ( coEdgerBelowPlanePos \& mask ) << 1 \vert \\ ! ! ( coVertexPlanePos \& mask )\end{matrix}$$

The specific process for the decoding side to determine the first context information corresponding to the i-th coordinate axis based on the planar structure information of the N neighborhood nodes is introduced above. It is to be noted that, in addition to determining the first context information corresponding to the i-th coordinate axis based on the above manners, the decoding side may also adopt other manners to determine the first context information corresponding to the i-th coordinate axis.

The specific process of determining the second context information corresponding to the i-th coordinate axis based on the planar structure information of the N neighborhood nodes in S103-A1-a2 is introduced below.

It is to be noted that, in the embodiments of the present disclosure, the specific manner in which the decoding side determines the second context information corresponding to the i-th coordinate axis based on the planar structure information of the N neighborhood nodes includes, but is not limited to, the following.

Manner I: the decoding side determines the second context information corresponding to the i-th coordinate axis based on planar structure information of part of the N neighborhood nodes.

For example, the decoding side determines the second context information corresponding to the i-th coordinate axis based on planar structure information of Q neighborhood nodes sharing an edge and/or sharing a vertex with the current node among the N neighborhood nodes, Q being a positive integer.

The planar structure information of the Q neighborhood nodes includes planar flag information and/or planar position information of the Q neighborhood nodes. That is, the decoding side determines the second context information corresponding to the i-th coordinate axis based on the planar flag information of the Q neighborhood nodes. Alternatively, the decoding side determines the second context information corresponding to the i-th coordinate axis based on the planar position information of the Q neighborhood nodes. Alternatively, the decoding side determines the second context information corresponding to the i-th coordinate axis based on the planar flag information and the planar position information of the Q neighborhood nodes.

The specific manner in which the decoding side determines the second context information corresponding to the i-th coordinate axis based on the planar structure information of the Q neighborhood nodes sharing an edge and/or sharing a vertex with the current node among the N neighborhood nodes is not limited in the embodiments of the present disclosure.

In a possible implementation, for any one neighborhood node among the Q neighborhood nodes, the decoding side performs AND operation on planar structure information of the neighborhood node and a first preset value corresponding to the i-th coordinate axis to obtain a first value corresponding to the neighborhood node, and then performs weighting operation on first values corresponding to the Q neighborhood nodes to obtain the second context information corresponding to the i-th coordinate axis. It is to be noted that different coordinate axes correspond to different first preset values, and the specific value of the respective first preset value corresponding to each coordinate axis is not limited in the embodiments of the present disclosure.

For example, the first preset value corresponding to the X-coordinate axis is 0, the first preset value corresponding to the Y-coordinate axis is 1, and the first preset value corresponding to the Z-coordinate axis is 2.

As can be seen from the above, the planar structure information of the neighborhood node includes the planar flag information and/or the planar position information, and therefore, in some embodiments, the above operation that decoding side performs AND operation on the planar structure information of the neighborhood node and the first preset value corresponding to the i-th coordinate axis to obtain the first value corresponding to the neighborhood node includes: performing, by the decoding side, AND operation on planar flag information and/or planar position information of the neighborhood node and the first preset value corresponding to the i-th coordinate axis to obtain the first value corresponding to the neighborhood node. That is, the decoding side performs AND operation on the planar flag information of the Q neighborhood nodes and the first preset value corresponding to the i-th coordinate axis and then performs weighting operation on the result, to obtain the second context information corresponding to the i-th coordinate axis. Alternatively, the decoding side performs AND operation on the planar position information of the Q neighborhood nodes and the first preset value corresponding to the i-th coordinate axis and then performs weighting operation on the result, to obtain the second context information corresponding to the i-th coordinate axis. Alternatively, the decoding side performs AND operation on the planar flag information and the planar position information of the Q neighborhood nodes and the first preset value corresponding to the i-th coordinate axis and then performs weighting operation on the result, to obtain the second context information corresponding to the i-th coordinate axis.

The specific manner in which weighting operation is performed on the first values corresponding to the Q neighborhood nodes to obtain the second context information corresponding to the i-th coordinate axis is not limited in the embodiments of the present disclosure.

In some embodiments, weights of the first values corresponding to the Q neighborhood nodes are preset values, so that weighting operation is performed on the first values corresponding to the Q neighborhood nodes based on the weight of the first value corresponding to each of the Q neighborhood nodes to obtain the second context information corresponding to the i-th coordinate axis.

In some embodiments, the operation that weighting operation is performed on the first values corresponding to the Q neighborhood nodes to obtain the second context information corresponding to the i-th coordinate axis includes the following steps C1 and C2.

In step C1: a left-shift bit count corresponding to the first value is determined, and a weighted weight corresponding to the first value is determined based on the left-shift bit count.

In step C2: weighting operation is performed on the first values corresponding to the Q neighborhood nodes based on the weighted weights of the first values to obtain the second context information corresponding to the i-th coordinate axis.

For example, it is assumed that the Q neighborhood nodes sharing an edge or sharing a vertex with the current node among the N neighborhood nodes are three co-edge neighborhood nodes (coEdgerLeft, coEdgerFront and coEdgerBelow) and one neighborhood node sharing a vertex with the current node (coVertex) illustrated in FIG. 12. The planar flag information of the four neighborhood nodes is respectively recorded as: coEdgerLeftPlaneMode, coEdgerFrontPlaneMode, coEdgerBelowPlaneMode and coVertexPlaneMode. The planar position information of the four neighborhood nodes is respectively recorded as: coEdgerLeftPlanePos, coEdgerFrontPlanePos, coEdgerBelowPlanePos and coVertexPlanePos.

For example, AND operation is performed on coEdgerLeftPlaneMode and the first preset value to obtain a first value 1, AND operation is performed on coEdgerFrontPlaneMode and the first preset value to obtain a first value 2, AND operation is performed on coEdgerBelowPlaneMode and the first preset value to obtain a first value 3, AND operation is performed on coVertexPlaneMode and the first preset value to obtain a first value 4, AND operation is performed on coEdgerLeftPlanePos and the first preset value to obtain a first value 5, AND operation is performed on coEdgerFrontPlanePos and the first preset value to obtain a first value 6, AND operation is performed on coEdgerBelowPlanePos and the first preset value to obtain a first value 7, and AND operation is performed on coVertexPlanePos and the first preset value to obtain a first value 8. As such, the eight first values occupy a total of eight bits, so the left-shift bit counts corresponding to the eight first values may be determined. It is assumed that the left-shift bit count corresponding to the first value 1 is 7, the left-shift bit count corresponding to the first value 2 is 6, the left-shift bit count corresponding to the first value 3 is 5, the left-shift bit count corresponding to the first value 4 is 4, the left-shift bit count corresponding to the first value 5 is 3, the left-shift bit count corresponding to the first value 6 is 2, the left-shift bit count corresponding to the first value 7 is 1, and the left-shift bit count corresponding to the first value 8 is 0.

In this way, the respective weighted weight corresponding to each first value may be determined based on the respective left-shift bit count corresponding to each first value. For example, when the left-shift bit count corresponding to the first value is m, 2^{m} is determined as the weighted weight corresponding to the first value. In this way, it may be determined that the weighted weight corresponding to the first value 1 is 2⁷, the weighted weight corresponding to the first value 2 is 2⁶, the weighted weight corresponding to the first value 3 is 2⁵, the weighted weight corresponding to the first value 4 is 2⁴, the weighted weight corresponding to the first value 5 is 2³, the weighted weight corresponding to the first value 6 is 2², the weighted weight corresponding to the first value 7 is 2¹, and the weighted weight corresponding to the first value 8 is 2⁰.

Then, weighting operation is performed on each first value based on the weighted weight of each first value to obtain the second context information corresponding to the i-th coordinate axis. It is to be understood that the above operation of performing weighting operation on each first value may be understood as performing splicing on each first value, that is, each first value is placed on the corresponding bit position to obtain the second context information corresponding to the i-th coordinate axis.

In an example, when the decoding side performs AND operation on the planar flag information of the Q neighborhood nodes and the first preset value corresponding to the i-th coordinate axis and then performs weighting operation on the result to obtain the second context information corresponding to the i-th coordinate axis, the decoding side calculates the second context information Ctx2 through the method shown in the following codes:

$$\begin{matrix}Const int mask = 1 << axisIdx ( axisIdx = 0 ( x ) , 1 ( y ) , 2 ( z ) ) \\ Ctx 2 = ! ! ( coEdgerLeftPlaneMode \& mask ) << 3 \vert \\ ! ! ( coEdgerFrontPlaneMode \& mask ) << 2 \vert \\ ! ! ( coEdgerBelowPlaneMode \& mask ) << 1 \vert \\ ! ! ( coVertexPlaneMode \& mask )\end{matrix}$$

In an example, when the decoding side performs AND operation on the planar position information of the Q neighborhood nodes and the first preset value corresponding to the i-th coordinate axis and then perform weighting operation on the result to obtain the second context information corresponding to the i-th coordinate axis, the decoding side calculates the second context information Ctx2 through the method shown in the following codes:

$$\begin{matrix}Const int mask = 1 << axisIdx ( axisIdx = 0 ( x ) , 1 ( y ) , 2 ( z ) ) \\ Ctx 2 = ! ! ( coEdgerLeftPlanePos \& mask ) << 3 \vert \\ ! ! ( coEdgerFrontPlanePos \& mask ) << 2 \vert \\ ! ! ( coEdgerBelowPlanePos \& mask ) << 1 \vert \\ ! ! ( coVertexPlanePos \& mask )\end{matrix}$$

In an example, when the decoding side performs AND operation on the planar flag information and the planar position information of the Q neighborhood nodes and the first preset value corresponding to the i-th coordinate axis and then performs weighting operation on the result to obtain the second context information corresponding to the i-th coordinate axis, the decoding side calculates the second context information Ctx2 through the method illustrated shown in the following codes:

$$\begin{matrix}Const int mask = 1 << axisIdx ( axisIdx = 0 ( x ) , 1 ( y ) , 2 ( z ) ) \\ Ctx 2 = ! ! ( coEdgerLeftPlanePos \& mask ) << 7 \vert \\ ! ! ( coEdgerFrontPlanePos \& mask ) << 6 \vert \\ ! ! ( coEdgerBelowPlanePos \& mask ) << 5 \vert \\ ! ! ( coVertexPlanePos \& mask ) << 4 \vert \\ ! ! ( CoEdgerLeftPlaneMode \& mask ) << 3 \vert \\ ! ! ( CoEdgerFrontPlaneMode \& mask ) << 2 \vert \\ ! ! ( CoEdgerBelowPlaneMode \& mask ) << 1 \vert \\ ! ! ( coVertexPlaneMode \& mask )\end{matrix}$$

The specific process for the decoding side to determine the second context information corresponding to the i-th coordinate axis based on the planar structure information of the Q neighborhood nodes sharing an edge and/or sharing a vertex with the current node among the N neighborhood nodes is introduced above.

In some embodiments, the decoding side may further determine the second context information corresponding to the i-th coordinate axis based on planar structure information of at least one neighborhood node sharing an edge with the current node among the N neighborhood nodes.

In some embodiments, the decoding side may further determine the second context information corresponding to the i-th coordinate axis based on planar structure information of at least one neighborhood node sharing a vertex with the current node among the N neighborhood nodes.

In some embodiments, the decoding side may further determine the second context information corresponding to the i-th coordinate axis based on planar structure information of at least one neighborhood node sharing a face with the current node among the N neighborhood nodes.

In some embodiments, the decoding side may further determine the second context information corresponding to the i-th coordinate axis based on planar structure information of at least one neighborhood node sharing a face or sharing an edge with the current node among the N neighborhood nodes.

In some embodiments, the decoding side may further determine the second context information corresponding to the i-th coordinate axis based on planar structure information of at least one neighborhood node sharing a face or sharing a vertex with the current node among the N neighborhood nodes.

The specific process for the decoding side to determine the second context information corresponding to the i-th coordinate axis based on the planar structure information of part of the N neighborhood nodes is introduced above.

Manner II: the decoding side determines the second context information corresponding to the i-th coordinate axis based on second planar structure information of the N neighborhood nodes.

The second planar structure information includes planar flag information and/or planar position information of the neighborhood nodes. That is, the decoding side determines the second context information corresponding to the i-th coordinate axis based on the planar flag information of the N neighborhood nodes. Alternatively, the decoding side determines the second context information corresponding to the i-th coordinate axis based on the planar position information of the N neighborhood nodes. Alternatively, the decoding side determines the second context information corresponding to the i-th coordinate axis based on the planar position information and the planar flag information of the N neighborhood nodes.

The specific manner in which the decoding side determines the second context information corresponding to the i-th coordinate axis based on the first planar structure information of the N neighborhood nodes is not limited in the embodiments of the present disclosure.

In a possible implementation, for any one neighborhood node among the N neighborhood nodes, the decoding side performs AND operation on second planar structure information of the neighborhood node and a first preset value corresponding to the i-th coordinate axis to obtain a third value corresponding to the neighborhood node, and then performs weighting on third values corresponding to the N neighborhood nodes to obtain the second context information corresponding to the i-th coordinate axis. It is to be noted that different coordinate axes correspond to different first preset values, and the specific value of the respective first preset value corresponding to each coordinate axis is not limited in the embodiments of the present disclosure.

For example, the first preset value corresponding to the X-coordinate axis is 0, the first preset value corresponding to the Y-coordinate axis is 1, and the first preset value corresponding to the Z-coordinate axis is 2.

As can be seen from the above, the planar structure information of the neighborhood node includes planar flag information and/or planar position information, and therefore, in some embodiments, the above operation that the decoding side performs AND operation on the second planar structure information of the neighborhood node and the first preset value corresponding to the i-th coordinate axis to obtain the third value corresponding to the neighborhood node includes: performing, by the decoding side, AND operation on the planar flag information and/or the planar position information of the neighborhood node and the first preset value corresponding to the i-th coordinate axis to obtain the third value corresponding to the neighborhood node. That is, the decoding side performs AND operation on the planar flag information of the N neighborhood nodes and the first preset value corresponding to the i-th coordinate axis and then performs weighting operation on the result, to obtain the second context information corresponding to the i-th coordinate axis. Alternatively, the decoding side performs AND operation on the planar position information of the N neighborhood nodes and the first preset value corresponding to the i-th coordinate axis and then performs weighting operation on the result, to obtain the second context information corresponding to the ith coordinate axis. Alternatively, the decoding side performs AND operation on the planar flag information and the planar position information of the N neighborhood nodes and the first preset value corresponding to the i-th coordinate axis and then performs weighting operation on the result, to obtain the second context information corresponding to the i-th coordinate axis.

The specific manner in which weighting operation is performed on the third values corresponding to the N neighborhood nodes to obtain the second context information corresponding to the i-th coordinate axis is not limited in the embodiments of the present disclosure.

In some embodiments, weights of the third values corresponding to the N neighborhood nodes are preset values, so that weighting operation is performed on the third values corresponding to the N neighborhood nodes based on the weight of the third value corresponding to each of the N neighborhood nodes to obtain the second context information corresponding to the i-th coordinate axis.

In some embodiments, the above operation that weighting operation is performed on the third values corresponding to the N neighborhood nodes to obtain the second context information corresponding to the i-th coordinate axis includes the following steps D1 and D2.

In step D1: a left-shift bit count corresponding to the third value is determined, and a weighted weight corresponding to the third value is determined based on the left-shift bit count.

In step D2: weighting operation is performed on the third values corresponding to the N neighborhood nodes based on the weighted weights of the third values to obtain the second context information corresponding to the i-th coordinate axis.

For example, it is assumed that the N neighborhood nodes include three co-planar neighborhood nodes (coPlanarLeft, coPlanarFront and coPlanarBelow), three co-edge neighborhood nodes (coEdgerLeft, coEdgerFront and coEdgerBelow) and one co-vertex neighborhood node (coVertex) illustrated in FIG. 12. It is assumed that the planar flag information of the seven neighborhood nodes is respectively recorded as: coPlanarLeftPlaneMode, coPlanarFrontPlaneMode, coPlanarBelowPlaneMode, coEdgerLeftPlanarMode, coEdgerFrontPlanarMode, coEdgerBelowPlanarMode and coVertexPlanarMode. The planar position information of the seven neighborhood nodes is respectively recorded as: coPlanarLeftPlanePos, coPlanarFrontPlanePos, coPlanarBelowPlanePos, coEdgerLeftPlanePos, coEdgerFrontPlanePos, coEdgerBelowPlanePos and coVertexPlanePos.

For example, AND operation is performed on coPlanarLeftPlaneMode and the first preset value to obtain a third value 1, AND operation is performed on coPlanarFrontPlaneMode and the first preset value to obtain a third value 2, AND operation is performed on coPlanarBelowPlaneMode and the first preset value to obtain a third value 3, AND operation is performed on coEdgerLeftPlanarMode and the first preset value to obtain a third value 4, AND operation is performed on coEdgerFrontPlanarMode and the first preset value to obtain a third value 5, AND operation is performed on coEdgerBelowPlanarMode and the first preset value to obtain a third value 6, and AND operation is performed on coVertexPlanarMode and the first preset value to obtain a third value 7. As such, the seven third values occupy a total of seven bits, so the left-shift bit counts corresponding to the seven third values may be determined. It is assumed that the left-shift bit count corresponding to the third value 1 is 6, the left-shift bit count corresponding to the third value 2 is 5, the left-shift bit count corresponding to the third value 3 is 4, the left-shift bit count corresponding to the third value 4 is 3, the left-shift bit count corresponding to the third value 5 is 2, the left-shift bit count corresponding to the third value 6 is 1, and the left-shift bit count corresponding to the third value 7 is 0.

In this way, the respective weighted weight corresponding to each third value may be determined based on the respective left-shift bit count corresponding to each third value. For example, when the left-shift bit count corresponding to the third value is m, 2^{m} is determined as the weighted weight corresponding to the third value. In this way, it may be determined that the weighted weight corresponding to the third value 1 is 2⁶, the weighted weight corresponding to the third value 2 is 2⁵, the weighted weight corresponding to the third value 3 is 2⁴, the weighted weight corresponding to the third value 4 is 2³, the weighted weight corresponding to the third value 5 is 2², the weighted weight corresponding to the third value 6 is 2¹, and the weighted weight corresponding to the third value 7 is 2⁰.

Then, weighting operation is performed on each third value based on the weighted weights of each third value to obtain the second context information corresponding to the i-th coordinate axis. It is to be understood that the above operation of performing weighting operation on each third value may be understood as performing splicing on each third value, that is, each third value is placed on the corresponding bit position to obtain the second context information corresponding to the i-th coordinate axis.

In an example, when the decoding side performing AND operation on the planar flag information of the N neighborhood nodes and the first preset value corresponding to the i-th coordinate axis and then performs weighting operation on the result to obtain the second context information corresponding to the i-th coordinate axis, the decoding side calculates the second context information Ctx2 through the method shown in the following codes:

$$\begin{matrix}Const int mask = 1 << axisIdx ( axisIdx = 0 ( x ) , 1 ( y ) , 2 ( z ) ) \\ Ctx 2 = ! ! ( coPlanarLeftPlanarMode \& mask ) << 6 \vert \\ ! ! ( coPlanarFrontPlanarMode \& mask ) << 5 \vert \\ ! ! ( coPlanarBelowPlanarMode \& mask ) << 4 \vert \\ ! ! ( coEdgerLeftPlanarMode \& mask ) << 3 \vert \\ ! ! ( coEdgerFrontPlanarMode \& mask ) << 2 \vert \\ ! ! ( coEdgerBelowPlanarMode \& mask ) << 1 \vert \\ ! ! ( coVertexPlanarMode \& mask )\end{matrix}$$

In an example, when the decoding side performs AND operation on the planar position information of the N neighborhood nodes and the first preset value corresponding to the i-th coordinate axis and then performs weighting operation on the result to obtain the second context information corresponding to the i-th coordinate axis, the decoding side calculates the second context information Ctx2 through the method shown in the following codes:

$$\begin{matrix}Const int mask = 1 << axisIdx ( axisIdx = 0 ( x ) , 1 ( y ) , 2 ( z ) ) \\ Ctx 2 = ! ! ( coPlanarLeftPlanePos \& mask ) << 6 \vert \\ ! ! ( coPlanarFrontlanePos \& mask ) << 5 \vert \\ ! ! ( coPlanarBelowPlanePos \& mask ) << 4 \vert \\ ! ! ( coEdgerLeftPlanePos \& mask ) << 3 \vert \\ ! ! ( coEdgerFrontPlanePos \& mask ) << 2 \vert \\ ! ! ( coEdgerBelowPlanePos \& mask ) << 1 \vert \\ ! ! ( coVertexPlanePos \& mask )\end{matrix}$$

In an example, when the decoding side performs AND operation on the planar flag information and the planar position information of the N neighborhood nodes and the first preset value corresponding to the i-th coordinate axis and then performs weighting operation on the result to obtain the second context information corresponding to the i-th coordinate axis, the decoding side calculates the second context information Ctx2 through the method shown in the following codes:

$$\begin{matrix}Const int mask = 1 << axisIdx ( axisIdx = 0 ( x ) , 1 ( y ) , 2 ( z ) ) \\ Ctx 2 = ! ! ( coPlanarLeftPlanarMode \& mask ) << 13 \vert \\ ! ! ( coPlanarFrontPlanarMode \& mask ) << 12 \vert \\ ! ! ( coPlanarBelowPlanarMode \& mask ) << 11 \vert \\ ! ! ( coEdgerLeftPlanarMode \& mask ) << 10 \vert \\ ! ! ( coEdgerFrontPlanarMode \& mask ) << 9 \vert \\ ! ! ( coEdgerBelowPlanarMode \& mask ) << 8 \vert \\ ! ! ( coVertexPlanarMode \& mask ) << 7 \vert \\ ! ! ( coPlanarLeftPlanePos \& mask ) << 6 \vert \\ ! ! ( coPlanarFrontlanePos \& mask ) << 5 \vert \\ ! ! ( coPlanarBelowPlanePos \& mask ) << 4 \vert \\ ! ! ( coEdgerLeftPlanePos \& mask ) << 3 \vert \\ ! ! ( coEdgerFrontPlanePos \& mask ) << 2 \vert \\ ! ! ( coEdgerBelowPlanePos \& mask ) << 1 \vert \\ ! ! ( coVertexPlanePos \& mask )\end{matrix}$$

The specific process for the decoding side to determine the second context information corresponding to the i-th coordinate axis based on the planar structure information of the N neighborhood nodes is introduced above. It is to be noted that, in addition to determining the second context information corresponding to the i-th coordinate axis based on the above manners, the decoding side may also adopt other manners to determine the second context information corresponding to the i-th coordinate axis.

It is to be noted that the first context information corresponding to the i-th coordinate axis obtained by the decoding side is different from the second context information corresponding to the i-th coordinate axis obtained by the decoding side, that is, the manner used by the decoding side to determine the first context information corresponding to the i-th coordinate axis is different from the manner used by the decoding side to determine the second context information corresponding to the i-th coordinate axis, and thus, the obtained first context information is different from the obtained second context information.

In Case I where the N neighborhood nodes are the first-type neighborhood nodes, the specific processes for the decoding side to determine the planar structure information of the N neighborhood nodes based on the occupancy information of the N neighborhood nodes and determine the first context information and/or the second context information corresponding to the i-th coordinate axis based on the planar structure information of the N neighborhood nodes are introduced above.

Case II: in response to the N neighborhood nodes being the second-type neighborhood nodes, then the S103-A1 includes the following steps.

S103-A1-b: the first context information and/or the second context information corresponding to the i-th coordinate axis are determined based on the occupancy information of the N neighborhood nodes, where occupancy information of a neighborhood node indicates whether the neighborhood node is occupied.

As can be seen from the above, the geometry information of the second-type neighborhood node has not been decoded, therefore, the occupancy information of the second-type neighborhood node indicates whether the second-type neighborhood node is occupied, and the occupancy information of the second-type neighborhood node is 1-bit. Based on this, in Case II, in response to the N neighborhood nodes of the current node being the second-type neighborhood nodes, the first context information and/or the second context information corresponding to the i-th coordinate axis are determined directly based on the occupancy information of the N neighborhood nodes.

The specific manner for determining the first context information and/or the second context information corresponding to the i-th coordinate axis based on the occupancy information of the N neighborhood nodes is not limited in the embodiments of the present disclosure.

In some embodiments, the first context information corresponding to the i-th coordinate axis is determined based on occupancy information of at least one neighborhood node sharing a face with the current node among the N neighborhood nodes.

In some embodiments, the second context information corresponding to the i-th coordinate axis is determined based on occupancy information of at least one neighborhood node sharing an edge with the current node among the N neighborhood nodes.

In some embodiments, the first context information corresponding to the i-th coordinate axis is determined based on occupancy information of at least one neighborhood node sharing a face with the current node and occupancy information of at least one neighborhood node sharing an edge with the current node among the N neighborhood nodes.

In some embodiments, the second context information corresponding to the i-th coordinate axis is determined based on the occupancy information of at least one neighborhood node sharing a face with the current node and the occupancy information of at least one neighborhood node sharing an edge with the current node among the N neighborhood nodes.

After determining the first context information and/or the second context information corresponding to the i-th coordinate axis based on the types and the occupancy information of the N neighborhood nodes through the manners described in above Case I and Case II, the decoding side performs the step S103-A2, that is, predictive decoding is performed on the planar position information of the current node in the i-th coordinate axis based on the first context information and/or the second context information corresponding to the i-th coordinate axis.

The specific manner for performing predictive decoding on the planar position information of the current node in the i-th coordinate axis based on the first context information and/or the second context information corresponding to the i-th coordinate axis in S103-A2 is not limited in the embodiments of the present disclosure.

In some embodiments, the decoding side performs predictive decoding on the planar position information of the current node in the i-th coordinate axis only based on the first context information and/or the second context information corresponding to the i-th coordinate axis. For example, the decoding side determines a context model index based on the first context information and/or the second context information corresponding to the i-th coordinate axis, selects a context model from multiple preset context models based on the context model index, and then performs predictive decoding on the planar position information of the current node in the i-th coordinate axis using the context model.

In some embodiments, the S103-A2 includes the following steps S103-A21 and S103-A22.

In S103-A21: a target context model is determined based on the first context information and/or the second context information corresponding to the i-th coordinate axis and preset context information.

In S103-A22: predictive decoding is performed on the planar position information of the current node in the i-th coordinate axis based on the target context model.

In the present embodiment, when the decoding side performs predictive decoding on the planar position information of the current node in the i-th coordinate axis, the reference context information includes other preset context information in addition to the first context information and/or the second context information corresponding to the i-th coordinate axis.

The specific content of the preset context information is not limited in the embodiments of the present disclosure, which may be determined according to actual needs.

In a possible implementation, the preset context information includes at least one of: third context information, fourth context information, fifth context information or sixth context information; where
the third context information is that the planar position information of the current node is obtained as three elements by performing prediction using occupancy information of the neighborhood nodes: predicted as a low plane, predicted as a high plane, or unpredictable;
the fourth context information is that a spatial distance between a node at a same partition depth and a same coordinate as the current node and the current node is “near” or “far”;
the fifth context information is a planar position of a node at the same partition depth and the same coordinate as the current node if the node is a plane; and
the sixth context information is coordinate dimension (i=0, 1, 2).

In the present embodiment, when performing predictive decoding on the planar position information of the current node in the i-th coordinate axis, the decoding side determines the first context information and/or the second context information corresponding to the i-th coordinate axis and then performs predictive decoding on the planar position information of the current node in the i-th coordinate axis based on the first context information and/or the second context information corresponding to the i-th coordinate axis and the preset context information, based on the above steps. As can be seen, in the embodiments of the present disclosure, when performing predictive decoding on the planar position information of the current node, the decoding side not only considers preset prior information (i.e., the preset context information), but also the planar structure information of the neighborhood nodes (i.e., the first context information and/or the second context information), so that the predictive decoding effect of the planar position information of the current node is improved and the decoding efficiency of the point cloud is improved.

In the present embodiment, the decoding side determines a context model based on the first context information and/or the second context information corresponding to the i-th coordinate axis and the preset context information, and for the sake of ease of description, the context model is recorded as a target context model. Next, predictive decoding is performed on the planar position information of the current node in the i-th coordinate axis using the target context model.

The specific process for the decoding side to determine the target context model based on the first context information and/or the second context information corresponding to the i-th coordinate axis and the preset context information is introduced below.

In some embodiments, the decoding side determines an index of a target context model based on the first context information and/or the second context information corresponding to the i-th coordinate axis and the preset context information, selects a target context model from multiple preset context models based on the index of the target context model, and then performs predictive decoding on the planar position information of the current node in the i-th coordinate axis using the target context model.

In the present embodiment, the multiple context models are set for the planar position information, and the specific number of the context models corresponding to the planar position information is not limited in the embodiments of the present disclosure, as long as it is greater than 1. That is, in the embodiments of the present disclosure, an optimal context model is selected from at least two context models to perform predictive decoding on the planar position information of the current node in the i-th coordinate axis.

For example, as shown in Table 3, the planar position information corresponds to the multiple context models:

TABLE 3

| Index | Context model |
|---|---|
| 0 | Context model A |
| 1 | Context model B |
| . . . | . . . |

In this way, the decoding side determines the index of the target context model based on the first context information and/or the second context information corresponding to the i-th coordinate axis and the preset context information. Next, based on the index of the target context model, the target context model is selected from the context models shown in Table 3 to perform predictive decoding on the planar position information of the current node in the i-th coordinate axis.

In some embodiments, the S102-B21 includes the following steps S102-B211 and S102-B212.

In S102-B211: the first context information and/or the second context information corresponding to the i-th coordinate axis and the preset context information are classified into primary information and minor information based on the types of the N neighborhood nodes.

In S102-B212, the target context model is determined based on the primary information of the current node and part or all of the minor information of the current node.

As can be seen from the above, assuming that the context information of the planar position information includes the first context information and the second context information corresponding to the i-th coordinate axis and the above four preset context information, the final contexts of the planar position are as follows:
1) the planar position information of the current node being obtained as three elements by performing prediction using the occupancy information of the neighborhood nodes: predicted as a low plane, predicted as a high plane or unpredictable;
2) the spatial distance between the node at the same partition depth and the same coordinates as the current node and the current node being “close” or “far”;
3) the planar position of the node at the same partition depth and the same coordinate as the current node if the node is a plane;
4) coordinate dimension (i=0, 1, 2);
5) Ctx1: the planar structure information of three co-planar neighborhood nodes; and
6) Ctx2: the planar structure information of three co-edge neighborhood nodes and one co-vertex neighborhood node.

Assuming that when the decoding side determines the first context information corresponding to the i-th coordinate axis based on the planar flag information and the planar position information of three neighborhood nodes sharing a face with the current node among the N neighborhood nodes, Ctx1 including 2⁶=64 contexts may be obtained. Assuming that the decoding side determines the second context information corresponding to the i-th coordinate axis based on the planar flag information and the planar position information of three neighborhood nodes sharing an edge with the current node and one neighborhood node sharing a vertex with the current node among the N neighborhood nodes, Ctx2 including 2⁸=256 contexts may be obtained. In this way, the decoding side may obtain 3×2×2×3×64×256=589824 contexts based on the first context information and the second context information corresponding to the i-th coordinate axis and the above four preset context information. The memory space occupied by so many contexts is very huge. Based on this, in the embodiments of the present disclosure, when predictive decoding is performed on the planar position information of the node, the advanced(first) coding technology Dynamic-OUBF of G-PCC is added to the algorithm to reduce the number of contexts used for decoding the planar position information, for example, to reduce the number of contexts of the planar position to 3×16=48.

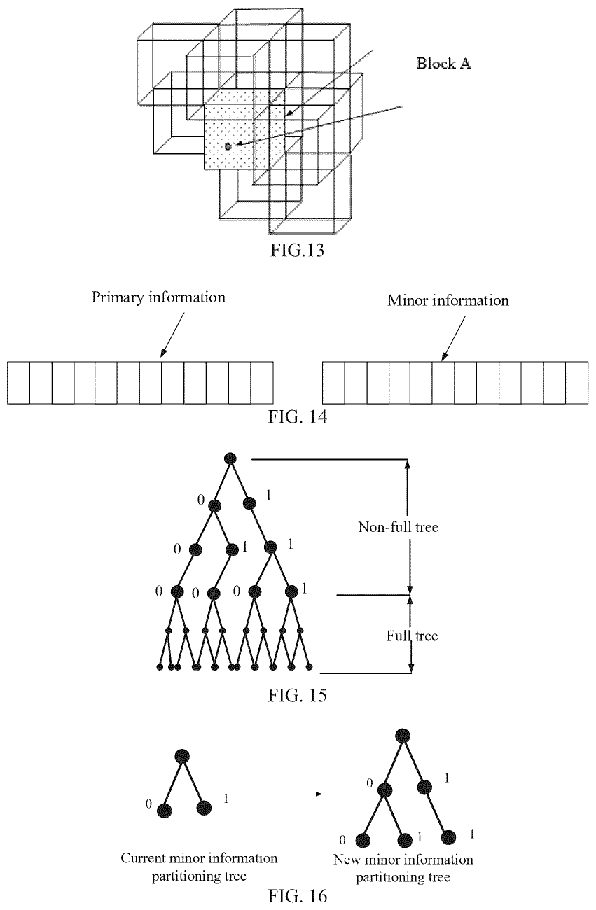

Exemplarily, in the embodiments of the present disclosure, as illustrated in FIG. 14, the decoding side classifies the determined first context information and/or the second context information corresponding to the i-th coordinate axis and the preset context information into the primary information and the minor information, and then determines the target context model based on the primary information of the current node and part or all of the minor information of the current node. It is to be noted that in the embodiments of the present disclosure, the target context model is mainly determined based on the primary information of the current node and part of the minor information of the current node, so as to reduce the number of contexts. In this way, not only can the memory occupancy of the contexts be reduced, but also the predictive decoding efficiency of the planar position information of the node can be improved.

The specific manner for classifying the first context information and/or the second context information corresponding to the i-th coordinate axis and the preset context information into the primary information and the minor information based on the types of N neighborhood nodes is not limited in the embodiments of the present disclosure.

Manner 1: in response to the N neighborhood nodes being the first-type neighborhood nodes, the decoding side determines at least one of the fourth context information, the fifth context information or the first context information as the primary information, and determines at least one of the third context information or the second context information as the minor information.

For example, the primary information includes:
the spatial distance between the node at the same partition depth and the same coordinate as the current node and the current node being “near” or “far”;
the planar position of the node at the same partition depth and the same coordinate as the current node if the node is a plane; and
the first context information corresponding to the i-th coordinate axis, for example, the first context information corresponding to the i-th coordinate axis includes occupancy information of three second-type neighborhood nodes sharing a face with the current node.

The minor information includes:
the planar position information of the current node being obtained as three elements by performing prediction using the occupancy information of the neighborhood nodes: predicted as a low plane, predicted as a high plane, or unpredictable; and
the second context information corresponding to the i-th coordinate axis, for example, the second context information corresponding to the i-th coordinate axis includes occupancy information of nine second-type neighborhood nodes sharing an edge with the current node.

Manner 2: in response to the N neighborhood nodes being the second-type neighborhood nodes, at least one of the third context information, the fourth context information, the fifth context information or the first context information is determined as the primary information, and the second context information is determined as the minor information.

For example, the primary information includes:
the planar position information of the current node being obtained as three elements by performing prediction using the occupancy information of the neighborhood nodes: predicted as a low plane, predicted as a high plane or unpredictable;
the spatial distance between the node at the same partition depth and the same coordinate as the current node and the current node being “near” or “far”;
the planar position of the node at the same partition depth and the same coordinate as the current node if the node is a plane; and
the first context information corresponding to the i-th coordinate axis, for example, the first context information corresponding to the i-th coordinate axis includes occupancy information of three second-type neighborhood nodes sharing a face with the current node.

The minor information includes:
the second context information corresponding to the i-th coordinate axis, for example, the second context information corresponding to the i-th coordinate axis includes occupancy information of nine second-type neighborhood nodes sharing an edge with the current node.

It is to be noted that in the embodiment of the present disclosure, the method in which the decoding side classifies the first context information and/or the second context information corresponding to the i-th coordinate axis and the preset context information into the primary information and the minor information based on the types of the N neighborhood nodes may include other methods in addition to the above methods of Manner 1 and Manner 2, and the embodiments of the present disclosure do not limit this.

Based on the above steps, after classifying the first context information and/or the second context information corresponding to the i-th coordinate axis and the preset context information into the primary information and the minor information based on the types of N neighborhood nodes, the decoding side performs the step S102-B212, that is, the target context model is determined based on the primary information of the current node and part or all of the minor information of the current node.

The specific manner in which the decoding side determines the target context model based on the primary information of the current node and part or all of the minor information of the current node is not limited in the embodiments of the present disclosure.

In some embodiments, the decoding side determines an index based on the primary information of the current node and part of the minor information of the current node, determines the index of the target context model based on the index, and then determines the target context model from the multiple preset context models based on the index of the target context model.

In some embodiments, the S102-B212 includes the following steps S102-B2121 to S102-B2124.

In S102-B2121: the primary information of the current node and the minor information of the current node are converted into binary representation.

In S102-B2122: a right-shift bit count of minor information corresponding to the current node is determined, and first minor information is selected from minor information after binary representation of the current node based on the right-shift bit count of minor information corresponding to the current node, where an initial value of the right-shift bit count of minor information is a total number of bits of the minor information after binary representation.

In S102-B2123: a first index is determined based on primary information after binary representation of the current node and the first minor information, and an index of the target context model is obtained from a preset context model index buffer based on the first index.

In S102-B2124: the target context model is obtained based on the index of the target context model.

In the present embodiment, based on the above steps, the decoding side classifies the first context information and/or the second context information corresponding to the i-th coordinate axis and the preset context information into the primary information and the minor information; and then, the decoding side converts the primary information and the minor information of the current node obtained by classifying into binary representation.

For example, referring to the above example, it is assumed that the decoding side classifies the first context information corresponding to the i-th coordinate axis, the spatial distance between the node at the same partition depth and the same coordinate as the current node and the current node being “near” or “far”, and the planar position of the node at the same partition depth and the same coordinate as the current node if the node is a plane into the primary information. Assuming that the first context information Ctx1 corresponding to the i-th coordinate axis includes 2⁶=64 contexts, and requires 6 bits to represent when converted into binary representation; the spatial distance between the node at the same partition depth and the same coordinate as the current node and the current node being “near” or “far” includes two contexts and requires 1 bit to represent when converted to binary representation; and the planar position of the node at the same partition depth and the same coordinate as the current node includes 2 contexts and requires 1 bit to represent when converted to binary representation, therefore, in such example, when the primary information of the current node is converted into binary representation, 6+1+1=8 bits are required for representation.

Similarly, it is assumed that the decoding side classifies the second context information corresponding to the i-th coordinate axis and the planar position information of the current node being obtained as three elements (predicted as a low plane, predicted as a high plane or unpredictable) by performing prediction using the occupancy information of the neighborhood nodes into the minor information. Assuming that the second context information Ctx2 corresponding to the i-th coordinate axis includes 28=256 contexts and requires 8 bits to represent when converted into binary representation; and the context information being that the planar position information of the current node is obtained as three elements (predicted as a low plane, predicted as a high plane or unpredictable) by performing prediction using the occupancy information of the neighborhood nodes includes three contexts and requires 2 bits to represent when converted to binary representation, therefore, in such example, when the minor information of the current node is converted into binary representation, 8+2=10 bits are required for representation.

The specific process for converting the primary information of the current node and the minor information of the current node into binary representation is introduced in the form of examples above. It is to be noted that the classifying manner of the primary information of the current node and the minor information of the current node includes, but is not limited to, the above examples. When the primary information of the current node and the minor information of the current node further include other context information, the primary information of the current node and the minor information of the current node may be converted into binary representation by referring to the method described in the above examples.

After converting the primary information of the current node and the minor information of the current node into binary representation, the decoding side determines the right-shift bit count of minor information corresponding to the current node, and then selects the first minor information from the minor information after binary representation of the current node based on the right-shift bit count of minor information. In the embodiments of the present disclosure, the right-shift bit count of minor information corresponding to the current node may be understood as that which is used to select which minor information from the minor information of the current node to perform predictive decoding on the planar position information of the current node.

The operation of determining the right-shift bit count of minor information corresponding to the current node is introduced below.

The specific manner for determining the right-shift bit count of minor information corresponding to the current node is not limited in the embodiments of the present disclosure.

In some embodiments, the right-shift bit count of minor information corresponding to the current node is a preset value. For example, for nodes in the point cloud octree, a preset number of nodes correspond to one right-shift bit count of minor information, so that the right-shift bit count of minor information corresponding to the current node may be determined. For example, the closer the node is to the root node of the octree, the larger the right-shift bit count of minor information corresponding to the node. Optionally, an initial value of the right-shift bit count of minor information is a total number of bits of the minor information after binary representation. For example, if the current node is the root node of the octree, the right-shift bit count of minor information corresponding to the current node is 10 bits.

In some embodiments, the operation that the right-shift bit count of minor information corresponding to the current node is determined in the S102-B2122 includes the following steps S102-B21221 and S102-B21222.

In S102-B21221: a right-shift bit count of minor information corresponding to a last level of a current minor information partitioning tree is determined, where the minor information partitioning tree is obtained by performing binary tree partitioning on the minor information starting from a highest bit of minor information.

In S102-B21222: the right-shift bit count of minor information corresponding to the last level is determined as the right-shift bit count of minor information corresponding to the current node.

The process for partitioning the minor information is introduced below.

Exemplarily, when the decoding side decodes the current point cloud, in the entire Dynamic-OUBF initialization process, assuming that the integer representation of the primary information is ct1 and the integer representation of the minor information is ct2, a context model index buffer ContextBuffer is initialized, and the size of ContextBuffer is ct1×ct2. For example, referring to the above example, assuming that the primary information includes 8 bits and the minor information includes 10 bits, the context model index buffer ContextBuffer having a size of 8×10 may be determined, and 8×10 context model indexes are stored in the context model index buffer ContextBuffer. In addition, the context initial probability of each state is set to 127 (i.e., 0.5).

In some embodiments, the process of minor information precision recovery is illustrated in FIG. 15.

First, the context of the entire minor information is represented in a binary format, and secondly, binary tree partitioning is performed on the minor information from a highest bit. As illustrated in FIG. 15, above a certain level, there is a non-full binary tree, that is, partitioning is performed according to the situation of the minor information itself, but when it is below MinDepth (currently set to 3), the precision of the minor information will be fully recovered. The partitioning of the minor information is introduced below in detail.

For example, a countBuffer counter is initialized having a size of ct1×(ct2 MinDepth) and initialized to 0.

In addition, a KDown is initialized to represent the precision (i.e., the right-shift bit count) of the minor information corresponding to each first state (index), the initial value of the right-shift bit count of minor information is a total number of bits of the minor information after binary representation, that is, the highest precision of the minor information. For example, when the minor information is 10 bits, the initial value of the right-shift bit count of minor information is 10 bits.

Further, a table of CountTimeTh is initialized to control the highest number of occurrences of the first state of each level of the minor information partitioning tree. When the number of occurrences of a certain first state exceeds the limit of this level, the low-bit precision of the minor information will be recovered, and the number of occurrences of the current first state will be reset to zero, the context probability of the recovered new first state inherits the probability of its parent node.

Exemplarily, as illustrated in FIG. 15, for the first node 1 in the point cloud, when predictive decoding is performed on the planar position information of node 1, firstly, the first context information and/or the second context information corresponding to node 1 are determined based on the above steps, and the first context information and/or the second context information corresponding to node 1 and the preset context information are classified into the primary information and the minor information, for example, classified into 8-bit primary information and 10-bit minor information. Next, the right-shift bit count of minor information corresponding to node 1 is obtained from KDown. Since node 1 is the first point of the point cloud, the right-shift bit count of minor information corresponding to node 1 is the initial value of the right-shift bit count of minor information, for example, 10 bits. In this way, when the decoding side determines that the right-shift bit count of minor information corresponding to node 1 is 10 bits, the minor information of node 1 is shifted to right by 10 bits. Since the minor information of node 1 is 10 bits in total, after shifting to right, the obtained first minor information of node 1 is 0 bit. Next, the decoding side determines the first state 1 based on the primary information after binary representation of node 1 and the first minor information, obtains the index of the target context model corresponding to node 1 from the context model index buffer ContextBuffer based on the first state 1, then obtains the target context model corresponding to node 1 based on the index of the target context model corresponding to the node 1, and finally performs predictive decoding on the planar position information of node 1 in the i-th coordinate axis using the target context model corresponding to the node. Meanwhile, the number of times of the first state 1 in countBuffer is increased by 1, and the number of times of the first state 1 in countBuffer is compared with the first preset threshold corresponding to the first level of the minor information partitioning tree stored in CountTimeTh. When the number of times of the first state 1 in countBuffer is less than the first preset threshold corresponding to the first level of the minor information partitioning tree stored in CountTimeTh, partitioning is not performed on the minor information partitioning tree.

Next, for node 2 in the point cloud, when predictive decoding is performed on the planar position information of node 2, firstly, the first context information and/or the second context information corresponding to node 2 are determined based on the above steps, and the first context information and/or the second context information corresponding to node 2 and the preset context information are classified into the primary information and the minor information, for example, classified into 8-bit primary information and 10-bit minor information. Next, the right-shift bit count of minor information corresponding to node 2 is obtained from KDown. Since the minor information partitioning tree is not partitioned, the right-shift bit count of minor information corresponding to node 2 is the same as that corresponding to node 1, and is the initial value of the right-shift bit count of minor information, for example, 10 bits. In this way, when the decoding side determines that the right-shift bit count of minor information corresponding to node 2 is 10 bits, the minor information of node 2 is shifted to right by 10 bits. Since the minor information of the node 2 is 10 bits in total, after right shifting, the obtained first minor information of node 2 is 0 bit. Next, the decoding side determines the first state 2 based on the primary information after binary representation of node 2 and the first minor information, obtains the index of the target context model corresponding to node 2 from the context model index buffer ContextBuffer based on the first state 2, then obtains the target context model corresponding to node 2 based on the index of the target context model corresponding to node 2, and finally performs predictive decoding on the planar position information of node 2 in the i-th coordinate axis using the target context model corresponding to the node. Meanwhile, the number of times of the first state 2 in countBuffer is increased by 1, and the number of times of the first state 2 in countBuffer is compared with the first preset threshold corresponding to the first level of the minor information partitioning tree stored in CountTimeTh. When the number of times of the first state 2 in countBuffer is less than the first preset threshold corresponding to the first level of the minor information partitioning tree stored in CountTimeTh, partitioning is not performed on the minor information partitioning tree.

It is assumed that the first state 1 is the same as the first state 2 and the first preset threshold corresponding to the first level of the minor information partitioning tree stored in CountTimeTh is 2, it may be determined that the number of times of the first state 1 in countBuffer is equal to the first preset threshold corresponding to the first level of the minor information partition tree stored in CountTimeTh. As such, partitioning is performed on the minor information partitioning tree, exemplarily, non-full binary tree partitioning is performed on the first level of the minor information partitioning tree to obtain a new minor information partitioning tree, and thus, the new minor information partitioning tree includes two levels, the first level includes one node, and the second level includes two nodes.

Meanwhile, the right-shift bit count of minor information in KDown is updated to obtain the right-shift bit count of minor information corresponding to the second level of the minor information partitioning tree. For example, the right-shift bit count of minor information corresponding to the second level is the right-shift bit count of minor information corresponding to the first level being minus 1, that is, 10 bits-1 bit=9 bits.

Further, countBuffer is set to 0.

Referring to the above steps, the precision of the minor information is gradually recovered, and the minor information partitioning tree illustrated in FIG. 15 may be obtained.

In this way, when predictive decoding is performed on the planar position information of the current node in the point cloud in the i-th coordinate axis, based on the above steps, the first context information and/or the second context information corresponding to the current node are determined, and the first context information and/or the second context information corresponding to the current node and the preset context information are classified into the primary information and the minor information, for example, classified into 8-bit primary information and 10-bit minor information. Next, the right-shift bit count of minor information corresponding to the last level of the current minor information partitioning tree is determined. As can be seen from the above, the right-shift bit count of minor information corresponding to the last level of the current minor information partitioning tree (i.e., the current level obtained by the last partitioning) is stored in KDown. Therefore, the decoding side may obtain the right-shift bit count of minor information corresponding to the last level of the current minor information partitioning tree from KDown, and then determine the right-shift bit count of minor information corresponding to the last level as the right-shift bit count of minor information corresponding to the current node.

Next, the decoding side selects the first minor information from the minor information after binary representation of the current node based on the right-shift bit count of minor information corresponding to the current node.

For example, the right-shift bit count of minor information corresponding to the current node is n bits, so the decoding side may shift the minor information after binary representation of the current node to right by n+1 bits or n−1 bits, to obtain the first minor information.

For another example, the minor information after binary representation of the current node is shifted to right by the right-shift bit count of minor information corresponding to the current node to obtain the first minor information. It is assumed that the right-shift bit count of minor information corresponding to the current node is n bits, the minor information after binary representation of the current node is shifted to right by n bits to obtain the first minor information.

Next, the decoding side determines the first state based on the primary information after binary representation of the current node and the first minor information.

The specific manner for the decoding side to determine the first state based on the primary information after binary representation of the current node and the first minor information is not limited in the embodiments of the present disclosure.

In an example, the decoding side obtains the first state corresponding to the current node based on the following equation (26):

$$state = ct 1 \times ( ct 2 ≫ shift ) \qquad ( 26 )$$

Where state is the first state corresponding to the current node, ct1 is the primary information after binary representation of the current node, ct2 is the minor information after binary representation of the current node, shift is the right-shift bit count of minor information corresponding to the current node, and ct2 shift is the first minor information corresponding to the current node.

After obtaining the first state corresponding to the current node based on the above equation (26), the decoding side obtains the context model index corresponding to the first state from the preset context model index buffer, and then records the context model index as the index of the target context model. In this way, the decoding side selects the target context model from the multiple preset context models based on the index of the target context model, and then performs predictive decoding on the planar position information of the current node in the i-th coordinate axis using the target context model.

In some embodiments, after determining the index of the target context model based on the above steps, the decoding side updates the index of the target context model in the context model index buffer to increase the probability of the index of the target context model.

The embodiments of the present disclosure, the decoding side determines the target context model based on the above steps, and further performs the steps of updating data and partitioning the minor information partitioning tree.

The specific partitioning manner of the minor information partitioning tree is not limited in the embodiments of the present disclosure.

In an example, non-full binary tree partitioning is performed on each level in the minor information partitioning tree.

In another example, full binary tree partitioning is performed on each level in the minor information partition tree.

In another example, non-full binary tree partitioning is performed on some levels in the minor information partitioning tree, and full binary tree partitioning is performed on some levels.

The partitioning process of the minor information partitioning tree is introduced below.

In some embodiments, when the minor information partitioning tree in the embodiments of the present disclosure includes a non-full binary tree level, the method in the embodiments of the present disclosure further includes the following step 1.

In step 1: in response to the last level of the current minor information partitioning tree being a non-full binary tree level, and a number of occurrences of the first state in the last level being greater than or equal to a first preset threshold corresponding to the last level, binary tree partitioning is performed on the last level to obtain a new minor information partitioning tree.

The decoding side determines the first state corresponding to the current node and the index of the target context model corresponding to the current node based on the above steps, and further determines whether to continue to perform partitioning on the last level of the current minor information partitioning tree. Exemplarily, when the last level of the current minor information partitioning tree being a non-full binary tree, the decoding side determines whether the number of occurrences of the first state corresponding to the current node in the last level (i.e., the newest level) of the current minor information partitioning tree is greater than or equal to the first preset threshold corresponding to the last level. When the decoding side determines that the number of occurrences of the first state corresponding to the current node in the last level (i.e., the newest level) of the current minor information partitioning tree is greater than or equal to the first preset threshold corresponding to the last level, the decoding side performs binary tree partitioning on the last level of the current minor information partitioning tree to obtain a new minor information partitioning tree.

For example, the decoding side determines that the minor information is further partitioned based on the following equation (27):

$$countBuffer [ state ] >= CountTime Th [ shift ] \qquad ( 27 )$$

Where countBuffer[state] represents the number of occurrences of the first state corresponding to the current node in the last level (i.e., the newest level) of the current minor information partitioning tree, and CountTimeTh[shift] is the first preset threshold corresponding to the last level of the current minor information partitioning tree.

In the embodiments of the present disclosure, the operation that the decoding side performs binary tree partitioning on the last level of the current minor information partitioning tree to obtain the new minor information partitioning tree includes at least the following two cases.

Case I: in response to the last level of the current minor information partitioning tree being not a last non-full binary tree level of the minor information partitioning tree, non-full binary tree partitioning is performed on the last level to obtain a new minor information partitioning tree.

For example, as illustrated in FIG. 15, it is assumed that the minor information partitioning tree includes four non-full binary tree levels and two full binary tree levels. As illustrated in FIG. 16, it is assumed that the last level of the current minor information partitioning tree is the second level, that is, the minor information is partitioned to the second level at the current time. In this case, the second level is not the last non-full binary tree level since the last non-full binary tree level is the fourth level. Therefore, when performing partitioning on the second level, non-full binary tree partitioning is performed on the second level to obtain the new minor information partitioning tree, in which the new minor information partitioning tree includes three levels, and the three levels are all non-full binary tree levels.

Case II: in response to the last level of the current minor information partitioning tree being a last non-full binary tree level of the minor information partitioning tree, full binary tree partitioning is performed on the last level to obtain a new minor information partitioning tree.

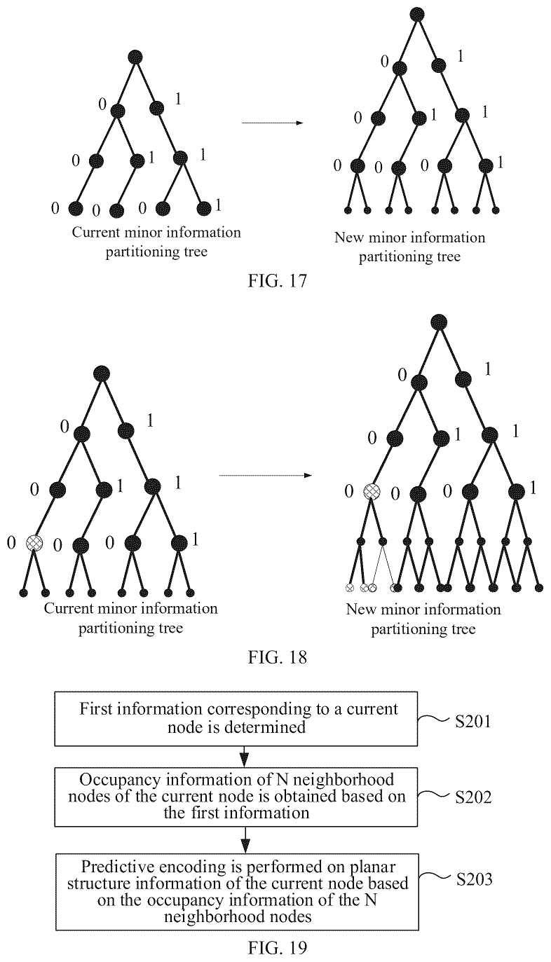

For example, as illustrated in FIG. 15, it is assumed that the minor information partitioning tree includes four non-full binary tree levels and two full binary tree levels. As illustrated in FIG. 17, it is assumed that the last level of the current minor information partitioning tree is the fourth level, that is, the minor information is partitioned to the fourth level at the current time. In this case, the fourth level is the last non-full binary tree level. Therefore, when performing partitioning on the fourth level, full binary tree partitioning is performed on the fourth level to obtain the new minor information partitioning tree, in which the new minor information partitioning tree includes five levels, and first four levels of the five levels are non-full binary tree levels, and the last level is a full binary tree level.

In the embodiments of the present disclosure, in addition to the step of performing full binary tree partitioning on the last level of the current minor information to obtain the new minor information partitioning tree, the step of updating the right-shift bit count of minor information is further included, that is, the right-shift bit count of minor information corresponding to the current node is subtracted by one to obtain a new right-shift bit count of minor information.

For example, the decoding side obtains the new right-shift bit count of minor information based on the following equation (28):

$$newShift = shift - 1 \qquad ( 28 )$$

Where shift is the right-shift bit count of minor information corresponding to the current node, and newShift is the new right-shift bit count of minor information.

Correspondingly, the calculation equation of the updated stateUpdate is shown in equation (29):

$$stateUpdate = ct 1 \times ( ct 2 ≫ newShift ) \qquad ( 29 )$$

Correspondingly, the context probability corresponding to the updated stateUpdate inherits the context probability of its parent node, as shown in equation (30):

$$ContextBuffer [ stateUpdate ] = ContextBuffer [ s t a t e ] \qquad ( 30 )$$

Correspondingly, the precision of the minor information corresponding to the current state is reduced, that is, KDown[state]- -.

Finally, the decoding side resets the occurrence counter of the current state to 0, that is, countBuffer[state]=0.

In some embodiments, when the minor information partitioning tree in the embodiments of the present disclosure includes a full binary tree level, the method in the embodiments of the present disclosure further includes the following steps 21 to 24.

In step 21: in response to the last level of the current minor information partitioning tree being a full binary tree level, a right-shift bit count of minor information and a first preset threshold corresponding to a last non-full binary tree level of the current minor information partitioning tree are determined.

In step 22: second minor information is selected from the minor information after binary representation of the current node based on the right-shift bit count of minor information corresponding to the last non-full binary tree level.

In step 23: a second state is determined based on the primary information after binary representation of the current node and the second minor information.

In step 24: in response to a number of occurrences of the second state in the last level being greater than or equal to the first preset threshold corresponding to the last non-full binary tree level, full binary tree partitioning is performed on the last level, to obtain a new minor information partitioning tree.

In the present embodiment, when the minor information partitioning tree includes a non-full binary tree level and a full binary tree level, it is determined whether to continue to perform partitioning on the full binary tree level based on the right-shift bit count of minor information and the first preset threshold corresponding to the last non-full binary tree level of the minor information partitioning tree. Exemplarily, when the last level of the current minor information partitioning tree is a full binary tree level, the right-shift bit count of minor information and the first preset threshold corresponding to the last non-full binary tree level of the current minor information partitioning tree are determined, and the second minor information is selected from the minor information after binary representation of the current node based on the right-shift bit count of minor information corresponding to the last non-full binary tree level. For example, the minor information after binary representation of the current node is shifted to the right by the right-shift bit count of minor information corresponding to the last non-full binary tree level, to obtain the second minor information corresponding to the current node. Next, the second state is determined based on the primary information after binary representation of the current node and the second minor information. For example, the primary information after binary representation of the current node and the second minor information are multiplied to determine the second state.

Then, it is determined whether the number of occurrences of the second state in the last level of the current minor information partitioning tree is greater than or equal to the first preset threshold corresponding to the last non-full binary tree level based on the following equation (31):

$$countBuffer [ state ] 1 >= Count ime Th [ shift ] 1 \qquad ( 31 )$$

Where countBuffer[state]1 is the number of occurrences of the second state in the last level of the current minor information partitioning tree, and CountTimeTh[shift]1 is the first preset threshold corresponding to the last non-full binary tree level.

When the number of occurrences of the second state in the last level of the current minor information partitioning tree is greater than or equal to the first preset threshold corresponding to the last non-full binary tree level, full binary tree partitioning is performed on the last level to obtain the new minor information partitioning tree.

Meanwhile, the decoding side updates the right-shift bit count of minor information, that is, the right-shift bit count of minor information corresponding to the current node is subtracted by one to obtain a new right-shift bit count of minor information.

For example, the decoding side obtains the new right-shift bit count of minor information based on the above equation (28).

Correspondingly, the calculation equation of the updated stateUpdate is shown in the above equation (29).

Correspondingly, the context probability corresponding to the updated stateUpdate inherits the context probability of the last non-full binary tree level.

Correspondingly, the precision of the minor information corresponding to the current state is reduced, that is, KDown[state]- -.

Finally, the decoding side resets the occurrence counter of the current state to 0, that is, countBuffer[state]=0.

For example, as illustrated in FIG. 15, it is assumed that the minor information partitioning tree includes four non-full binary tree levels and two full binary tree levels. As illustrated in FIG. 18, it is assumed that the last level of the current minor information partitioning tree is the fifth level, that is, the minor information is partitioned to the fifth level at the current time. In this case, the fifth level is a full binary tree level. Therefore, when determining whether to perform partitioning on the fifth level, the decoding side first determines the right-shift bit count of minor information a and the first preset threshold b corresponding to the last non-full binary tree level of the current minor information partitioning tree, that is, the fourth level. Next, the decoding side shifts the minor information of the current node after binary representation to the right by the right-shift bit count of minor information a corresponding to the last non-full binary tree level to obtain the second minor information. Then, the decoding side multiplies the primary information after binary representation of the current node and the second minor information to obtain the second state corresponding to the current node. Finally, it is determined whether the number of occurrences of the second state in the current last level (i.e., the fifth level) is greater than or equal to the first preset threshold b corresponding to the last non-full binary tree level, and when the number of occurrences of the second state in the fifth level is greater than or equal to the first preset threshold b corresponding to the last non-full binary tree level, full binary tree partitioning is performed on the fifth level to obtain the new minor information partitioning tree.

In summary, the entire processing flow of Dynamic-OUBF may be that: Dynamic-OUBF is used as a processor, its inputs are the primary information and the minor information of the current node, and its finally outputs is an index of the target context model (context) between 0 and 255.

In some embodiments, in order to further reduce the number of context information, the operation of obtaining the target context model based on the index of the target context model in the above S102-B2124 includes the following steps S102-B21241 and S102-B21242.

In S102-B21241: the index of the target context model is quantized to obtain a quantized model index.

In S102-B21242: the target context model is obtained based on the quantized model index.

In the present embodiment, in order to further reduce the number of context information, the determined index of the target context model above is quantized to obtain the quantized model index, and then the target context model is obtained from the multiple preset context models based on the quantized model index.

The specific manner for quantizing the index of the target context model to obtain the quantized model index is not limited in the embodiments of the present disclosure.

In a possible implementation, the index of the target context model is shifted to the right by n bits to obtain the quantized model index, n being a positive integer.

The embodiment of the present disclosure does not limit the specific value of n.

In an example, n=2 bits, in this case, when quantization is not performed and the number of contexts is 256, the index of the context model is shifted to the right by 2 bits, and the total number of contexts may be reduced to 256/4=64. In this way, the number of contexts may be greatly reduced, so as to improve the decoding efficiency of the point cloud.

In an example, n=4 bits, in this case, when quantization is not performed and the number of contexts is 256, the index of the context model is shifted to the right by 4 bits, and the total number of contexts may be reduced to 256/16=16. In this way, with three coordinate axes, 3×16=48 context models may be obtained, the number of contexts is greatly reduced, so as to improve the decoding efficiency of the point cloud.

In the embodiments of the present disclosure, predictive coding is performed on the planar position information of the current node through considering the planar structure information of the neighborhood nodes, so that the geometry coding efficiency of the point cloud can be improved.

Taking the lossless geometry lossless attribute test environment as an example below, the number of bits occupied by per pixel (bit per pixel, abbreviated as BPP) is used as a performance index to measure compression efficiency. When BPP is less than 100%, it means that the encoding and decoding efficiency is improved compared to the existing encoding and decoding solutions.

Under the lossless geometry lossless attribute, the performance of the point cloud decoding method provided by the embodiments of the present disclosure is illustrated in Table 4:

TABLE 4

| | Lossless geometry, Lossless attributes | | | |
|---|---|---|---|---|
| | (full intra) Bpip bitrate [%] | | | |
| CW_ai | geometry | color | Reflectance | all |
| Solid Average | 100.0% | 100.0% | | 100.0% |
| Dense Average | 97.0% | 100.0% | | 99.0% |
| Sparse Average | 99.1% | 100.0% | | 99.6% |
| Scant Average | 99.5% | 100.0% | | 99.6% |
| Am-fusion average | 98.0% | 100.0% | 100.0% | 99.0% |
| Am-frame spinning | 100.0% | | 100.0% | 100.0% |
| average | | | | |
| Am-frame | 100.4% | | 100.0% | 100.3% |
| non-spinning average | | | | |
| Overall average | 99.3% | 100.0% | 100.0% | 99.6% |

Under the lossy geometry lossy attribute, the performance of the point cloud decoding method provided by the embodiments of the present disclosure is illustrated in Table 5:

TABLE 5

Lossy geometry lossy
attribute (full intra)
Geometry BD bitrate [%]

| C2_ai | D1 | D2 |
|---|---|---|
| Solid Average | 0.0% | 0.0% |
| Dense Average | 0.0% | −0.1% |
| Sparse Average | −0.5% | −0.5% |
| Scant Average | −1.4% | −1.4% |
| Am-fusion average | −2.1% | −2.1% |
| Am-frame spinning | 0.0% | 0.0% |
| average | | |
| Am-frame | 0.0% | |
| non-spinning average | | |
| Overall average | −0.6% | −0.6% |

The planar decoding of all test sequences is turned on, the test performance of the present disclosure and the existing TMC13-v19 is illustrated in Table 6:

TABLE 6

| | Lossless geometry, Lossless attributes | | | |
|---|---|---|---|---|
| | (full intra) Bpip bitrate [%] | | | |
| CW_ai | geometry | color | Reflectance | all |
| Dense Average | 95.0% | 100.0% | | 98.2% |
| Sparse Average | 99.1% | 100.0% | | 99.6% |
| Scant Average | 99.5% | 100.0% | | 99.6% |
| Am-fusion average | 98.0% | 100.0% | 100.0% | 99.0% |
| Am-frame spinning | 100.0% | | 100.0% | 100.0% |
| average | | | | |
| Am-frame | 100.4% | | 100.0% | 100.3% |
| non-spinning average | | | | |
| Overall average | 99.2% | 100.0% | 100.0% | 99.5% |

As can be seen from Tables 4 to 6, when the methods provided in the embodiments of the present disclosure are applied to the selected test sequence set, the compression performance of a single sequence may be improved by up to 5.7%.

As can be seen from the above, in the embodiments of the present disclosure, when decoding the planar position information of the node, predictive decoding is performed on the planar position information of the current node based on the planar structure information of the neighborhood nodes. The correlation between the planar structure information between neighboring nodes is considered, thereby effectively improving coding efficiency of geometry information of the point cloud. Further, in the embodiments of the present disclosure, the N neighborhood nodes of the current node are determined based on the first information corresponding to the current node, the first context information and/or the second context information are determined based on the types of the N neighborhood nodes, and the first context information, the second context information and the preset context are classified into the primary information and the minor information based on the types of the N neighborhood nodes, and the planar position contexts are mapped to a preset number (for example, 48) of contexts using the Dynamic-OUBF technology, while improving the decoding effect of the planar position information of the node, the number of contexts is reduced, thereby saving memory space used for storing context information and further improving the decoding efficiency of the point cloud.

According to the point cloud decoding method provided in the embodiments of the present disclosure, when the planar structure information of the current node in the current decoded picture is decoded, the first information corresponding to the current node is determined, where the first information is used to indicate whether the first-type neighborhood nodes of the current node exist, and the first-type neighborhood nodes are neighborhood nodes whose geometry information has been decoded. Next, the occupancy information of the N neighborhood nodes of the current node is obtained based on the first information, and predictive decoding is performed on the planar structure information of the current node based on the occupancy information of the N neighborhood nodes. That is, in the embodiments of the present disclosure, when predictive decoding is performed on the planar structure information of the current node, the correlation between the planar structure information of neighborhood nodes and the types of neighborhood nodes are taken into account, which may effectively improve the decoding efficiency of the geometry information of the point cloud, thereby improving the predictive decoding performance of the planar structure information and improving the decoding efficiency and performance of the point cloud.

The point cloud decoding method provided by an embodiment of the present disclosure is introduced in detail above taking the decoding side as an example, the point cloud encoding method provided by an embodiment of the present disclosure is introduced below taking the encoding side as an example.

FIG. 19 is a flowchart of a point cloud encoding method provided by an embodiment of the present disclosure. The point cloud encoding method in the embodiments of the present disclosure may be implemented by the point cloud encoding device illustrated in FIG. 3 or FIG. 4A above.

As illustrated in FIG. 19, the point cloud encoding method in the embodiments of the present disclosure includes the following steps.

In S201: first information corresponding to a current node is determined.

The first information is used to indicate whether first-type neighborhood nodes of the current node are valid, and the first-type neighborhood nodes are neighborhood nodes whose geometry information has been encoded.

As can be seen from the above, the point cloud has geometry information and attribute information, and encoding of the point cloud includes geometric encoding and attribute encoding. The embodiments of the present disclosure relate to geometric encoding of the point cloud.

In some embodiments, the geometry information of the point cloud is also referred to as position information of the point cloud, and therefore, the geometric encoding of the point cloud is also referred to as position encoding of the point cloud.

In the octree-based coding manner, the encoding side constructs an octree structure of the point cloud based on the geometry information of the point cloud, as illustrated in FIG. 10, where a minimum cuboid is used to surround the point cloud. First, octree partitioning is performed on the bounding box to obtain 8 nodes, and then, octree partitioning is continuously performed on occupied nodes among these 8 nodes (that is, nodes including points), and so on, until partitioned into a voxel-level position, for example, until partitioned into a 1×1×1 cube. The point cloud octree structure obtained by such partitioning includes multiple levels of nodes, for example, including N levels. During encoding, occupancy information of each level is encoded level by level until the voxel-level leaf nodes of the last level are encoded. That is, in octree encoding, by performing octree partitioning on the point cloud, the points in the point cloud are finally partitioned into voxel-level leaf nodes of the octree; and the encoding of the point cloud is realized by encoding the entire octree.

However, for some relatively planar nodes or nodes with planar characteristics, the coding efficiency of the geometry information of point cloud may be further improved by utilizing the planar coding. For example, as illustrated in FIG. 5A, the four occupied child nodes of the current node are all located at the low plane position of the current node in the Z-coordinate axis direction, and thus, the occupancy information of the current node is represented as: 11001100. In this way, when the current node is encoded by using the planar coding manner, first, a flag needs to be encoded to represent that the current node is a plane in the Z-axis direction. Secondly, if the current node is a plane in the Z-axis direction, the planar position of the current node needs to be represented. Thirdly, only the occupancy information of the low plane nodes in the Z-coordinate axis direction needs to be encoded (i.e., the occupancy information of the four child nodes 0, 2, 4 and 6). Therefore, when encoding the current node based on the planar coding manner, only 6 bits are needed to be encoded, which may reduce 2 bits of representation compared to the original octree coding, thereby improving the coding performance of the point cloud.

As can be seen from the above, when encoding the current node using the planar coding manner, the encoding side needs to perform predictive encoding on the planar structure information of the current node.

At present, predictive encoding is performed on the planar structure information of the current node based on some prior reference information (such as a spatial distance between a node at the same partition depth and the same coordinate as the current node and the current node and/or a planar position of the node at the same partition depth and the same coordinate as the current node), resulting in poor predictive coding performance of the planar structure information.

In order to solve the above problems, in the embodiments of the present disclosure, the encoding side performs predictive encoding on the planar structure of the current node based on the occupancy information of the N neighborhood nodes of the current node, thereby improving the predictive encoding performance of the planar structure information and improving the encoding efficiency and performance of the point cloud.

In the embodiments of the present disclosure, in order to improve the prediction encoding accuracy of the planar structure information of the current node, the occupancy information of the N neighborhood nodes of the current node whose geometry information has been encoded is usually used to perform predictive encoding on the planar structure information of the current node.

In some embodiments, for the sake of ease of description, the N neighborhood nodes of the current node whose geometry information has been encoded are recorded as the first-type neighborhood nodes.

In the embodiments of the present disclosure, the first-type neighborhood nodes may be understood as that occupancy status of child nodes included in the neighborhood nodes has been encoded. For example, the occupied status of 8 child nodes of neighborhood node 1 is 11001010, 1 representing occupied and 0 representing unoccupied.

It is to be noted that, the specific manner for determining the first-type neighborhood nodes is not limited in the embodiments of the present disclosure.

In an example, as illustrated in FIG. 11, the first-type neighborhood nodes of the current node include any node whose geometry information has been encoded within a point cloud spatial area of 3×3.

In an example, as illustrated in FIG. 12, a node with thick dashed line is the current node to be encoded, the nodes with solid line are three neighborhood nodes sharing a face with the current node, the nodes with dotted line are three neighborhood nodes sharing an edge with the current node, and a node with long dashed line is a neighborhood node sharing a vertex with the current node. Since geometry information of the seven neighborhood nodes that share a face, an edge or a vertex (in left, front or lower direction) with the current node illustrated in FIG. 12 has been encoded when the occupancy information of the current node is encoded according to the order of point cloud encoding, these 7 neighborhood nodes may be recorded as the first-type neighborhood nodes.

In an example, the first-type neighborhood nodes of the current node may include, in addition to the seven neighborhood nodes that share a face, an edge or a vertex (in left, front, or lower direction) with the current node as illustrated in FIG. 12, other nodes whose geometry information has been encoded within a preset reference neighborhood range, which is not limited in the embodiments of the present disclosure.

In some embodiments, the first-type neighborhood nodes of the current node are invalid, for example, the current node does not have the first-type neighborhood nodes (i.e., the neighborhood nodes whose geometry information has been encoded), in this case, the encoding side cannot use the occupancy information of the first-type neighborhood nodes to perform predictive encoding on the planar structure information of the current node.

Based on this, before performing predictive encoding on the planar structure information of the current node, the encoding side first needs to determine the first information corresponding to the current node, where the first information is used to indicate whether the current node has the first-type neighborhood nodes (i.e., the neighborhood nodes whose geometry information has been encoded). Next, based on the first information, N neighborhood nodes of the current node are determined. For example, when the first information indicates that the current node has the first-type neighborhood nodes, the encoding side determines N first-type neighborhood nodes of the current node and performs predictive encoding on the planar structure information of the current node based on the geometry information of the first-type neighborhood nodes. For another example, when the first information indicates that the current node does not have the first-type neighborhood nodes, the encoding side determines N other-type neighborhood nodes of the current node and then performs predictive encoding on the planar structure information of the current node based on the geometry information of these N other-type neighborhood nodes.

The specific process for the encoding side to determine the first information corresponding to the current node is introduced below.

When encoding the geometry information of the current node, the encoding side determines whether the current node has the first-type neighborhood nodes; determines the first information neighAvaibale corresponding to the current node based on whether the current node has the first-type neighborhood nodes. For example, when the current node has the first-type neighborhood nodes, the first information neighAvaibale is set to be true; or when the current node does not have the first-type neighborhood nodes the first information neighAvaibale is set to be false.

In some embodiments, the encoding side signals the first information neighAvaibale corresponding to the current node into a bitstream.

After determining the first information corresponding to the current node based on the above steps, the encoding side performs the following step S202.

In S202: occupancy information of N neighborhood nodes of the current node is obtained based on the first information.

Where N is a positive integer.

After determining the first information corresponding to the current node based on the above step, the encoding side determines whether the current node has the first-type neighborhood nodes based on the first information. In this way, the occupancy information of the N neighborhood nodes of the current node may be obtained based on the first information.

The specific process for the encoding side to obtain the occupancy information of the N neighborhood nodes of the current node based on the first information is not limited in the embodiments of the present disclosure.

Case I: in response to the first information indicating that at least one first-type neighborhood node of the current node is valid, the encoding side obtains the occupancy information of N first-type neighborhood nodes of the current node, and uses the occupancy information of the N first-type neighborhood nodes as the occupancy information of the N neighborhood nodes of the current node.

In Case I, in response to the first information corresponding to the current node indicating that the at least one first-type neighborhood node of the current node is valid (i.e., exists), since the geometry information of the first-type neighborhood node(s) has been encoded, the prediction accuracy of the planar structure information of the current node may be improved when the planar structure information of the current node is predicted by using the occupancy information of the first-type neighborhood node(s) whose geometry information has been encoded. Therefore, the encoding side obtains the occupancy information of the N first-type neighborhood nodes of the current node, and performs predictive encoding on the planar structure information of the current node based on the occupancy information of the N first-type neighborhood nodes.

In the embodiments of the present disclosure, the number and specific positions of the N first-type neighborhood nodes are not limited.

In some embodiments, the N first-type neighborhood nodes include at least one of: three first co-planar neighborhood nodes, three first co-edge neighborhood nodes or one first co-vertex neighborhood node. As illustrated in FIG. 12, the three first co-planar neighborhood nodes include a neighborhood node sharing a face with a front surface of the current node, a neighborhood node sharing a face with a left surface of the current node, and a neighborhood node sharing a face with a bottom surface of the current node; the three first co-edge neighborhood nodes include a neighborhood node sharing an edge with a left edge of the front surface of the current node, a neighborhood node sharing an edge with a bottom edge of the front surface of the current node, and a neighborhood node sharing an edge with a left edge of the bottom surface of the current node; and the first co-vertex neighborhood node is a neighborhood node sharing a vertex with a bottom left front vertex of the current node.

In some embodiments, as illustrated in FIG. 12, when all seven first-type neighborhood nodes of the current node exist, in this case, in an example, the seven first-type neighborhood nodes may be used as the N first-type neighborhood nodes of the current node, and N=seven; and in another example, the N first-type neighborhood nodes may be selected from the seven first-type neighborhood nodes, and N is a positive integer less than seven.

In some embodiments, as illustrated in FIG. 12, when only a part of the first-type neighborhood nodes of the seven first-type neighborhood nodes of the current node exist, in an example, the existing part of first-type neighborhood nodes may be used as the N first-type neighborhood nodes of the current node; and in another example, the N first-type neighborhood nodes may be selected from the existing part of first-type neighbor nodes.

Based on the above method, the encoding side determines the N first-type neighborhood nodes of the current node. Since the geometry information of the above N first-type neighborhood nodes has been encoded, the encoding side may obtain the occupancy information of the N first-type neighborhood nodes, where the occupancy information of the first-type neighborhood nodes indicates whether each child node of the first-type neighborhood nodes is unoccupied. For example, when octree coding is adopted in the present disclosure, the occupancy information of the first-type neighborhood nodes is 8-bit information.

The specific process of obtaining the geometry information of the N first-type neighborhood nodes when the first information indicates that the current node has the first-type neighborhood nodes in Case I is introduced above.

Case II: in response to the first information indicating that all first-type neighborhood nodes of the current node are invalid, occupancy information of N second-type neighborhood nodes of the current node is obtained, and the occupancy information of the N second-type neighborhood nodes is used as the occupancy information of the N neighborhood nodes of the current node.

In Case II, in response to the first information corresponding to the current node indicating that the first-type neighborhood nodes of the current node are invalid (i.e., do not exist), the encoding side cannot use the occupancy information of the first-type neighborhood nodes to perform predictive encoding on the planar structure information of the current node. In this way, the encoding side determines the N second-type neighborhood nodes of the current node, and performs predictive encoding on the planar structure information of the current node based on the occupancy information of the N second-type neighborhood nodes.

A second-type neighborhood node is a neighborhood node whose geometry information has not been encoded.

In the embodiments of the present disclosure, the geometry information of the second-type neighborhood node has not been encoded, therefore, occupancy status of child nodes of the second-type neighborhood node is unknown, but whether the second-type neighborhood node is occupied is known. For example, when the second-type neighborhood node is occupied, the occupancy information of the second-type neighborhood node is represented as 1, and when the second-type neighborhood node is not occupied, the occupancy information of the second-type neighborhood node is represented as 0.

As can be seen from the above, in the embodiments of the present disclosure, the occupancy information of the second-type neighborhood nodes is different from the occupancy information of the first-type neighborhood nodes. The occupancy information of the first-type neighborhood node indicates whether the child nodes of the first-type neighborhood nodes are occupied, which is 8-bit information. While the occupancy information of the second-type neighborhood node indicates whether the second-type neighborhood node is occupied, which is 1-bit information.

In the embodiments of the present disclosure, the number and specific positions of the N second-type neighborhood nodes are not limited.

In some embodiments, the N second-type neighborhood nodes include any one neighborhood node among neighborhood nodes of the current node except the first-type neighborhood nodes.

In some embodiments, the N second-type neighborhood nodes include at least one of: three second co-planar neighborhood nodes or nine second co-edge neighborhood nodes. For example, as illustrated in FIG. 13, the three second co-planar neighborhood nodes include a neighborhood node sharing a face with a rear surface of the current node, a neighborhood node sharing a face with a right surface of the current node, and a neighborhood node sharing a face with a top surface of the current node; and the nine second co-edge neighborhood nodes include four neighborhood nodes respectively sharing an edge with four edges of the right surface of the current node, three neighborhood nodes respectively sharing an edge with a front edge, a left edge and a rear edge of the top surface of the current node, and two neighborhood nodes respectively sharing an edge with a left edge and a bottom edge of the rear surface of the current node.

In some embodiments, as illustrated in FIG. 13, when all twelve second-type neighborhood nodes of the current node exist, in this case, in an example, the twelve second-type neighborhood nodes may be used as the N second-type neighborhood nodes of the current node, and N=twelve; and in another example, the N second-type neighborhood nodes may be selected from the twelve second-type neighborhood nodes, where N is a positive integer less than twelve.

In some embodiments, as illustrated in FIG. 13, when only a part of the second-type neighborhood nodes of the twelve second-type neighborhood nodes of the current node exist, in this case, in an example, the existing part of second-type neighborhood nodes may be used as the N second-type neighborhood nodes of the current node; and in another example, the N second-type neighborhood nodes may be selected from the existing part of second-type neighborhood nodes.

Based on the above method, the encoding side determines the N second-type neighborhood nodes of the current node. Since the geometry information of the above N second-type neighborhood nodes has not been encoded, the encoding side may obtain the occupancy status of each second-type neighborhood node among the N second-type neighborhood nodes, and then determine the occupancy status of the second-type neighborhood nodes as the occupancy information of the second-type neighborhood nodes. For example, when the second-type neighborhood node is occupied, the occupancy information of the second-type neighborhood node is determined to be 1; and when the second-type neighborhood node is not occupied, the occupancy information of the second-type neighborhood node is determined to be 0, that is, the occupancy information of the second-type neighborhood node is 1-bit information.

After determining the N neighborhood nodes of the current node based on the first information, the encoding side performs the following step S203.

In S203: predictive encoding is performed on planar structure information of the current node based on the occupancy information of the N neighborhood nodes.

In the embodiments of the present disclosure, the planar structure information of the current node includes planar flag information of the current node and/or planar position information of the current node.

As can be seen from above, the planar flag of the current node is represented by PlaneModei (i=0, 1, 2), where i=0 represents the X-coordinate axis, i=1 represents the Y-coordinate axis and i=2 represents the Z-coordinate axis. PlaneModei=0 represents that the current node is not a plane in the direction of the i-th coordinate axis, and PlaneModei=1 represents that the current node is a plane in the direction of the i-th coordinate axis.

When the current node is a plane in the direction of the i-th coordinate axis, i.e., PlaneModei=1, the encoding side continues to encode the planar position information of the current node in the i-th coordinate axis. Exemplarily, PlanePositioni is used to represent the planar position information of the current node in the i-th coordinate axis direction. For example, PlanePositioni=0 represents that the current node is a plane in the i-th coordinate axis direction, and the planar position is a low plane, and PlanePositioni=1 represents that the current node is a high plane in the i-th coordinate axis direction.

In the embodiments of the present disclosure, predictive encoding is performed on the planar structure information of the current node based on the occupancy information of the N neighborhood nodes, that is, predictive encoding is performed on the planar flag and/or the planar position information of the current node.

For example, predictive encoding is performed on the planar flag of the current node in the i-th coordinate axis based on the occupancy information of the N neighborhood nodes of the current node.

For another example, predictive encoding is performed on the planar position information of the current node in the i-th coordinate axis based on the occupancy information of the N neighborhood nodes of the current node.

In the embodiments of the present disclosure, the operation that predictive encoding is performed on the planar structure information of the current node based on the occupancy information of the N neighborhood nodes of the current node may be understood as that the occupancy information of the N neighborhood nodes of the current node is used as context information of the planar structure information of the current node to perform predictive encoding on the planar structure information of the current node. For example, a context model index is determined based on the occupancy information of the N neighborhood nodes of the current node; a context model is determined based on the context model index; and predictive encoding is performed on the planar structure information of the current node based on the context model, for example, predictive encoding is performed on the planar flag of the current node based on the context model, or predictive encoding is performed on the planar position information of the current node based on the context model.

The specific manner in which the encoding side performs predictive encoding on the planar structure information of the current node based on the occupancy information of the N neighborhood nodes is not limited in the embodiments of the present disclosure.

In some embodiments, as can be seen from the above, the N neighborhood nodes of the current node may be the first-type neighborhood nodes or the second-type neighborhood nodes. However, in the present embodiment, the types of the N neighborhood nodes are not considered, and the encoding side uses the occupancy information of the N neighborhood nodes as the context information to perform predictive encoding on the planar structure information of the current node. For example, the occupancy information of the N neighborhood nodes of the current node is used as the context information to determine a context model index; a context model is determined based on the context model index; and predictive encoding is performed on the planar structure information of the current node based on the context model.

In some embodiments, when the planar structure information of the current node includes the planar position information of the current node, the encoding side considers the type of the neighborhood nodes when performing predictive encoding on the planar structure information of the current node based on the occupancy information of the N neighborhood nodes, and in this case, the above S203 includes the following step S203-A.

In S203-A: predictive encoding is performed on the planar position information of the current node based on types and the occupancy information of the N neighborhood nodes.

In the present embodiment, when the encoding side performs predictive encoding on the planar position information of the current node based on the occupancy information of the N neighborhood nodes, the types of the neighborhood nodes are considered. For example, different manners may be adopted for different types of neighborhood nodes when performing predictive encoding on the planar position information of the current node based on the occupancy information of the neighborhood nodes.

In some embodiments, the encoding side may further use the types and the occupancy information of the N neighborhood nodes as the context information to perform predictive encoding on the planar structure information of the current node. For example, the types and the occupancy information of the N neighborhood nodes are used as the context information to determine a context model index; and a context model is determined based on the context model index; and predictive encoding is performed on the planar position information of the current node based on the context model.

In some embodiments, the above S203-A includes the following steps.

In S203-A1: first context information and/or second context information corresponding to the i-th coordinate axis are determined based on the types and the occupancy information of the N neighborhood nodes, where the i-th coordinate axis is an X-coordinate axis, a Y-coordinate axis, or a Z-coordinate axis.

In S203-A2: predictive encoding is performed on planar position information of the current node in the i-th coordinate axis based on the first context information and/or the second context information corresponding to the i-th coordinate axis.

In the embodiments of the present disclosure, due to different types of the neighborhood nodes, the implementation of the S203-A1 includes at least the following two cases.

Case I: in response to the N neighborhood nodes being the first-type neighborhood nodes, then the S203-A1 includes the following steps.

In S203-A1-a1: planar structure information of the N neighborhood nodes is determined based on the occupancy information of the N neighborhood nodes, where occupancy information of a neighborhood node indicates occupancy information of a child node of the neighborhood node.

In S203-A1-a2: the first context information and/or the second context information corresponding to the i-th coordinate axis are determined based on the planar structure information of the N neighborhood nodes.

In Case I, in a case where the current node has the first-type neighborhood nodes, when the encoding side uses the occupancy information of the first-type neighborhood nodes to perform predictive encoding on the planar position information of the current node, the planar structure information of the N first-type neighborhood nodes is determined first based on the occupancy information of the N first-type neighborhood nodes; and then, the first context information and/or the second context information corresponding to the i-th coordinate axis are determined based on the planar structure information of the N first-type neighborhood nodes. Finally, a target context model is determined based on the first context information and/or the second context information corresponding to the i-th coordinate axis, and predictive encoding is performed on the planar position information of the current node in the i-th coordinate axis by using the target context model, so as to improve the accuracy of predictive encoding of the planar position information of the current node.

In the embodiments of the present disclosure, for each of the N neighborhood nodes, the specific process of determining the planar structure information of the neighborhood node based on the occupancy information of the neighborhood node is consistent. For the sake of ease of description, any one neighborhood node among the N neighborhood nodes is taken as an example for explanation.

In some embodiments, the S203-A1-a1 includes the following step S203-A1-a11.

In S203-A1-a11: for any one neighborhood node among the N neighborhood nodes, at least one of the planar flag information or the planar position information of the neighborhood node is determined based on the occupancy information of the neighborhood node.

In the embodiments of the present disclosure, the encoding side may determine the planar flag information and/or the planar position information of the neighborhood node based on the occupancy information of the neighborhood node.

The specific process of determining the planar flag information of the neighborhood node based on the occupancy information of the neighborhood node is introduced below.

Exemplarily, the encoding side determines plane0 and plane1 corresponding to the i-th coordinate axis based on the occupancy information of the neighborhood node, and then determines the planar flag information corresponding to the neighborhood node in the i-th coordinate axis based on plane0 and plane1.

Based on the above method, the encoding side may determine plane0 and plane1 corresponding to the neighborhood node in the i-th coordinate axis, and then determine the planar flag information corresponding to the neighborhood node in the i-th coordinate axis based on plane0 and plane1.

The specific process of determining the planar position information of the neighborhood node is introduced below.

In the embodiments of the present disclosure, based on the above method, the encoding side may determine the planar flag information planarMode of the neighborhood node, and then determine the planar position information of the neighborhood node based on the planar flag information planarMode.

For example, the encoding side determines the planar position information of the neighborhood node on the i-th axis based on the above equation (25).

The specific process of determining the planar flag information and the planar position information of the neighborhood node in the X-coordinate axis is introduced above. The specific process of determining the planar flag information and the planar position information of the neighborhood node in the Y-coordinate axis and the Z-coordinate axis can refer to the above process of determining the planar flag information and the planar position information of the neighborhood node in the X-coordinate axis, which will not be repeated here.

Based on the above steps, the encoding side determines the planar flag information and/or the planar position information of each of the N neighborhood nodes, and then performs predictive encoding on the planar position information of the current node based on the planar flag information and/or the planar position information of each of the N neighborhood nodes.

In the embodiments of the present disclosure, the operation that the first context information and/or the second context information corresponding to the i-th coordinate axis are determined based on the planar structure information of N neighborhood nodes in the above S203-A1-a2 is described.

The specific process for the encoding side to determine the first context information corresponding to the i-th coordinate axis based on the planar structure information of the N neighborhood nodes is introduced below.

It is to be noted that, in the embodiments of the present disclosure, the specific manner in which the encoding side determines the first context information corresponding to the i-th coordinate axis based on the planar structure information of the N neighborhood nodes includes, but is not limited to, the following.

Manner I: the encoding side determines the first context information corresponding to the i-th coordinate axis based on planar structure information of part of the N neighborhood nodes.

In a possible implementation, for any one neighborhood node among the P neighborhood nodes, the encoding side performs AND operation on planar structure information of the neighborhood node and a first preset value corresponding to the i-th coordinate axis to obtain a first value corresponding to the neighborhood node, and then performs weighting operation on first values corresponding to the P neighborhood nodes to obtain the first context information corresponding to the i-th coordinate axis. It is to be noted that different coordinate axes correspond to different first preset values, and the specific value of the respective first preset value corresponding to each coordinate axis is not limited in the embodiments of the present disclosure.

The specific manner in which weighting operation is performed on the first values corresponding to the P neighborhood nodes to obtain the first context information corresponding to the i-th coordinate axis is not limited in the embodiments of the present disclosure.

In some embodiments, weights of the first values corresponding to the P neighborhood nodes are preset values, so that weighting operation is performed on the first values corresponding to the P neighborhood nodes based on the weight of the first value corresponding to each of the P neighborhood nodes to obtain the first context information corresponding to the i-th coordinate axis.

In some embodiments, the operation that weighting operation is performed on the first values corresponding to the P neighborhood nodes to obtain the first context information corresponding to the i-th coordinate axis includes the following steps A1 and A2.

In step A1: a left-shift bit count corresponding to the first value is determined, and a weighted weight corresponding to the first value is determined based on the left-shift bit count.

In step A2: weighting operation is performed on the first values corresponding to the P neighborhood nodes based on the weighted weights of the first values to obtain the first context information corresponding to the i-th coordinate axis.

In this way, the respective weighted weight corresponding to each first value may be determined based on the respective left-shift bit count corresponding to each first value. For example, when the left-shift bit count corresponding to the first value is m, 2^{m} is determined as the weighted weight corresponding to the first value. In this way, it may be determined that the weighted weight corresponding to the first value 1 is 2⁵, the weighted weight corresponding to the first value 2 is 2⁴, the weighted weight corresponding to the first value 3 is 2³, the weighted weight corresponding to the first value 4 is 2², the weighted weight corresponding to the first value 5 is 2¹, and the weighted weight corresponding to the first value 6 is 2⁰.

Then, weighting operation is performed on each first value based on the weighted weight of each first value to obtain the first context information corresponding to the i-th coordinate axis. It is to be understood that the above operation of performing weighting operation on each first value may be understood as performing splicing on each first value, that is, each first value is placed on the corresponding bit position to obtain the first context information corresponding to the i-th coordinate axis.

The specific process for the encoding side to determine the first context information corresponding to the i-th coordinate axis based on the planar structure information of the P neighborhood nodes sharing a face with the current node among the N neighborhood nodes is introduced above.

In some embodiments, the encoding side may further determine the first context information corresponding to the i-th coordinate axis based on planar structure information of neighborhood node(s) sharing an edge with the current node among the N neighborhood nodes.

In some embodiments, the encoding side may further determine the first context information corresponding to the i-th coordinate axis based on planar structure information of the neighborhood node(s) sharing a vertex with the current node among the N neighborhood nodes.

In some embodiments, the encoding side may further determine the first context information corresponding to the i-th coordinate axis based on planar structure information of at least one neighborhood node sharing a face or sharing an edge with the current node among the N neighborhood nodes.

In some embodiments, the encoding side may further determine the first context information corresponding to the i-th coordinate axis based on planar structure information of at least one neighborhood node sharing a face or sharing a vertex with the current node among the N neighborhood nodes.

In some embodiments, the encoding side may further determine the first context information corresponding to the i-th coordinate axis based on the planar structure information of at least one neighborhood node sharing an edge or sharing a vertex with the current node among the N neighborhood nodes.

The specific process for the encoding side to determine the first context information corresponding to the i-th coordinate axis based on the planar structure information of part of the N neighborhood nodes is introduced above.

Manner II: the encoding side determines the first context information corresponding to the i-th coordinate axis based on first planar structure information of the N neighborhood nodes.

The first planar structure information includes planar flag information and/or planar position information of the neighborhood nodes. That is, the encoding side determines the first context information corresponding to the i-th coordinate axis based on the planar flag information of the N neighborhood nodes. Alternatively, the encoding side determines the first context information corresponding to the i-th coordinate axis based on the planar position information of the N neighborhood nodes. Alternatively, the encoding side determines the first context information corresponding to the i-th coordinate axis based on the planar position information and the planar flag information of the N neighborhood nodes.

The specific manner in which the encoding side determines the first context information corresponding to the i-th coordinate axis based on the first planar structure information of the N neighborhood nodes is not limited in the embodiments of the present disclosure.

In a possible implementation, for any one neighborhood node among the N neighborhood nodes, the encoding side performs AND operation on first planar structure information of the neighborhood node and a first preset value corresponding to the i-th coordinate axis to obtain a second value corresponding to the neighborhood node, and then performs weighting operation on second values corresponding to the N neighborhood nodes to obtain the first context information corresponding to the i-th coordinate axis. It is to be noted that different coordinate axes correspond to different first preset values, and the specific value of the respective first preset value corresponding to each coordinate axis is not limited in the embodiments of the present disclosure.

For example, the first preset value corresponding to the X-coordinate axis is 0, the first preset value corresponding to the Y-coordinate axis is 1, and the first preset value corresponding to the Z-coordinate axis is 2.

As can be seen from the above, the planar structure information of the neighborhood node includes planar flag information and/or planar position information, and therefore, in some embodiments, the above operation that the encoding side performs AND operation on the first planar structure information of the neighborhood node and the first preset value corresponding to the i-th coordinate axis to obtain the second value corresponding to the neighborhood node includes: performing, by the encoding side, AND operation on the planar flag information and/or the planar position information of the neighborhood node and the first preset value corresponding to the i-th coordinate axis to obtain the first value corresponding to the neighborhood node. That is, the encoding side performs AND operation on the planar flag information of the N neighborhood nodes and the first preset value corresponding to the i-th coordinate axis and then performs weighting operation on the result, to obtain the first context information corresponding to the i-th coordinate axis. Alternatively, the encoding side performs AND operation on the planar position information of the N neighborhood nodes and the first preset value corresponding to the i-th coordinate axis and then performs weighting operation on the result, to obtain the first context information corresponding to the i-th coordinate axis. Alternatively, the encoding side performs AND operation on the planar flag information and the planar position information of the N neighborhood nodes and the first preset value corresponding to the i-th coordinate axis and then performs weighting operation on the result, to obtain the first context information corresponding to the i-th coordinate axis.

The specific manner in which weighting operation is performed on the second values corresponding to the N neighborhood nodes to obtain the first context information corresponding to the i-th coordinate axis is not limited in the embodiments of the present disclosure.

In some embodiments, weights of the second values corresponding to the N neighborhood nodes are preset values, so that weighting operation is performed on the second values corresponding to the N neighborhood nodes based on the weight of the second value corresponding to each of the N neighborhood nodes to obtain the first context information corresponding to the i-th coordinate axis.

In some embodiments, the above operation that weighting operation is performed on the second values corresponding to the N neighborhood nodes to obtain the first context information corresponding to the i-th coordinate axis includes the following steps B1 and B2.

In step B1: a left-shift bit count corresponding to the second value is determined, and a weighted weight corresponding to the second value is determined based on the left-shift bit count.

In step B2: weighting operation is performed on the second values corresponding to the N neighborhood nodes based on the weighted weights of the second values to obtain the first context information corresponding to the i-th coordinate axis.

The specific process for the encoding side to determine the first context information corresponding to the i-th coordinate axis based on the planar structure information of the N neighborhood nodes is introduced above. It is to be noted that, in addition to determining the first context information corresponding to the i-th coordinate axis based on the above manners, the encoding side may also adopt other manners to determine the first context information corresponding to the i-th coordinate axis.

The specific process of determining the second context information corresponding to the i-th coordinate axis based on the planar structure information of the N neighborhood nodes in S203-A1-a2 is introduced below.

It is to be noted that, in the embodiments of the present disclosure, the specific manner in which the encoding side determines the second context information corresponding to the i-th coordinate axis based on the planar structure information of the N neighborhood nodes includes, but is not limited to, the following.

Manner I: the encoding side determines the second context information corresponding to the i-th coordinate axis based on planar structure information of part of the N neighborhood nodes.

For example, the encoding side determines the second context information corresponding to the i-th coordinate axis based on planar structure information of Q neighborhood nodes sharing an edge and/or sharing a vertex with the current node among the N neighborhood nodes, Q being a positive integer.

The planar structure information of the Q neighborhood nodes includes planar flag information and/or planar position information of the Q neighborhood nodes. That is, the encoding side determines the second context information corresponding to the i-th coordinate axis based on the planar flag information of the Q neighborhood nodes. Alternatively, the encoding side determines the second context information corresponding to the i-th coordinate axis based on the planar position information of the Q neighborhood nodes. Alternatively, the encoding side determines the second context information corresponding to the i-th coordinate axis based on the planar flag information and the planar position information of the Q neighborhood nodes.

The specific manner in which the encoding side determines the second context information corresponding to the i-th coordinate axis based on the planar structure information of the Q neighborhood nodes sharing an edge and/or sharing a vertex with the current node among the N neighborhood nodes is not limited in the embodiments of the present disclosure.

In a possible implementation, for any one neighborhood node among the Q neighborhood nodes, the encoding side performs AND operation on planar structure information of the neighborhood node and a first preset value corresponding to the i-th coordinate axis to obtain a first value corresponding to the neighborhood node, and then performs weighting operation on first values corresponding to the Q neighborhood nodes to obtain the second context information corresponding to the i-th coordinate axis. It is to be noted that different coordinate axes correspond to different first preset values, and the specific value of the respective first preset value corresponding to each coordinate axis is not limited in the embodiments of the present disclosure.

As can be seen from the above, the planar structure information of the neighborhood node includes the planar flag information and/or the planar position information, and therefore, in some embodiments, the above operation that encoding side performs AND operation on the planar structure information of the neighborhood node and the first preset value corresponding to the i-th coordinate axis to obtain the first value corresponding to the neighborhood node includes: performing, by the encoding side, AND operation on planar flag information and/or planar position information of the neighborhood node and the first preset value corresponding to the i-th coordinate axis to obtain the first value corresponding to the neighborhood node. That is, the encoding side performs AND operation on the planar flag information of the Q neighborhood nodes and the first preset value corresponding to the i-th coordinate axis and then performs weighting operation on the result, to obtain the second context information corresponding to the i-th coordinate axis. Alternatively, the encoding side performs AND operation on the planar position information of the Q neighborhood nodes and the first preset value corresponding to the i-th coordinate axis and then performs weighting operation on the result, to obtain the second context information corresponding to the i-th coordinate axis. Alternatively, the encoding side performs AND operation on the planar flag information and the planar position information of the Q neighborhood nodes and the first preset value corresponding to the i-th coordinate axis and then performs weighting operation on the result, to obtain the second context information corresponding to the i-th coordinate axis.

The specific manner in which weighting operation is performed on the first values corresponding to the Q neighborhood nodes to obtain the second context information corresponding to the i-th coordinate axis is not limited in the embodiments of the present disclosure.

In some embodiments, weights of the first values corresponding to the Q neighborhood nodes are preset values, so that weighting operation is performed on the first values corresponding to the Q neighborhood nodes based on the weight of the first value corresponding to each of the Q neighborhood nodes to obtain the second context information corresponding to the i-th coordinate axis.

In some embodiments, the operation that weighting operation is performed on the first values corresponding to the Q neighborhood nodes to obtain the second context information corresponding to the i-th coordinate axis includes the following steps C1 and C2.

In step C1: a left-shift bit count corresponding to the first value is determined, and a weighted weight corresponding to the first value is determined based on the left-shift bit count.

In step C2: weighting operation is performed on the first values corresponding to the Q neighborhood nodes based on the weighted weights of the first values to obtain the second context information corresponding to the i-th coordinate axis.

The specific process for the encoding side to determine the second context information corresponding to the i-th coordinate axis based on the planar structure information of the Q neighborhood nodes sharing an edge and/or sharing a vertex with the current node among the N neighborhood nodes is introduced above.

In some embodiments, the encoding side may further determine the second context information corresponding to the i-th coordinate axis based on planar structure information of at least one neighborhood node sharing an edge with the current node among the N neighborhood nodes.

In some embodiments, the encoding side may further determine the second context information corresponding to the i-th coordinate axis based on planar structure information of at least one neighborhood node sharing a vertex with the current node among the N neighborhood nodes.

In some embodiments, the encoding side may further determine the second context information corresponding to the i-th coordinate axis based on planar structure information of at least one neighborhood node sharing a face with the current node among the N neighborhood nodes.

In some embodiments, the encoding side may further determine the second context information corresponding to the i-th coordinate axis based on planar structure information of at least one neighborhood node sharing a face or sharing an edge with the current node among the N neighborhood nodes.

In some embodiments, the encoding side may further determine the second context information corresponding to the i-th coordinate axis based on planar structure information of at least one neighborhood node sharing a face or sharing a vertex with the current node among the N neighborhood nodes.

The specific process for the encoding side to determine the second context information corresponding to the i-th coordinate axis based on the planar structure information of part of the N neighborhood nodes is introduced above.

Manner II: the encoding side determines the second context information corresponding to the i-th coordinate axis based on second planar structure information of the N neighborhood nodes.

The second planar structure information includes planar flag information and/or planar position information of the neighborhood nodes. That is, the encoding side determines the second context information corresponding to the i-th coordinate axis based on the planar flag information of the N neighborhood nodes. Alternatively, the encoding side determines the second context information corresponding to the i-th coordinate axis based on the planar position information of the N neighborhood nodes. Alternatively, the encoding side determines the second context information corresponding to the i-th coordinate axis based on the planar position information and the planar flag information of the N neighborhood nodes.

The specific manner in which the encoding side determines the second context information corresponding to the i-th coordinate axis based on the first planar structure information of the N neighborhood nodes is not limited in the embodiments of the present disclosure.

In a possible implementation, for any one neighborhood node among the N neighborhood nodes, the encoding side performs AND operation on second planar structure information of the neighborhood node and a first preset value corresponding to the i-th coordinate axis to obtain a third value corresponding to the neighborhood node, and then performs weighting on third values corresponding to the N neighborhood nodes to obtain the second context information corresponding to the i-th coordinate axis. It is to be noted that different coordinate axes correspond to different first preset values, and the specific value of the respective first preset value corresponding to each coordinate axis is not limited in the embodiments of the present disclosure.

As can be seen from the above, the planar structure information of the neighborhood node includes planar flag information and/or planar position information, and therefore, in some embodiments, the above operation that the encoding side performs AND operation on the second planar structure information of the neighborhood node and the first preset value corresponding to the i-th coordinate axis to obtain the third value corresponding to the neighborhood node includes: performing, by the encoding side, AND operation on the planar flag information and/or the planar position information of the neighborhood node and the first preset value corresponding to the i-th coordinate axis to obtain the third value corresponding to the neighborhood node. That is, the encoding side performs AND operation on the planar flag information of the N neighborhood nodes and the first preset value corresponding to the i-th coordinate axis and then performs weighting operation on the result, to obtain the second context information corresponding to the i-th coordinate axis. Alternatively, the encoding side performs AND operation on the planar position information of the N neighborhood nodes and the first preset value corresponding to the i-th coordinate axis and then performs weighting operation on the result, to obtain the second context information corresponding to the i-th coordinate axis. Alternatively, the encoding side performs AND operation on the planar flag information and the planar position information of the N neighborhood nodes and the first preset value corresponding to the i-th coordinate axis and then performs weighting operation on the result, to obtain the second context information corresponding to the i-th coordinate axis.

The specific manner in which weighting operation is performed on the third values corresponding to the N neighborhood nodes to obtain the second context information corresponding to the i-th coordinate axis is not limited in the embodiments of the present disclosure.

In some embodiments, weights of the third values corresponding to the N neighborhood nodes are preset values, so that weighting operation is performed on the third values corresponding to the N neighborhood nodes based on the weight of the third value corresponding to each of the N neighborhood nodes to obtain the second context information corresponding to the i-th coordinate axis.

In some embodiments, the above operation that weighting operation is performed on the third values corresponding to the N neighborhood nodes to obtain the second context information corresponding to the i-th coordinate axis includes the following steps D1 and D2.

In step D1: a left-shift bit count corresponding to the third value is determined, and a weighted weight corresponding to the third value is determined based on the left-shift bit count.

In step D2: weighting operation is performed on the third values corresponding to the N neighborhood nodes based on the weighted weights of the third values to obtain the second context information corresponding to the i-th coordinate axis.

The specific process for the encoding side to determine the second context information corresponding to the i-th coordinate axis based on the planar structure information of the N neighborhood nodes is introduced above. It is to be noted that, in addition to determining the second context information corresponding to the i-th coordinate axis based on the above manners, the encoding side may also adopt other manners to determine the second context information corresponding to the i-th coordinate axis.

It is to be noted that the first context information corresponding to the i-th coordinate axis obtained by the encoding side is different from the second context information corresponding to the i-th coordinate axis obtained by the decoding side, that is, the manner used by the encoding side to determine the first context information corresponding to the i-th coordinate axis is different from the manner used by the decoding side to determine the second context information corresponding to the i-th coordinate axis, and thus, the obtained first context information is different from the obtained second context information.

In Case I where the N neighborhood nodes are the first-type neighborhood nodes, the specific processes for the encoding side to determine the planar structure information of the N neighborhood nodes based on the occupancy information of the N neighborhood nodes and determine the first context information and/or the second context information corresponding to the i-th coordinate axis based on the planar structure information of the N neighborhood nodes are introduced above.

Case II: in response to the N neighborhood nodes being the second-type neighborhood nodes, then the S203-A1 includes the following steps.

In S203-A1-b: the first context information and/or the second context information corresponding to the i-th coordinate axis are determined based on the occupancy information of the N neighborhood nodes, where occupancy information of a neighborhood node indicates whether the neighborhood node is occupied.

As can be seen from the above, the geometry information of the second-type neighborhood node has not been encoded, therefore, the occupancy information of the second-type neighborhood node indicates whether the second-type neighborhood node is occupied, and the occupancy information of the second-type neighborhood node is 1-bit. Based on this, in Case II, in response to the N neighborhood nodes of the current node being the second-type neighborhood nodes, the first context information and/or the second context information corresponding to the i-th coordinate axis are determined directly based on the occupancy information of the N neighborhood nodes.

The specific manner for determining the first context information and/or the second context information corresponding to the i-th coordinate axis based on the occupancy information of the N neighborhood nodes is not limited in the embodiments of the present disclosure.

In some embodiments, the first context information corresponding to the i-th coordinate axis is determined based on occupancy information of at least one neighborhood node sharing a face with the current node among the N neighborhood nodes.

In some embodiments, the second context information corresponding to the i-th coordinate axis is determined based on occupancy information of at least one neighborhood node sharing an edge with the current node among the N neighborhood nodes.

In some embodiments, the first context information corresponding to the i-th coordinate axis is determined based on occupancy information of at least one neighborhood node sharing a face with the current node and occupancy information of at least one neighborhood node sharing an edge with the current node among the N neighborhood nodes.

In some embodiments, the second context information corresponding to the i-th coordinate axis is determined based on the occupancy information of at least one neighborhood node sharing a face with the current node and the occupancy information of at least one neighborhood node sharing an edge with the current node among the N neighborhood nodes.

After determining the first context information and/or the second context information corresponding to the i-th coordinate axis based on the types and the occupancy information of the N neighborhood nodes through the manners described in above Case I and Case II, the encoding side performs the step S203-A2, that is, predictive encoding is performed on the planar position information of the current node in the i-th coordinate axis based on the first context information and/or the second context information corresponding to the i-th coordinate axis.

The specific manner for performing predictive encoding on the planar position information of the current node in the i-th coordinate axis based on the first context information and/or the second context information corresponding to the i-th coordinate axis in S203-A2 is not limited in the embodiments of the present disclosure.

In some embodiments, the encoding side performs predictive encoding on the planar position information of the current node in the i-th coordinate axis only based on the first context information and/or the second context information corresponding to the i-th coordinate axis. For example, the encoding side determines a context model index based on the first context information and/or the second context information corresponding to the i-th coordinate axis, selects a context model from multiple preset context models based on the context model index, and then performs predictive encoding on the planar position information of the current node in the i-th coordinate axis using the context model.

In some embodiments, the S203-A2 includes the following steps S203-A21 and S203-A22.

In S203-A21: a target context model is determined based on the first context information and/or the second context information corresponding to the i-th coordinate axis and preset context information.

In S203-A22: predictive encoding is performed on the planar position information of the current node in the i-th coordinate axis based on the target context model.

In the present embodiment, when the encoding side performs predictive encoding on the planar position information of the current node in the i-th coordinate axis, the reference context information includes other preset context information in addition to the first context information and/or the second context information corresponding to the i-th coordinate axis.

The specific content of the preset context information is not limited in the embodiments of the present disclosure, which may be determined according to actual needs.

In a possible implementation, the preset context information includes at least one of: third context information, fourth context information, fifth context information or sixth context information; where the third context information is that the planar position information of the current node is obtained as three elements by performing prediction using occupancy information of the neighborhood nodes: predicted as a low plane, predicted as a high plane, or unpredictable; the fourth context information is that a spatial distance between a node at a same partition depth and a same coordinate as the current node and the current node is “near” or “far”; the fifth context information is a planar position of a node at the same partition depth and the same coordinate as the current node if the node is a plane; and the sixth context information is coordinate dimension (i=0, 1, 2).

In the present embodiment, when performing predictive encoding on the planar position information of the current node in the i-th coordinate axis, the encoding side determines the first context information and/or the second context information corresponding to the i-th coordinate axis and then performs predictive encoding on the planar position information of the current node in the i-th coordinate axis based on the first context information and/or the second context information corresponding to the i-th coordinate axis and the preset context information, based on the above steps. As can be seen, in the embodiments of the present disclosure, when performing predictive encoding on the planar position information of the current node, the encoding side not only considers preset prior information (i.e., the preset context information), but also the planar structure information of the neighborhood nodes (i.e., the first context information and/or the second context information), so that the predictive encoding effect of the planar position information of the current node is improved and the encoding efficiency of the point cloud is improved.

In the present embodiment, the encoding side determines a context model based on the first context information and/or the second context information corresponding to the i-th coordinate axis and the preset context information, and for the sake of ease of description, the context model is recorded as a target context model. Next, predictive encoding is performed on the planar position information of the current node in the i-th coordinate axis using the target context model.

The specific process for the encoding side to determine the target context model based on the first context information and/or the second context information corresponding to the i-th coordinate axis and the preset context information is introduced below.

In some embodiments, the encoding side determines an index of a target context model based on the first context information and/or the second context information corresponding to the i-th coordinate axis and the preset context information, selects a target context model from multiple preset context models based on the index of the target context model, and then performs predictive encoding on the planar position information of the current node in the i-th coordinate axis using the target context model.

In some embodiments, the S202-B21 includes the following steps S202-B211 and S202-B21.

In S202-B211: the first context information and/or the second context information corresponding to the i-th coordinate axis and the preset context information are classified into primary information and minor information based on the types of the N neighborhood nodes.

In S202-B212: the target context model is determined based on the primary information of the current node and part or all of the minor information of the current node.

As can be seen from the above, assuming that the context information of the planar position information includes the first context information and the second context information corresponding to the i-th coordinate axis and the above four preset context information, the final contexts of the planar position are as follows:
1) the planar position information of the current node being obtained as three elements by performing prediction using the occupancy information of the neighborhood nodes: predicted as a low plane, predicted as a high plane or unpredictable;
2) the spatial distance between the node at the same partition depth and the same coordinates as the current node and the current node being “close” or “far”;
3) the planar position of the node at the same partition depth and the same coordinate as the current node if the node is a plane;
4) coordinate dimension (i=0, 1, 2);
5) Ctx1: the planar structure information of three co-planar neighborhood nodes; and
6) Ctx2: the planar structure information of three co-edge neighborhood nodes and one co-vertex neighborhood node.

The specific manner for classifying the first context information and/or the second context information corresponding to the i-th coordinate axis and the preset context information into the primary information and the minor information based on the types of N neighborhood nodes is not limited in the embodiments of the present disclosure.

Manner 1: in response to the N neighborhood nodes being the first-type neighborhood nodes, the encoding side determines at least one of the fourth context information, the fifth context information or the first context information as the primary information, and determines at least one of the third context information or the second context information as the minor information.

For example, the primary information includes:
the spatial distance between the node at the same partition depth and the same coordinate as the current node and the current node being “near” or “far”;
the planar position of the node at the same partition depth and the same coordinate as the current node if the node is a plane; and
the first context information corresponding to the i-th coordinate axis, for example, the first context information corresponding to the i-th coordinate axis includes occupancy information of three second-type neighborhood nodes sharing a face with the current node.

The minor information includes:
the planar position information of the current node being obtained as three elements by performing prediction using the occupancy information of the neighborhood nodes: predicted as a low plane, predicted as a high plane, or unpredictable; and
the second context information corresponding to the i-th coordinate axis, for example, the second context information corresponding to the i-th coordinate axis includes occupancy information of nine second-type neighborhood nodes sharing an edge with the current node.

Manner 2: in response to the N neighborhood nodes being the second-type neighborhood nodes, at least one of the third context information, the fourth context information, the fifth context information or the first context information is determined as the primary information, and the second context information is determined as the minor information.

For example, the primary information includes:
the planar position information of the current node being obtained as three elements by performing prediction using the occupancy information of the neighborhood nodes: predicted as a low plane, predicted as a high plane or unpredictable;
the spatial distance between the node at the same partition depth and the same coordinate as the current node and the current node being “near” or “far”;
the planar position of the node at the same partition depth and the same coordinate as the current node if the node is a plane; and
the first context information corresponding to the i-th coordinate axis, for example, the first context information corresponding to the i-th coordinate axis includes occupancy information of three second-type neighborhood nodes sharing a face with the current node.

The minor information includes:
the second context information corresponding to the i-th coordinate axis, for example, the second context information corresponding to the i-th coordinate axis includes occupancy information of nine second-type neighborhood nodes sharing an edge with the current node.

It is to be noted that in the embodiment of the present disclosure, the method in which the encoding side classifies the first context information and/or the second context information corresponding to the i-th coordinate axis and the preset context information into the primary information and the minor information based on the types of the N neighborhood nodes may include other methods in addition to the above methods of Manner 1 and Manner 2, and the embodiments of the present disclosure do not limit this.

Based on the above steps, after classifying the first context information and/or the second context information corresponding to the i-th coordinate axis and the preset context information into the primary information and the minor information based on the types of N neighborhood nodes, the encoding side performs the step S202-B212, that is, the target context model is determined based on the primary information of the current node and part or all of the minor information of the current node.

The specific manner in which the encoding side determines the target context model based on the primary information of the current node and part or all of the minor information of the current node is not limited in the embodiments of the present disclosure.

In some embodiments, the encoding side determines an index based on the primary information of the current node and part of the minor information of the current node, determines the index of the target context model based on the index, and then determines the target context model from the multiple preset context models based on the index of the target context model.

In some embodiments, the S202-B212 includes the following steps S202-B2121 to S202-B2124.

In S202-B2121: the primary information of the current node and the minor information of the current node are converted into binary representation.

In S202-B2122: a right-shift bit count of minor information corresponding to the current node is determined, and first minor information is selected from minor information after binary representation of the current node based on the right-shift bit count of minor information corresponding to the current node, where an initial value of the right-shift bit count of minor information is a total number of bits of the minor information after binary representation.

In S202-B2123: a first index is determined based on primary information after binary representation of the current node and the first minor information, and an index of the target context model is obtained from a preset context model index buffer based on the first index.

In S202-B2124: the target context model is obtained based on the index of the target context model.

In the present embodiment, based on the above steps, the encoding side classifies the first context information and/or the second context information corresponding to the i-th coordinate axis and the preset context information into the primary information and the minor information; and then, the encoding side converts the primary information and the minor information of the current node obtained by classifying into binary representation.

For example, referring to the above example, it is assumed that the encoding side classifies the first context information corresponding to the i-th coordinate axis, the spatial distance between the node at the same partition depth and the same coordinate as the current node and the current node being “near” or “far”, and the planar position of the node at the same partition depth and the same coordinate as the current node if the node is a plane into the primary information. Assuming that the first context information Ctx1 corresponding to the i-th coordinate axis includes 2⁶=64 contexts, and requires 6 bits to represent when converted into binary representation; the spatial distance between the node at the same partition depth and the same coordinate as the current node and the current node being “near” or “far” includes two contexts and requires 1 bit to represent when converted to binary representation; and the planar position of the node at the same partition depth and the same coordinate as the current node includes 2 contexts and requires 1 bit to represent when converted to binary representation, therefore, in such example, when the primary information of the current node is converted into binary representation, 6+1+1=8 bits are required for representation.

Similarly, it is assumed that the encoding side classifies the second context information corresponding to the i-th coordinate axis and the planar position information of the current node being obtained as three elements (predicted as a low plane, predicted as a high plane or unpredictable) by performing prediction using the occupancy information of the neighborhood nodes into the minor information. Assuming that the second context information Ctx2 corresponding to the i-th coordinate axis includes 2⁸=256 contexts and requires 8 bits to represent when converted into binary representation; and the context information being that the planar position information of the current node is obtained as three elements (predicted as a low plane, predicted as a high plane or unpredictable) by performing prediction using the occupancy information of the neighborhood nodes includes three contexts and requires 2 bits to represent when converted to binary representation, therefore, in such example, when the minor information of the current node is converted into binary representation, 8+2=10 bits are required for representation.

The specific process for converting the primary information of the current node and the minor information of the current node into binary representation is introduced in the form of examples above. It is to be noted that the classifying manner of the primary information of the current node and the minor information of the current node includes, but is not limited to, the above examples. When the primary information of the current node and the minor information of the current node further include other context information, the primary information of the current node and the minor information of the current node may be converted into binary representation by referring to the method described in the above examples.

After converting the primary information of the current node and the minor information of the current node into binary representation, the encoding side determines the right-shift bit count of minor information corresponding to the current node, and then selects the first minor information from the minor information after binary representation of the current node based on the right-shift bit count of minor information. In the embodiments of the present disclosure, the right-shift bit count of minor information corresponding to the current node may be understood as that which is used to select which minor information from the minor information of the current node to perform predictive encoding on the planar position information of the current node.

The operation of determining the right-shift bit count of minor information corresponding to the current node is introduced below.

The specific manner for determining the right-shift bit count of minor information corresponding to the current node is not limited in the embodiments of the present disclosure.

In some embodiments, the right-shift bit count of minor information corresponding to the current node is a preset value. For example, for nodes in the point cloud octree, a preset number of nodes correspond to one right-shift bit count of minor information, so that the right-shift bit count of minor information corresponding to the current node may be determined. For example, the closer the node is to the root node of the octree, the larger the right-shift bit count of minor information corresponding to the node. Optionally, an initial value of the right-shift bit count of minor information is a total number of bits of the minor information after binary representation. For example, if the current node is the root node of the octree, the right-shift bit count of minor information corresponding to the current node is 10 bits.

In some embodiments, the operation that the right-shift bit count of minor information corresponding to the current node is determined in the S202-B2122 includes the following steps S202-B21221 and S202-B21222.

In S202-B21221: a right-shift bit count of minor information corresponding to a last level of a current minor information partitioning tree is determined, where the minor information partitioning tree is obtained by performing binary tree partitioning on the minor information starting from a highest bit of minor information.

In S202-B21222: the right-shift bit count of minor information corresponding to the last level is determined as the right-shift bit count of minor information corresponding to the current node.

The process for partitioning the minor information is introduced below.

Exemplarily, when the encoding side encodes the current point cloud, in the entire Dynamic-OUBF initialization process, assuming that the integer representation of the primary information is ct1 and the integer representation of the minor information is ct2, a context model index buffer ContextBuffer is initialized, and the size of ContextBuffer is ct1×ct2. For example, referring to the above example, assuming that the primary information includes 8 bits and the minor information includes 10 bits, the context model index buffer ContextBuffer having a size of 8×10 may be determined, and 8×10 context model indexes are stored in the context model index buffer ContextBuffer. In addition, the context initial probability of each state is set to 127 (i.e., 0.5).

In some embodiments, the process of minor information precision recovery is illustrated in FIG. 15. First, the context of the entire minor information is represented in a binary format, and secondly, binary tree partitioning is performed on the minor information from a highest bit. As illustrated in FIG. 15, above a certain level, there is a non-full binary tree, that is, partitioning is performed according to the situation of the minor information itself, but when it is below MinDepth (currently set to 3), the precision of the minor information will be fully recovered. The partitioning of the minor information is introduced below in detail.

For example, a countBuffer counter is initialized having a size of ct1×(ct2 MinDepth) and initialized to 0.

In addition, a KDown is initialized to represent the precision (i.e., the right-shift bit count) of the minor information corresponding to each first state (index), the initial value of the right-shift bit count of minor information is a total number of bits of the minor information after binary representation, that is, the highest precision of the minor information. For example, when the minor information is 10 bits, the initial value of the right-shift bit count of minor information is 10 bits.

Further, a table of CountTimeTh is initialized to control the highest number of occurrences of the first state of each level of the minor information partitioning tree. When the number of occurrences of a certain first state exceeds the limit of this level, the low-bit precision of the minor information will be recovered, and the number of occurrences of the current first state will be reset to zero, the context probability of the recovered new first state inherits the probability of its parent node.

Exemplarily, as illustrated in FIG. 15, for the first node 1 in the point cloud, when predictive encoding is performed on the planar position information of node 1, firstly, the first context information and/or the second context information corresponding to node 1 are determined based on the above steps, and the first context information and/or the second context information corresponding to node 1 and the preset context information are classified into the primary information and the minor information, for example, classified into 8-bit primary information and 10-bit minor information. Next, the right-shift bit count of minor information corresponding to node 1 is obtained from KDown. Since node 1 is the first point of the point cloud, the right-shift bit count of minor information corresponding to node 1 is the initial value of the right-shift bit count of minor information, for example, 10 bits. In this way, when the encoding side determines that the right-shift bit count of minor information corresponding to node 1 is 10 bits, the minor information of node 1 is shifted to right by 10 bits. Since the minor information of node 1 is 10 bits in total, after shifting to right, the obtained first minor information of node 1 is 0 bit. Next, the encoding side determines the first state 1 based on the primary information after binary representation of node 1 and the first minor information, obtains the index of the target context model corresponding to node 1 from the context model index buffer ContextBuffer based on the first state 1, then obtains the target context model corresponding to node 1 based on the index of the target context model corresponding to the node 1, and finally performs predictive encoding on the planar position information of node 1 in the i-th coordinate axis using the target context model corresponding to the node. Meanwhile, the number of times of the first state 1 in countBuffer is increased by 1, and the number of times of the first state 1 in countBuffer is compared with the first preset threshold corresponding to the first level of the minor information partitioning tree stored in CountTimeTh. When the number of times of the first state 1 in countBuffer is less than the first preset threshold corresponding to the first level of the minor information partitioning tree stored in CountTimeTh, partitioning is not performed on the minor information partitioning tree.

Next, for node 2 in the point cloud, when predictive encoding is performed on the planar position information of node 2, firstly, the first context information and/or the second context information corresponding to node 2 are determined based on the above steps, and the first context information and/or the second context information corresponding to node 2 and the preset context information are classified into the primary information and the minor information, for example, classified into 8-bit primary information and 10-bit minor information. Next, the right-shift bit count of minor information corresponding to node 2 is obtained from KDown. Since the minor information partitioning tree is not partitioned, the right-shift bit count of minor information corresponding to node 2 is the same as that corresponding to node 1, and is the initial value of the right-shift bit count of minor information, for example, 10 bits. In this way, when the encoding side determines that the right-shift bit count of minor information corresponding to node 2 is 10 bits, the minor information of node 2 is shifted to right by 10 bits. Since the minor information of the node 2 is 10 bits in total, after right shifting, the obtained first minor information of node 2 is 0 bit. Next, the encoding side determines the first state 2 based on the primary information after binary representation of node 2 and the first minor information, obtains the index of the target context model corresponding to node 2 from the context model index buffer ContextBuffer based on the first state 2, then obtains the target context model corresponding to node 2 based on the index of the target context model corresponding to node 2, and finally performs predictive encoding on the planar position information of node 2 in the i-th coordinate axis using the target context model corresponding to the node. Meanwhile, the number of times of the first state 2 in countBuffer is increased by 1, and the number of times of the first state 2 in countBuffer is compared with the first preset threshold corresponding to the first level of the minor information partitioning tree stored in CountTimeTh. When the number of times of the first state 2 in countBuffer is less than the first preset threshold corresponding to the first level of the minor information partitioning tree stored in CountTimeTh, partitioning is not performed on the minor information partitioning tree.

It is assumed that the first state 1 is the same as the first state 2 and the first preset threshold corresponding to the first level of the minor information partitioning tree stored in CountTimeTh is 2, it may be determined that the number of times of the first state 1 in countBuffer is equal to the first preset threshold corresponding to the first level of the minor information partition tree stored in CountTimeTh. As such, partitioning is performed on the minor information partitioning tree, specifically, non-full binary tree partitioning is performed on the first level of the minor information partitioning tree to obtain a new minor information partitioning tree, and thus, the new minor information partitioning tree includes two levels, the first level includes one node, and the second level includes two nodes.

Meanwhile, the right-shift bit count of minor information in KDown is updated to obtain the right-shift bit count of minor information corresponding to the second level of the minor information partitioning tree. For example, the right-shift bit count of minor information corresponding to the second level is the right-shift bit count of minor information corresponding to the first level being minus 1, that is, 10 bits-1 bit=9 bits.

Further, countBuffer is set to 0.

Referring to the above steps, the precision of the minor information is gradually recovered, and the minor information partitioning tree illustrated in FIG. 15 may be obtained.

In this way, when predictive encoding is performed on the planar position information of the current node in the point cloud in the i-th coordinate axis, based on the above steps, the first context information and/or the second context information corresponding to the current node are determined, and the first context information and/or the second context information corresponding to the current node and the preset context information are classified into the primary information and the minor information, for example, classified into 8-bit primary information and 10-bit minor information. Next, the right-shift bit count of minor information corresponding to the last level of the current minor information partitioning tree is determined. As can be seen from the above, the right-shift bit count of minor information corresponding to the last level of the current minor information partitioning tree (i.e., the current level obtained by the last partitioning) is stored in KDown. Therefore, the encoding side may obtain the right-shift bit count of minor information corresponding to the last level of the current minor information partitioning tree from KDown, and then determine the right-shift bit count of minor information corresponding to the last level as the right-shift bit count of minor information corresponding to the current node.

Next, the encoding side selects the first minor information from the minor information after binary representation of the current node based on the right-shift bit count of minor information corresponding to the current node.

For example, the right-shift bit count of minor information corresponding to the current node is n bits, so the encoding side may shift the minor information after binary representation of the current node to right by n+1 bits or n−1 bits, to obtain the first minor information.

For another example, the minor information after binary representation of the current node is shifted to right by the right-shift bit count of minor information corresponding to the current node to obtain the first minor information. It is assumed that the right-shift bit count of minor information corresponding to the current node is n bits, the minor information after binary representation of the current node is shifted to right by n bits to obtain the first minor information.

Next, the encoding side determines the first state based on the primary information after binary representation of the current node and the first minor information.

The specific manner for the encoding side to determine the first state based on the primary information after binary representation of the current node and the first minor information is not limited in the embodiments of the present disclosure.

In an example, the encoding side obtains the first state corresponding to the current node based on the above equation (26).

After obtaining the first state corresponding to the current node based on the above equation (26), the encoding side obtains the context model index corresponding to the first state from the preset context model index buffer, and then records the context model index as the index of the target context model. In this way, the encoding side selects the target context model from the multiple preset context models based on the index of the target context model, and then performs predictive encoding on the planar position information of the current node in the i-th coordinate axis using the target context model.

In some embodiments, after determining the index of the target context model based on the above steps, the encoding side updates the index of the target context model in the context model index buffer to increase the probability of the index of the target context model.

The embodiments of the present disclosure, the encoding side determines the target context model based on the above steps, and further performs the steps of updating data and partitioning the minor information partitioning tree.

The specific partitioning manner of the minor information partitioning tree is not limited in the embodiments of the present disclosure.

In an example, non-full binary tree partitioning is performed on each level in the minor information partitioning tree.

In another example, full binary tree partitioning is performed on each level in the minor information partition tree.

In another example, non-full binary tree partitioning is performed on some levels in the minor information partitioning tree, and full binary tree partitioning is performed on some levels.

The partitioning process of the minor information partitioning tree is introduced below.

In some embodiments, when the minor information partitioning tree in the embodiments of the present disclosure includes a non-full binary tree level, the method in the embodiments of the present disclosure further includes the following step 1.

In step 1: in response to the last level of the current minor information partitioning tree being a non-full binary tree level, and a number of occurrences of the first state in the last level being greater than or equal to a first preset threshold corresponding to the last level, binary tree partitioning is performed on the last level to obtain a new minor information partitioning tree.

The encoding side determines the first state corresponding to the current node and the index of the target context model corresponding to the current node based on the above steps, and further determines whether to continue to perform partitioning on the last level of the current minor information partitioning tree. Exemplarily, when the last level of the current minor information partitioning tree being a non-full binary tree, the encoding side determines whether the number of occurrences of the first state corresponding to the current node in the last level (i.e., the newest level) of the current minor information partitioning tree is greater than or equal to the first preset threshold corresponding to the last level. When the encoding side determines that the number of occurrences of the first state corresponding to the current node in the last level (i.e., the newest level) of the current minor information partitioning tree is greater than or equal to the first preset threshold corresponding to the last level, the decoding side performs binary tree partitioning on the last level of the current minor information partitioning tree to obtain a new minor information partitioning tree.

For example, the encoding side determines that the minor information is further partitioned based on the above equation (27).

In the embodiments of the present disclosure, the operation that the encoding side performs binary tree partitioning on the last level of the current minor information partitioning tree to obtain the new minor information partitioning tree includes at least the following two cases.

Case I: in response to the last level of the current minor information partitioning tree being not a last non-full binary tree level of the minor information partitioning tree, non-full binary tree partitioning is performed on the last level to obtain a new minor information partitioning tree.

For example, as illustrated in FIG. 15, it is assumed that the minor information partitioning tree includes four non-full binary tree levels and two full binary tree levels. As illustrated in FIG. 16, it is assumed that the last level of the current minor information partitioning tree is the second level, that is, the minor information is partitioned to the second level at the current time. In this case, the second level is not the last non-full binary tree level since the last non-full binary tree level is the fourth level. Therefore, when performing partitioning on the second level, non-full binary tree partitioning is performed on the second level to obtain the new minor information partitioning tree, in which the new minor information partitioning tree includes three levels, and the three levels are all non-full binary tree levels.

Case II: in response to the last level of the current minor information partitioning tree being a last non-full binary tree level of the minor information partitioning tree, full binary tree partitioning is performed on the last level to obtain a new minor information partitioning tree.

For example, as illustrated in FIG. 15, it is assumed that the minor information partitioning tree includes four non-full binary tree levels and two full binary tree levels. As illustrated in FIG. 17, it is assumed that the last level of the current minor information partitioning tree is the fourth level, that is, the minor information is partitioned to the fourth level at the current time. In this case, the fourth level is the last non-full binary tree level. Therefore, when performing partitioning on the fourth level, full binary tree partitioning is performed on the fourth level to obtain the new minor information partitioning tree, in which the new minor information partitioning tree includes five levels, and first four levels of the five levels are non-full binary tree levels, and the last level is a full binary tree level.

In the embodiments of the present disclosure, in addition to the step of performing full binary tree partitioning on the last level of the current minor information to obtain the new minor information partitioning tree, the step of updating the right-shift bit count of minor information is further included, that is, the right-shift bit count of minor information corresponding to the current node is subtracted by one to obtain a new right-shift bit count of minor information.

For example, the encoding side obtains the new right-shift bit count of minor information based on the above equation (28).

Correspondingly, the calculation equation of the updated stateUpdate is shown in equation (29).

Correspondingly, the context probability corresponding to the updated stateUpdate inherits the context probability of its parent node, as shown in equation (30).

Correspondingly, the precision of the minor information corresponding to the current state is reduced, that is, KDown[state]- -.

Finally, the encoding side resets the occurrence counter of the current state to 0, that is, countBuffer[state]=0.

In some embodiments, when the minor information partitioning tree in the embodiments of the present disclosure includes a full binary tree level, the method in the embodiments of the present disclosure further includes the following steps 21 to 24.

In step 21: in response to the last level of the current minor information partitioning tree being a full binary tree level, a right-shift bit count of minor information and a first preset threshold corresponding to a last non-full binary tree level of the current minor information partitioning tree are determined.

In step 22: second minor information is selected from the minor information after binary representation of the current node based on the right-shift bit count of minor information corresponding to the last non-full binary tree level.

In step 23: a second state is determined based on the primary information after binary representation of the current node and the second minor information.

In step 24: in response to a number of occurrences of the second state in the last level being greater than or equal to the first preset threshold corresponding to the last non-full binary tree level, full binary tree partitioning is performed on the last level, to obtain a new minor information partitioning tree.

In the present embodiment, when the minor information partitioning tree includes a non-full binary tree level and a full binary tree level, it is determined whether to continue to perform partitioning on the full binary tree level based on the right-shift bit count of minor information and the first preset threshold corresponding to the last non-full binary tree level of the minor information partitioning tree. Exemplarily, when the last level of the current minor information partitioning tree is a full binary tree level, the right-shift bit count of minor information and the first preset threshold corresponding to the last non-full binary tree level of the current minor information partitioning tree are determined, and the second minor information is selected from the minor information after binary representation of the current node based on the right-shift bit count of minor information corresponding to the last non-full binary tree level. For example, the minor information after binary representation of the current node is shifted to the right by the right-shift bit count of minor information corresponding to the last non-full binary tree level, to obtain the second minor information corresponding to the current node. Next, the second state is determined based on the primary information after binary representation of the current node and the second minor information. For example, the primary information after binary representation of the current node and the second minor information are multiplied to determine the second state.

Then, it is determined whether the number of occurrences of the second state in the last level of the current minor information partitioning tree is greater than or equal to the first preset threshold corresponding to the last non-full binary tree level based on the above equation (31).

When the number of occurrences of the second state in the last level of the current minor information partitioning tree is greater than or equal to the first preset threshold corresponding to the last non-full binary tree level, full binary tree partitioning is performed on the last level to obtain the new minor information partitioning tree.

Meanwhile, the encoding side updates the right-shift bit count of minor information, that is, the right-shift bit count of minor information corresponding to the current node is subtracted by one to obtain a new right-shift bit count of minor information.

For example, the encoding side obtains the new right-shift bit count of minor information based on the above equation (28).

Correspondingly, the calculation equation of the updated stateUpdate is shown in the above equation (29).

Correspondingly, the context probability corresponding to the updated stateUpdate inherits the context probability of the last non-full binary tree level.

Correspondingly, the precision of the minor information corresponding to the current state is reduced, that is, KDown[state]- -.

Finally, the encoding side resets the occurrence counter of the current state to 0, that is, countBuffer[state]=0.

In summary, the entire processing flow of Dynamic-OUBF may be that: Dynamic-OUBF is used as a processor, its inputs are the primary information and the minor information of the current node, and its finally outputs is an index of the target context model (context) between 0 and 255.

In some embodiments, in order to further reduce the number of context information, the operation of obtaining the target context model based on the index of the target context model in the above S202-B2124 includes the following steps S202-B21241 and S202-B21242.

In S202-B21241: the index of the target context model is quantized to obtain a quantized model index.

In S202-B21242: the target context model is obtained based on the quantized model index.

In the present embodiment, in order to further reduce the number of context information, the determined index of the target context model above is quantized to obtain the quantized model index, and then the target context model is obtained from the multiple preset context models based on the quantized model index.

The specific manner for quantizing the index of the target context model to obtain the quantized model index is not limited in the embodiments of the present disclosure.

In a possible implementation, the index of the target context model is shifted to the right by n bits to obtain the quantized model index, n being a positive integer.

The embodiment of the present disclosure does not limit the specific value of n.

In an example, n=2 bits, in this case, when quantization is not performed and the number of contexts is 256, the index of the context model is shifted to the right by 2 bits, and the total number of contexts may be reduced to 256/4=64. In this way, the number of contexts may be greatly reduced, so as to improve the encoding efficiency of the point cloud.

In an example, n=4 bits, in this case, when quantization is not performed and the number of contexts is 256, the index of the context model is shifted to the right by 4 bits, and the total number of contexts may be reduced to 256/16=16. In this way, with three coordinate axes, 3×16=48 context models may be obtained, the number of contexts is greatly reduced, so as to improve the encoding efficiency of the point cloud.

According to the point cloud encoding method provided in the embodiments of the present disclosure, when the planar structure information of the current node in the current encoded picture is encoded, the first information corresponding to the current node is determined, where the first information is used to indicate whether the first-type neighborhood nodes of the current node exist, and the first-type neighborhood nodes are neighborhood nodes whose geometry information has been encoded. Next, the occupancy information of the N neighborhood nodes of the current node is obtained based on the first information, and predictive encoding is performed on the planar structure information of the current node based on the occupancy information of the N neighborhood nodes. That is, in the embodiments of the present disclosure, when predictive encoding is performed on the planar structure information of the current node, the correlation between the planar structure information of neighborhood nodes and the types of neighborhood nodes are taken into account, which may effectively improve the encoding efficiency of the geometry information of the point cloud, thereby improving the predictive encoding performance of the planar structure information and improving the encoding efficiency and performance of the point cloud.

The preferred embodiments of the present disclosure are described in detail above in conjunction with the drawings. However, the present disclosure is not limited to the specific details in the above embodiments. Within the technical concept of the present disclosure, various simple modifications may be made to the technical solution of the present disclosure, and these simple modifications all fall within the protection scope of the present disclosure. For example, if there is no contradiction, various specific technical features described in the above specific embodiments may be combined in any appropriate manner. In order to avoid unnecessary repetition, various possible combinations are not further described in the present disclosure. For another example, the various implementation of the present disclosure may be arbitrarily combined, and as long as they do not violate the concept of the present disclosure, these combination should also be regarded as the contents disclosed in the present disclosure.

It is also to be understood that in the various method embodiments of the present disclosure, values of the serial numbers of the above-mentioned processes does not mean the order of execution. The execution order of each process should be determined by its function and internal logic, and should not constitute any limitation on the implementation process of the embodiments of the present disclosure. In addition, in the embodiments of the present disclosure, the term “and/or” is merely an association relationship to describe associated objects, which indicates that three types of relationships may exist. Specifically, A and/or B may represent three cases: A exists alone, both A and B exist, and B exists alone. In addition, the character “/”here generally indicates that the previous and next related objects are in an “or” relationship.

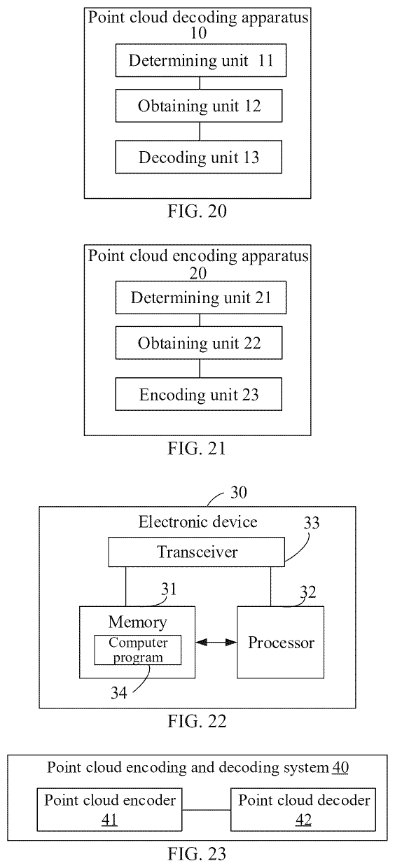

The method embodiments of the present disclosure are described in detail above in combination with FIG. 9 to FIG. 19, the apparatus embodiments are described in detail below in combination with FIG. 20 and FIG. 21.

FIG. 20 is a schematic block diagram of a point cloud decoding apparatus provided in an embodiment of the present disclosure.

As illustrated in FIG. 20, the point cloud decoding apparatus 10 may include:
a determining unit 11, configured to determine first information corresponding to a current node, wherein the first information is used to indicate whether first-type neighborhood nodes of the current node are valid, and the first-type neighborhood nodes are neighborhood nodes whose geometry information has been decoded;
an obtaining unit 12, configured to obtain occupancy information of N neighborhood nodes of the current node based on the first information, N being a positive integer; and
a decoding unit 13, configured to perform predictive decoding on planar structure information of the current node based on the occupancy information of the N neighborhood nodes.

In some embodiments, the obtaining unit 12 is specifically configured to obtain, in response to the first information indicating that at least one first-type neighborhood node of the current node is valid, occupancy information of N first-type neighborhood nodes of the current node, and using the occupancy information of the N first-type neighborhood nodes as the occupancy information of the N neighborhood nodes of the current node or obtain, in response to the first information indicating that all the first-type neighborhood nodes of the current node are invalid, occupancy information of N second-type neighborhood nodes of the current node, and use the occupancy information of the N second-type neighborhood nodes as the occupancy information of the N neighborhood nodes of the current node, where second-type neighborhood nodes are neighborhood nodes whose geometry information has not been decoded.

In some embodiments, the N first-type neighborhood nodes comprise at least one of: three first co-planar neighborhood nodes, three first co-edge neighborhood nodes, or one first co-vertex neighborhood node.

The three first co-planar neighborhood nodes comprise a neighborhood node sharing a face with a front surface of the current node, a neighborhood node sharing a face with a left surface of the current node, and a neighborhood node sharing a face with a bottom surface of the current node; the three first co-edge neighborhood nodes comprise a neighborhood node sharing an edge with a left edge of the front surface of the current node, a neighborhood node sharing an edge with a bottom edge of the front surface of the current node, and a neighborhood node sharing an edge with a left edge of the bottom surface of the current node; and the first co-vertex neighborhood node is a neighborhood node sharing a vertex with a bottom left front vertex of the current node.

In some embodiments, the N second-type neighborhood nodes comprise any one neighborhood node among neighborhood nodes of the current node except the first-type neighborhood nodes.

In some embodiments, the N second-type neighborhood nodes comprise at least one of: three second co-planar neighborhood nodes or nine second co-edge neighborhood nodes.

The three second co-planar neighborhood nodes comprise a neighborhood node sharing a face with a rear surface of the current node, a neighborhood node sharing a face with a right surface of the current node, and a neighborhood node sharing a face with a top surface of the current node; and the nine second co-edge neighborhood nodes comprise four neighborhood nodes respectively sharing an edge with four edges of the right surface of the current node, three neighborhood nodes respectively sharing an edge with a front edge, a left edge and a rear edge of the top surface of the current node, and two neighborhood nodes respectively sharing an edge with a left edge and a bottom edge of the rear surface of the current node.

In some embodiments, in response to the planar structure information of the current node comprising planar position information of the current node, the decoding unit 13 is specifically configured to perform predictive decoding on the planar position information of the current node based on types and the occupancy information of the N neighborhood nodes.

In some embodiments, the decoding unit 13 is specifically configured to determine first context information and/or second context information corresponding to an i-th coordinate axis based on the types and the occupancy information of the N neighborhood nodes, the i-th coordinate axis being an X-coordinate axis, a Y-coordinate axis or a Z-coordinate axis; and perform predictive decoding on planar position information of the current node in the i-th coordinate axis based on the first context information and/or the second context information corresponding to the i-th coordinate axis.

In some embodiments, the decoding unit 13 is specifically configured to determine, in response to the N neighborhood nodes being the first-type neighborhood nodes, planar structure information of the N neighborhood nodes based on the occupancy information of the N neighborhood nodes, where occupancy information of a neighborhood node indicates whether a child node of the neighborhood node is occupied; and determine the first context information and/or the second context information corresponding to the i-th coordinate axis based on the planar structure information of the N neighborhood nodes.

In some embodiments, the decoding unit 13 is specifically configured to determine the first context information corresponding to the i-th coordinate axis based on planar structure information of P neighborhood nodes sharing a face with the current node among the N neighborhood nodes, P being a positive integer.

In some embodiments, the decoding unit 13 is specifically configured to perform, for any one neighborhood node among the P neighborhood nodes, AND operation on planar structure information of the neighborhood node and a first preset value corresponding to the i-th coordinate axis to obtain a first value corresponding to the neighborhood node; and perform weighting operation on first values corresponding to the P neighborhood nodes to obtain the first context information corresponding to the i-th coordinate axis.

In some embodiments, the decoding unit 13 is specifically configured to determine the second context information corresponding to the i-th coordinate axis based on planar structure information of Q neighborhood nodes sharing an edge and/or sharing a vertex with the current node among the N neighborhood nodes, Q being a positive integer.

In some embodiments, the decoding unit 13 is specifically configured to perform, for any one neighborhood node among the Q neighborhood nodes, AND operation on planar structure information of the neighborhood node and a first preset value corresponding to the i-th coordinate axis to obtain a first value corresponding to the neighborhood node; and perform weighting operation on first values corresponding to the Q neighborhood nodes to obtain the second context information corresponding to the i-th coordinate axis.

In some embodiments, the decoding unit 13 is specifically configured to determine the first context information corresponding to the i-th coordinate axis based on first planar structure information of the N neighborhood nodes, wherein the first planar structure information comprises planar flag information or planar position information of the neighborhood nodes.

In some embodiments, the decoding unit 13 is specifically configured to perform, for any one neighborhood node among the N neighborhood nodes, AND operation on first planar structure information of the neighborhood node and a first preset value corresponding to the i-th coordinate axis to obtain a second value corresponding to the neighborhood node; and perform weighting operation on second values corresponding to the N neighborhood nodes to obtain the first context information corresponding to the i-th coordinate axis.

In some embodiments, the decoding unit 13 is specifically configured to determine the second context information corresponding to the i-th coordinate axis based on second planar structure information of the N neighborhood nodes, wherein the second planar structure information is planar flag information or planar position information of the neighborhood nodes.

In some embodiments, the decoding unit 13 is specifically configured to perform, for any one neighborhood node among the N neighborhood nodes, AND operation on second planar structure information of the neighborhood node and a first preset value corresponding to the i-th coordinate axis to obtain a third value corresponding to the neighborhood node; and perform weighting operation on third values corresponding to the N neighborhood nodes to obtain the second context information corresponding to the i-th coordinate axis.

In some embodiments, the decoding unit 13 is specifically configured to determine, in response to the N neighborhood nodes being the second-type neighborhood nodes, the first context information and/or the second context information corresponding to the i-th coordinate axis based on the occupancy information of the N neighborhood nodes, where occupancy information of a neighborhood node indicates whether the neighborhood node is occupied.

In some embodiments, the decoding unit 13 is specifically configured to determine the first context information corresponding to the i-th coordinate axis based on occupancy information of at least one neighborhood node sharing a face with the current node among the N neighborhood nodes.

In some embodiments, the decoding unit 13 is specifically configured to determine the second context information corresponding to the i-th coordinate axis based on occupancy information of at least one neighborhood node sharing an edge with the current node among the N neighborhood nodes.

In some embodiments, the decoding unit 13 is specifically configured to determine a target context model based on the first context information and/or the second context information corresponding to the i-th coordinate axis and the preset context information; and perform predictive decoding on the planar position information of the current node in the i-th coordinate axis based on the target context model.

In some embodiments, the decoding unit 13 is specifically configured to classify the first context information and/or the second context information corresponding to the i-th coordinate axis and the preset context information into primary information and minor information based on the types of the N neighborhood nodes; and determine the target context model based on the primary information of the current node and part or all of the minor information of the current node.

In some embodiments, the preset context information comprises at least one of: third context information, fourth context information, fifth context information or sixth context information; where
the third context information is that the planar position information of the current node is obtained as three elements by performing prediction using occupancy information of neighborhood nodes: predicted as a low plane, predicted as a high plane, or unpredictable;
the fourth context information is that a spatial distance between a node at a same partition depth and a same coordinate as the current node and the current node is “near” or “far”;
the fifth context information is a planar position of a node at the same partition depth and the same coordinate as the current node if the node is a plane; and
the sixth context information is coordinate dimension.

In some embodiments, the decoding unit 13 is specifically configured to determine, in response to the N neighborhood nodes being the first-type neighborhood nodes, at least one of the fourth context information, the fifth context information or the first context information as the primary information, and determine at least one of the third context information or the second context information as the minor information.

In some embodiments, the decoding unit 13 is specifically configured to determine, in response to the N neighborhood nodes being the second-type neighborhood nodes, at least one of the third context information, the fourth context information, the fifth context information or the first context information as the primary information, and determine the second context information as the minor information.

In some embodiments, the decoding unit 13 is specifically configured to convert the primary information of the current node and the minor information of the current node into binary representation; determine a right-shift bit count of minor information corresponding to the current node, and select first minor information from minor information after binary representation of the current node based on the right-shift bit count of minor information corresponding to the current node, where an initial value of the right-shift bit count of minor information is a total number of bits of the minor information after binary representation; determine a first state based on primary information after binary representation of the current node and the first minor information, and obtaining an index of the target context model from a preset context model index buffer based on the first state; and obtain the target context model based on the index of the target context model.

In some embodiments, the decoding unit 13 is specifically configured to determine a right-shift bit count of minor information corresponding to a last level of a current minor information partitioning tree, where the minor information partitioning tree is obtained by performing binary tree partitioning on the minor information starting from a highest bit of minor information; and determine the right-shift bit count of minor information corresponding to the last level as the right-shift bit count of minor information corresponding to the current node.

In some embodiments, the decoding unit 13 is further configured to perform, in response to the last level of the current minor information partitioning tree being a non-full binary tree level, and a number of occurrences of the first state in the last level being greater than or equal to a first preset threshold corresponding to the last level, binary tree partitioning on the last level to obtain a new minor information partitioning tree.

In some embodiments, the decoding unit 13 is further configured to determine, in response to the last level of the current minor information partitioning tree being a full binary tree level, a right-shift bit count of minor information and a first preset threshold corresponding to a last non-full binary tree level of the current minor information partitioning tree; select second minor information from the minor information after binary representation of the current node based on the right-shift bit count of minor information corresponding to the last non-full binary tree level; determine a second state based on the primary information after binary representation of the current node and the second minor information; and perform in response to a number of occurrences of the second state in the last level being greater than or equal to the first preset threshold corresponding to the last non-full binary tree level, full binary tree partitioning on the last level, to obtain a new minor information partitioning tree.

In some embodiments, the decoding unit 13 is further configured to subtract the right-shift bit count of minor information corresponding to the current node by one, to obtain a new right-shift bit count of minor information.

In some embodiments, the decoding unit 13 is specifically configured to the index of the target context model to obtain a quantized model index; and obtain the target context model based on the quantized model index.

It is to be understood that the apparatus embodiments and the method embodiments may correspond to each other, and similar descriptions may refer to the method embodiments, which will not be repeated here for avoiding repetitions. Specifically, the point cloud decoding apparatus 10 illustrated in FIG. 20 may correspond to the corresponding subject in the point cloud decoding method in the embodiments of the present disclosure, and the aforementioned and other operations and/or functions of various units in the point cloud decoding apparatus 10 are respectively for implementing the corresponding processes in the point cloud decoding method, which will not be repeated here for the sake of brevity.

FIG. 21 is a schematic block diagram of a point cloud encoding apparatus provided by an embodiment of the present disclosure.

As illustrated in FIG. 21, the point cloud encoding apparatus 20 includes:
a determining unit 21, configured to determine first information corresponding to a current node, wherein the first information is used to indicate whether first-type neighborhood nodes of the current node are valid, and the first-type neighborhood nodes are neighborhood nodes whose geometry information has been encoded;
an obtaining unit 22, configured to obtain occupancy information of N neighborhood nodes of the current node based on the first information, N being a positive integer; and
an encoding unit 23, configured to perform predictive encoding on planar structure information of the current node based on the occupancy information of the N neighborhood nodes.

In some embodiments, the obtaining unit 22 is specifically configured to obtain, in response to the first information indicating that at least one first-type neighborhood node of the current node is valid, occupancy information of N first-type neighborhood nodes of the current node, and use the occupancy information of the N first-type neighborhood nodes as the occupancy information of the N neighborhood nodes of the current node; or obtain, in response to the first information indicating that all the first-type neighborhood nodes of the current node are invalid, occupancy information of N second-type neighborhood nodes of the current node, and use the occupancy information of the N second-type neighborhood nodes as the occupancy information of the N neighborhood nodes of the current node, where second-type neighborhood nodes are neighborhood nodes whose geometry information has not been encoded.

In some embodiments, the N first-type neighborhood nodes comprise at least one of: three first co-planar neighborhood nodes, three first co-edge neighborhood nodes, or one first co-vertex neighborhood node.

The three first co-planar neighborhood nodes comprise a neighborhood node sharing a face with a front surface of the current node, a neighborhood node sharing a face with a left surface of the current node, and a neighborhood node sharing a face with a bottom surface of the current node; the three first co-edge neighborhood nodes comprise a neighborhood node sharing an edge with a left edge of the front surface of the current node, a neighborhood node sharing an edge with a bottom edge of the front surface of the current node, and a neighborhood node sharing an edge with a left edge of the bottom surface of the current node; and the first co-vertex neighborhood node is a neighborhood node sharing a vertex with a bottom left front vertex of the current node.

In some embodiments, the N second-type neighborhood nodes comprise any one neighborhood node among neighborhood nodes of the current node except the first-type neighborhood nodes.

In some embodiments, the N second-type neighborhood nodes comprise at least one of: three second co-planar neighborhood nodes or nine second co-edge neighborhood nodes.

The three second co-planar neighborhood nodes comprise a neighborhood node sharing a face with a rear surface of the current node, a neighborhood node sharing a face with a right surface of the current node, and a neighborhood node sharing a face with a top surface of the current node; and the nine second co-edge neighborhood nodes comprise four neighborhood nodes respectively sharing an edge with four edges of the right surface of the current node, three neighborhood nodes respectively sharing an edge with a front edge, a left edge and a rear edge of the top surface of the current node, and two neighborhood nodes respectively sharing an edge with a left edge and a bottom edge of the rear surface of the current node.

In some embodiments, in response to the planar structure information of the current node comprising planar position information of the current node, the encoding unit 23 is specifically configured to perform predictive encoding on the planar position information of the current node based on types and the occupancy information of the N neighborhood nodes.

In some embodiments, the encoding unit 23 is specifically configured to determine first context information and/or second context information corresponding to an i-th coordinate axis based on the types and the occupancy information of the N neighborhood nodes, the i-th coordinate axis being an X-coordinate axis, a Y-coordinate axis or a Z-coordinate axis; and perform predictive encoding on planar position information of the current node in the i-th coordinate axis based on the first context information and/or the second context information corresponding to the i-th coordinate axis.

In some embodiments, the encoding unit 23 is specifically configured to determinE, in response to the N neighborhood nodes being the first-type neighborhood nodes, planar structure information of the N neighborhood nodes based on the occupancy information of the N neighborhood nodes, where occupancy information of a neighborhood node indicates whether a child node of the neighborhood node is occupied; and determine the first context information and/or the second context information corresponding to the i-th coordinate axis based on the planar structure information of the N neighborhood nodes.

In some embodiments, the encoding unit 23 is specifically configured to determine the first context information corresponding to the i-th coordinate axis based on planar structure information of P neighborhood nodes sharing a face with the current node among the N neighborhood nodes, P being a positive integer.

In some embodiments, the encoding unit 23 is specifically configured to perform, for any one neighborhood node among the P neighborhood nodes, AND operation on planar structure information of the neighborhood node and a first preset value corresponding to the i-th coordinate axis to obtain a first value corresponding to the neighborhood node; and perform weighting operation on first values corresponding to the P neighborhood nodes to obtain the first context information corresponding to the i-th coordinate axis.

In some embodiments, the encoding unit 23 is specifically configured to determine the second context information corresponding to the i-th coordinate axis based on planar structure information of Q neighborhood nodes sharing an edge and/or sharing a vertex with the current node among the N neighborhood nodes, Q being a positive integer.

In some embodiments, the encoding unit 23 is specifically configured to perform, for any one neighborhood node among the Q neighborhood nodes, AND operation on planar structure information of the neighborhood node and a first preset value corresponding to the i-th coordinate axis to obtain a first value corresponding to the neighborhood node; and perform weighting operation on first values corresponding to the Q neighborhood nodes to obtain the second context information corresponding to the i-th coordinate axis.

In some embodiments, the encoding unit 23 is specifically configured to determine the first context information corresponding to the i-th coordinate axis based on first planar structure information of the N neighborhood nodes, wherein the first plane structure information comprises planar flag information or planar position information of the neighborhood nodes.

In some embodiments, the encoding unit 23 is specifically configured to perform, for any one neighborhood node among the N neighborhood nodes, AND operation on first planar structure information of the neighborhood node and a first preset value corresponding to the i-th coordinate axis to obtain a second value corresponding to the neighborhood node; and perform weighting operation on second values corresponding to the N neighborhood nodes to obtain the first context information corresponding to the i-th coordinate axis.

In some embodiments, the encoding unit 23 is specifically configured to determine the second context information corresponding to the i-th coordinate axis based on second planar structure information of the N neighborhood nodes, wherein the second planar structure information is planar flag information or the planar position information of the neighborhood nodes.

In some embodiments, the encoding unit 23 is specifically configured to perform, for any one neighborhood node among the N neighborhood nodes, AND operation on second planar structure information of the neighborhood node and a first preset value corresponding to the i-th coordinate axis to obtain a third value corresponding to the neighborhood node; and perform weighting operation on third values corresponding to the N neighborhood nodes to obtain the second context information corresponding to the i-th coordinate axis.

In some embodiments, the encoding unit 23 is specifically configured to determine, in response to the N neighborhood nodes being the second-type neighborhood nodes, the first context information and/or the second context information corresponding to the i-th coordinate axis based on the occupancy information of the N neighborhood nodes, where occupancy information of a neighborhood node indicates whether the neighborhood node is occupied.

In some embodiments, the encoding unit 23 is specifically configured to determine the first context information corresponding to the i-th coordinate axis based on occupancy information of at least one neighborhood node sharing a face with the current node among the N neighborhood nodes.

In some embodiments, the encoding unit 23 is specifically configured to determine the second context information corresponding to the i-th coordinate axis based on occupancy information of at least one neighborhood node sharing an edge with the current node among the N neighborhood nodes.

In some embodiments, the encoding unit 23 is specifically configured to determine a target context model based on the first context information and/or the second context information corresponding to the i-th coordinate axis and the preset context information; and perform predictive encoding on the planar position information of the current node in the i-th coordinate axis based on the target context model.

In some embodiments, the encoding unit 23 is specifically configured to classify the first context information and/or the second context information corresponding to the i-th coordinate axis and the preset context information into primary information and minor information based on the types of the N neighborhood nodes; and determine the target context model based on the primary information of the current node and part or all of the minor information of the current node.

In some embodiments, the preset context information comprises at least one of: third context information, fourth context information, fifth context information or sixth context information; where
the third context information is that the planar position information of the current node is obtained as three elements by performing prediction using occupancy information of the neighborhood nodes: predicted as a low plane, predicted as a high plane, or unpredictable;
the fourth context information is that a spatial distance between a node at a same partition depth and a same coordinate as the current node and the current node is “near” or “far”;
the fifth context information is a planar position of a node at the same partition depth and the same coordinate as the current node if the node is a plane; and
the sixth context information is coordinate dimension.

In some embodiments, the encoding unit 23 is specifically configured to determine, in response to the N neighborhood nodes being the first-type neighborhood nodes, at least one of the fourth context information, the fifth context information or the first context information as the primary information, and determine at least one of the third context information or the second context information as the minor information.

In some embodiments, the encoding unit 23 is specifically configured to determine, in response to the N neighborhood nodes being the second-type neighborhood nodes, at least one of the third context information, the fourth context information, the fifth context information or the first context information as the primary information, and determine the second context information as the minor information.

In some embodiments, the encoding unit 23 is specifically configured to convert the primary information of the current node and the minor information of the current node into binary representation; determine a right-shift bit count of minor information corresponding to the current node, and select first minor information from minor information after binary representation of the current node based on the right-shift bit count of minor information corresponding to the current node, where an initial value of the right-shift bit count of minor information is a total number of bits of the minor information after binary representation; determine a first state based on primary information after binary representation of the current node and the first minor information, and obtaining an index of the target context model from a preset context model index buffer based on the first state; an obtain the target context model based on the index of the target context model.

In some embodiments, the encoding unit 23 is specifically configured to determine a right-shift bit count of minor information corresponding to a last level of a current minor information partitioning tree, where the minor information partitioning tree is obtained by performing binary tree partitioning on the minor information starting from a highest bit of minor information; and determine the right-shift bit count of minor information corresponding to the last level as the right-shift bit count of minor information corresponding to the current node.

In some embodiments, the encoding unit 23 is further configured to perform, in response to the last level of the current minor information partitioning tree being a non-full binary tree level, and a number of occurrences of the first state in the last level being greater than or equal to a first preset threshold corresponding to the last level, binary tree partitioning on the last level to obtain a new minor information partitioning tree.

In some embodiments, the encoding unit 23 is further configured to determine, in response to the last level of the current minor information partitioning tree being a full binary tree level, a right-shift bit count of minor information and a first preset threshold corresponding to a last non-full binary tree level of the current minor information partitioning tree; select second minor information from the minor information after binary representation of the current node based on the right-shift bit count of minor information corresponding to the last non-full binary tree level; determine a second state based on the primary information after binary representation of the current node and the second minor information; and perform in response to a number of occurrences of the second state in the last level being greater than or equal to a first preset threshold corresponding to the last non-full binary tree level, full binary tree partitioning on the last level, to obtain a new minor information partitioning tree.

In some embodiments, the encoding unit 23 is further configured to subtract the right-shift bit count of minor information corresponding to the current node by one, to obtain a new right-shift bit count of minor information.

In some embodiments, the encoding unit 23 is specifically configured to quantize the index of the target context model to obtain a quantized model index; and obtain the target context model based on the quantized model index.

It is to be understood that the apparatus embodiments and the method embodiments may correspond to each other, and similar descriptions may refer to the method embodiments, which will not be repeated here for avoiding repetitions. Specifically, the point cloud encoding apparatus 20 illustrated in FIG. 21 may correspond to the corresponding subject in the point cloud encoding method of the embodiments of the present disclosure, and the aforementioned and other operations and/or functions of various units in the point cloud encoding apparatus 20 are respectively for implementing the corresponding processes in the point cloud encoding method, which will not be repeated here for the sake of brevity.

The apparatus and system in the embodiments of the present disclosure are described in detail above from the perspective of functional units in combination with the accompanying drawings. It should be understood that the functional units may be implemented in the form of hardware, or may be implemented by instructions in the form of software, or may be implemented by a combination of hardware units and software units. Specifically, various steps of the method embodiments among the embodiments of the present disclosure may be completed by the hardware integrated logic circuit and/or software instructions in the processor, and the steps of the method disclosed in the embodiments of the present disclosure may be directly reflected as being executed by a hardware decoding processor, or may be executed by a combination of hardware and software units in the decoding processor. Optionally, the software unit may be located in a mature storage medium in the art, such as a random access memory, a flash memory, a read-only memory, a programmable read-only memory, an electrically erasable programmable memory, or a register. The storage medium is located in the memory, and the processor reads the information in the memory and completes the steps in the above method embodiments in combination with its hardware.

FIG. 22 is a schematic block diagram of an electronic device provided in the embodiments of the present disclosure.

As illustrated in FIG. 22, the electronic device 30 may be a point cloud decoding device or a point cloud encoding device as described in the embodiments of the present disclosure, and the electronic device 30 may include:
a memory 31 and a processor 32, where the memory 31 is configured to store a computer program 34 and transmit the computer program 34 to the processor 32. In other words, the processor 32 may call and run the computer program 34 from the memory 31 and run the computer program 34, to implement the method in the embodiments of the present disclosure.

For example, the processor 32 may be configured to perform the steps in the above method 200 according to the instructions in the computer program 34.

In some embodiments of the present disclosure, the processor 32 may include but is not limited to:
a general purpose processor, a digital signal processor (DSP), an application specific integrated circuit (ASIC), a field programmable gate array (FPGA) or other programmable logic devices, discrete gates or transistor logic devices, discrete hardware components or the like.

In some embodiments of the present disclosure, the memory 31 includes but is not limited to:
a volatile memory and/or non-volatile memory. The non-volatile memory here may be a read-only memory (ROM), a programmable ROM (PROM), an erasable PROM (EPROM), an electrically EPROM (EEPROM), or a flash memory. The volatile memory may be a random access memory (RAM), which acts as external cache memory. By way of example and not limitation, many forms of RAM are available, such as a static RAM (SRAM), a dynamic RAM (DRAM), a synchronous DRAM (SDRAM), a double data rate SDRAM (DDR SDRAM), an enhanced SDRAM (ESDRAM), a synch link DRAM (SLDRAM), or a direct rambus RAM (DR RAM).

In some embodiments of the present disclosure, the computer program 34 may be divided into one or more units, which are stored in the memory 31 and executed by the processor 32 to complete the method provided by the present disclosure. The one or more units may be a series of computer program instruction segments capable of completing specific functions, and the instruction segments are used to describe the execution process of the computer program 34 in the electronic device 30.

As illustrated in FIG. 22, the electronic device 30 may further include:

a transceiver 33, and the transceiver 33 may be connected to the processor 32 or the memory 31.

The processor 32 may control the transceiver 33 to communicate with other devices, and specifically, may transmit information or data to other devices, or receive information or data transmitted by other devices. The transceiver 33 may include a transmitter and a receiver. The transceiver 33 may further include an antenna, and the number of the antenna may be one or more.

It should be understood that the various components in the electronic device 30 are connected via a bus system, where the bus system includes not only a data bus but further a power bus, a control bus and a status signal bus.

FIG. 23 is a schematic block diagram of the point cloud encoding and decoding system provided in the embodiments of the present disclosure.

As illustrated in FIG. 23, the point cloud encoding and decoding system 40 may include: a point cloud encoder 41 and a point cloud decoder 42, where the point cloud encoder 41 is configured to perform the point cloud encoding method involved in the embodiments of the present disclosure, and the point cloud decoder 42 is configured to perform the point cloud decoding method involved in the embodiments of the present disclosure.

The present disclosure further provides a bitstream, which is generated according to the above encoding method.

The present disclosure further provides a computer storage medium, having a computer program stored thereon. Where the computer program, when executed on a computer, enables the computer to perform the method of the above method embodiments. In other words, the embodiments of the present disclosure further provide a computer program product including instructions which, when executed on a computer, enables the computer to perform the method of the above method embodiments.

When implemented using software, all or part of the above embodiments may be implemented in a form of a computer program product. The computer program product includes one or more computer instructions. When loaded and executed on a computer, the computer program instructions produce, in all or in part, a process or function in accordance with the embodiments of the present disclosure. The computer may be a general purpose computer, a special purpose computer, a computer network, or any of other programmable apparatuses. The computer instructions may be stored in a non-transitory computer-readable storage medium, or transmitted from one non-transitory computer-readable storage medium to another non-transitory computer-readable storage medium. For example, the computer instructions may be transmitted from a website, a computer, a server, or a data center to another website, computer, server, or data center through wired manner (e.g., coaxial cable, optical fiber, or digital subscriber line (DSL)) or wireless (e.g., infrared, radio, or microwave) manner. The non-transitory computer-readable storage medium may be any available medium to which a computer can access or may be a data storage device, such as a server or a data center that includes one or more available media. The available medium may be a magnetic medium (e.g., a floppy disk, a hard disk, or a magnetic tape), an optical medium (e.g., a digital video disc (DVD)), or a semiconductor medium (e.g., a solid state disk (SSD)).

Those skilled in the art will appreciate that the units and algorithm steps of each example described in conjunction with the embodiments disclosed herein may be implemented by electronic hardware, or a combination of computer software and electronic hardware. Whether these functions are performed in hardware or software depends on the specific application and design constraints of the technical solution. Professional technicians may use different methods to implement the described functions for each specific application, but such implementation should not be considered to be beyond the scope of the present disclosure.

In several embodiments provided by the present disclosure, it should be understood that the disclosed system, apparatuses and methods may be implemented in other manners. For example, the apparatus embodiments described above are only schematic. For example, the partition of the units is only partition of logical functions, and there may be other partition manners in the actual implementation, such as a plurality of units or components may be combined or integrated into another system, or some features may be ignored or not implemented. In addition, the mutual coupling or direct coupling or communication connection illustrated or discussed may be indirect coupling or communication connection through some interfaces, apparatuses or units, which may be in electrical, mechanical or other forms.

The units described as discrete components may or may not be physically separated, and the components shown as units may or may not be physical units, that is, they may be located at one place, or may be distributed onto a plurality of network units. Some or all of these units may be selected depending on actual requirements to fulfill the purpose of the solution of the embodiments. For example, various functional units in various embodiments of the present disclosure may be integrated into one processing unit, or various units may exist physically alone, or two or more units may be integrated into one unit.

The foregoing descriptions are merely specific implementations of the present disclosure, but the protection scope of the present disclosure is not limited thereto. Any skilled person in the art could readily conceive of variations or replacements within the technical scope of the present disclosure, which shall be all included in the protection scope of the present disclosure. Therefore, the protection scope of the present disclosure shall be subject to the protection scope of claims.

What is claimed is:

1. A point cloud decoding method, comprising:
determining first information corresponding to a current node, wherein the first information is used to indicate whether first-type neighborhood nodes of the current node are valid, and the first-type neighborhood nodes are neighborhood nodes whose geometry information has been decoded;
obtaining occupancy information of N neighborhood nodes of the current node based on the first information, N being a positive integer; and
performing predictive decoding on planar structure information of the current node based on the occupancy information of the N neighborhood nodes.

2. The method according to claim 1, wherein obtaining the occupancy information of the N neighborhood nodes of the current node based on the first information comprises:
in response to the first information indicating that at least one first-type neighborhood node of the current node is valid, obtaining occupancy information of N first-type neighborhood nodes of the current node, and using the occupancy information of the N first-type neighborhood nodes as the occupancy information of the N neighborhood nodes of the current node; or
in response to the first information indicating that all the first-type neighborhood nodes of the current node are invalid, obtaining occupancy information of N second-type neighborhood nodes of the current node, and using the occupancy information of the N second-type neighborhood nodes as the occupancy information of the N neighborhood nodes of the current node, wherein second-type neighborhood nodes are neighborhood nodes whose geometry information has not been decoded.

3. The method according to claim 2, wherein the N first-type neighborhood nodes comprise at least one of: three first co-planar neighborhood nodes, three first co-edge neighborhood nodes, or one first co-vertex neighborhood node;
wherein the three first co-planar neighborhood nodes comprise a neighborhood node sharing a face with a front surface of the current node, a neighborhood node sharing a face with a left surface of the current node, and a neighborhood node sharing a face with a bottom surface of the current node;
the three first co-edge neighborhood nodes comprise a neighborhood node sharing an edge with a left edge of the front surface of the current node, a neighborhood node sharing an edge with a bottom edge of the front surface of the current node, and a neighborhood node sharing an edge with a left edge of the bottom surface of the current node; and the first co-vertex neighborhood node is a neighborhood node sharing a vertex with a bottom left front vertex of the current node.

4. The method according to claim 3, wherein the N second-type neighborhood nodes comprise any one neighborhood node among neighborhood nodes of the current node except the first-type neighborhood nodes; and
the N second-type neighborhood nodes comprise at least one of: three second co-planar neighborhood nodes or nine second co-edge neighborhood nodes;
wherein the three second co-planar neighborhood nodes comprise a neighborhood node sharing a face with a rear surface of the current node, a neighborhood node sharing a face with a right surface of the current node, and a neighborhood node sharing a face with a top surface of the current node; and the nine second co-edge neighborhood nodes comprise four neighborhood nodes respectively sharing an edge with four edges of the right surface of the current node, three neighborhood nodes respectively sharing an edge with a front edge, a left edge and a rear edge of the top surface of the current node, and two neighborhood nodes respectively sharing an edge with a left edge and a bottom edge of the rear surface of the current node.

5. The method according to claim 2, wherein in response to the planar structure information of the current node comprising planar position information of the current node, performing predictive decoding on the planar structure information of the current node based on the occupancy information of the N neighborhood nodes comprises:
performing predictive decoding on the planar position information of the current node based on types and the occupancy information of the N neighborhood nodes.

6. The method according to claim 5, wherein performing predictive decoding on the planar position information of the current node based on the types and the occupancy information of the N neighborhood nodes comprises:
determining first context information and/or second context information corresponding to an i-th coordinate axis based on the types and the occupancy information of the N neighborhood nodes, the i-th coordinate axis being an X-coordinate axis, a Y-coordinate axis or a Z-coordinate axis; and
performing predictive decoding on planar position information of the current node in the i-th coordinate axis based on the first context information and/or the second context information corresponding to the i-th coordinate axis.

7. The method according to claim 6, wherein determining the first context information and/or the second context information corresponding to the i-th coordinate axis based on the types and the occupancy information of the N neighborhood nodes comprises:
in response to the N neighborhood nodes being the first-type neighborhood nodes, determining planar structure information of the N neighborhood nodes based on the occupancy information of the N neighborhood nodes, wherein occupancy information of a neighborhood node indicates whether a child node of the neighborhood node is occupied; and
determining the first context information and/or the second context information corresponding to the i-th coordinate axis based on the planar structure information of the N neighborhood nodes.

8. The method according to claim 6, wherein determining the first context information and/or the second context information corresponding to the i-th coordinate axis based on the types and the occupancy information of the N neighborhood nodes comprises:
in response to the N neighborhood nodes being the second-type neighborhood nodes, determining the first context information and/or the second context information corresponding to the i-th coordinate axis based on the occupancy information of the N neighborhood nodes, wherein occupancy information of a neighborhood node indicates whether the neighborhood node is occupied.

9. The method according to claim 6, wherein performing predictive decoding on the planar position information of the current node in the i-th coordinate axis based on the first context information and/or the second context information corresponding to the i-th coordinate axis comprises:
determining a target context model based on the first context information and/or the second context information corresponding to the i-th coordinate axis and preset context information; and
performing predictive decoding on the planar position information of the current node in the i-th coordinate axis based on the target context model;
wherein determining the target context model based on the first context information and/or the second context information corresponding to the i-th coordinate axis and the preset context information comprises:
classifying the first context information and/or the second context information corresponding to the i-th coordinate axis and the preset context information into primary information and minor information based on the types of the N neighborhood nodes; and
determining the target context model based on the primary information of the current node and part or all of the minor information of the current node.

10. The method according to claim 9, wherein determining the target context model based on the primary information of the current node and part or all of the minor information of the current node comprises:
converting the primary information of the current node and the minor information of the current node into binary representation;
determining a right-shift bit count of minor information corresponding to the current node, and selecting first minor information from minor information after binary representation of the current node based on the right-shift bit count of minor information corresponding to the current node, wherein an initial value of the right-shift bit count of minor information is a total number of bits of the minor information after binary representation;
determining a first state based on primary information after binary representation of the current node and the first minor information, and obtaining an index of the target context model from a preset context model index buffer based on the first state; and
obtaining the target context model based on the index of the target context model.

11. The method according to claim 10, wherein determining the right-shift bit count of minor information corresponding to the current node comprises:
determining a right-shift bit count of minor information corresponding to a last level of a current minor information partitioning tree, wherein the minor information partitioning tree is obtained by performing binary tree partitioning on the minor information starting from a highest bit of minor information; and
determining the right-shift bit count of minor information corresponding to the last level as the right-shift bit count of minor information corresponding to the current node.

12. The method according to claim 11, further comprising:
in response to the last level of the current minor information partitioning tree being a non-full binary tree level, and a number of occurrences of the first state in the last level being greater than or equal to a first preset threshold corresponding to the last level, performing binary tree partitioning on the last level to obtain a new minor information partitioning tree.

13. The method according to claim 11, further comprising:
in response to the last level of the current minor information partitioning tree being a full binary tree level, determining a right-shift bit count of minor information and a first preset threshold corresponding to a last non-full binary tree level of the current minor information partitioning tree;
selecting second minor information from the minor information after binary representation of the current node based on the right-shift bit count of minor information corresponding to the last non-full binary tree level;
determining a second state based on the primary information after binary representation of the current node and the second minor information; and
in response to a number of occurrences of the second state in the last level being greater than or equal to the first preset threshold corresponding to the last non-full binary tree level, performing full binary tree partitioning on the last level, to obtain a new minor information partitioning tree.

14. The method according to claim 12, further comprising:
subtracting the right-shift bit count of minor information corresponding to the current node by one, to obtain a new right-shift bit count of minor information.

15. The method according to claim 10, wherein obtaining the target context model based on the index of the target context model comprises:
quantizing the index of the target context model to obtain a quantized model index; and
obtaining the target context model based on the quantized model index.

16. A point cloud encoding method, comprising:
determining first information corresponding to a current node, wherein the first information is used to indicate whether first-type neighborhood nodes of the current node are valid, and the first-type neighborhood nodes are neighborhood nodes whose geometry information has been encoded;
obtaining occupancy information of N neighborhood nodes of the current node based on the first information, N being a positive integer; and
performing predictive encoding on planar structure information of the current node based on the occupancy information of the N neighborhood nodes.

17. The method according to claim 16, wherein obtaining the occupancy information of the N neighborhood nodes of the current node based on the first information comprises:
in response to the first information indicating that at least one first-type neighborhood node of the current node is valid, obtaining occupancy information of N first-type neighborhood nodes of the current node, and using the occupancy information of the N first-type neighborhood nodes as the occupancy information of the N neighborhood nodes of the current node; or
in response to the first information indicating that all the first-type neighborhood nodes of the current node are invalid, obtaining occupancy information of N second-type neighborhood nodes of the current node, and using the occupancy information of the N second-type neighborhood nodes as the occupancy information of the N neighborhood nodes of the current node, wherein second-type neighborhood nodes are neighborhood nodes whose geometry information has not been encoded.

18. The method according to claim 17, wherein the N first-type neighborhood nodes comprise at least one of: three first co-planar neighborhood nodes, three first co-edge neighborhood nodes, or one first co-vertex neighborhood node;
wherein the three first co-planar neighborhood nodes comprise a neighborhood node sharing a face with a front surface of the current node, a neighborhood node sharing a face with a left surface of the current node, and a neighborhood node sharing a face with a bottom surface of the current node;
the three first co-edge neighborhood nodes comprise a neighborhood node sharing an edge with a left edge of the front surface of the current node, a neighborhood node sharing an edge with a bottom edge of the front surface of the current node, and a neighborhood node sharing an edge with a left edge of the bottom surface of the current node; and the first co-vertex neighborhood node is a neighborhood node sharing a vertex with a bottom left front vertex of the current node.

19. The method according to claim 17, wherein in response to the planar structure information of the current node comprising planar position information of the current node, performing predictive encoding on the planar structure information of the current node based on the occupancy information of the N neighborhood nodes comprises:
performing predictive encoding on the planar position information of the current node based on types and the occupancy information of the N neighborhood nodes.

20. The method according to claim 19, wherein performing predictive encoding on the planar position information of the current node based on the types and the occupancy information of the N neighborhood nodes comprises:
determining first context information and/or second context information corresponding to an i-th coordinate axis based on the types and the occupancy information of the N neighborhood nodes, the i-th coordinate axis being an X-coordinate axis, a Y-coordinate axis or a Z-coordinate axis; and
performing predictive encoding on planar position information of the current node in the i-th coordinate axis based on the first context information and/or the second context information corresponding to the i-th coordinate axis.
